(19) United States
(12) Patent Application Publication
(10) Pub. No.: US 2026/0019184 A1
(43) Pub. Date: Jan. 15, 2026

(54) METHOD AND DEVICE FOR TRANSMITTING AND RECEIVING DATA IN SATELLITE COMMUNICATION SYSTEM

(71) Applicant: Samsung Electronics Co., Ltd., Gyeonggi-do (KR)

(72) Inventors: Sungjin PARK, Gyeonggi-do (KR); Younsun KIM, Gyeonggi-do (KR); Hyoungju JI, Gyeonggi-do (KR); Kyungjun CHOI, Gyeonggi-do (KR)

(21) Appl. No.: 19/266,737

(22) Filed: Jul. 11, 2025

(30) Foreign Application Priority Data
Jul. 12, 2024 (KR) 10-2024-0092509

(51) Int. Cl. H04J 13/00; H04L 5/00; H04W 72/0446; H04W 72/231; H04W 72/51

(52) U.S. Cl. CPC H04J 13/004; H04L 5/0044; H04W 72/0446; H04W 72/231; H04W 72/51

(57) ABSTRACT

The disclosure relates to a 5G or 6G communication system for supporting a higher data transmission rate. A method performed by a terminal in a wireless communication system includes receiving, from a base station, configuration information on an orthogonal cover code (OCC), identifying a transport block (TB) and multiple slots for a TB processing, based on the configuration information, applying a different OCC sequence to each repetition of the TB, and transmitting, to the base station, a physical uplink shared channel (PUSCH).

### CROSS-REFERENCE TO RELATED APPLICATION(S)

This application is based on and claims priority under 35 U.S.C. § 119 to Korean Patent Application No. 10-2024-0092509, which was filed in the Korean Intellectual Property Office on Jul. 12, 2024, the entire disclosure of which is incorporated herein by reference.

### BACKGROUND

### 1. Field

The disclosure relates generally to operations of a terminal and a base station in a satellite communication system, and more particularly to a method for transmitting and receiving data information in a satellite communication system, and a device capable of performing the same.

### 2. Description of Related Art

5th generation (5G) mobile communication technologies define broad frequency bands such that high transmission rates and new services are possible, and can be implemented in “sub 6 gigahertz (GHz)” bands such as 3.5 GHz, and in “above 6 GHz” bands, which may be referred to as mmWave including 28 GHz and 39 GHz. In addition, it has been considered to implement 6th generation (6G) mobile communication technologies (which may be referred to as beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

Since the initial development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi-input multi-output (MIMO) for mitigating radio-wave path loss and increasing radio-wave transmission distances in mmWave, supporting numerologies (e.g., operating multiple subcarrier spacings (SCSs)) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for relatively large amount of data transmission and a polar code for highly reliable transmission of control information, layer 2 (L2) pre-processing, and network slicing for providing a dedicated network specialized to a specific service.

There are also ongoing discussions regarding improvement and performance enhancement of initial 5G mobile communication technologies in view of services to be supported by 5G mobile communication technologies, such as physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR (user equipment (UE) power saving, non-terrestrial network (NTN), which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There is also ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expected to exponential increase, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIA), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

According to an aspect of the disclosure, various embodiments are set forth herein to provide devices and methods capable of effectively performing physical uplink (UL) shared channel (PUSCH) transmission in a mobile communication system and/or a satellite communication system.

In accordance with an aspect of the disclosure, a method is provided for a terminal in a wireless communication system. The method includes receiving, from a base station, configuration information on an OCC; identifying a TB and multiple slots for TB processing; based on the configuration information, applying a different OCC sequence to each repetition of the TB; and transmitting, to the base station, a PUSCH.

In accordance with another aspect of the disclosure, a method is provided for a base station in a wireless communication system. The method includes transmitting, to a terminal, configuration information on an OCC; receiving, from the terminal, a PUSCH; and identifying a TB and multiple slots for TB processing. A different OCC sequence is applied to each repetition of the TB.

In accordance with another aspect of the disclosure, a terminal is provided for use in a wireless communication system. The terminal includes a transceiver; a processor; and memory, communicatively coupled to the processor, configured for storing instructions executable by the processor individually or in any combination to cause the terminal to receive, from a base station, configuration information on an OCC, identify a TB and multiple slots for TB processing, based on the configuration information, apply a different OCC sequence to each repetition of the TB and transmit, to the base station, a PUSCH.

In accordance with another aspect of the disclosure, a base station is provided for use in a wireless communication system. The base station includes a transceiver; a processor; and memory, communicatively coupled to the processor, configured for storing instructions executable by the processor individually or in any combination to cause the base station to transmit, to a terminal, configuration information on an OCC, receive, from the terminal, a PUSCH, and identify a TB and multiple slots for TB processing. A different OCC sequence is applied to each repetition of the TB.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a time-frequency domain in a wireless communication system according to an embodiment;

FIG. 2 illustrates a structure of a frame, a subframe, and a slot in a wireless communication system according to an embodiment;

FIG. 3 illustrates an example of a BWP configuration in a wireless communication system according to an embodiment;

FIG. 4 illustrates an example of a control resource set (CORESET) configuration of a downlink (DL) control channel in a wireless communication system according to an embodiment;

FIG. 5 illustrates a structure of a DL control channel in a wireless communication system according to an embodiment;

FIG. 6 illustrates, in terms of spans, a case in which a UE may have multiple physical DL control channel (PDCCH) monitoring occasions (MOs) within a slot in a wireless communication system according to an embodiment;

FIG. 7 illustrates an example of base station beam allocation according to transmission configuration indicator (TCI) state configurations in a wireless communication system according to an embodiment;

FIG. 8 illustrates an example of a method for allocating a TCI state to a PDCCH in a wireless communication system according to an embodiment;

FIG. 9 illustrates a TCI indication medium access control (MAC) control element (CE) signaling structure for a PDCCH demodulation reference signal (DMRS) in a wireless communication system according to an embodiment;

FIG. 10 illustrates an example of a beam configuration with regard to a CORESET and a search space in a wireless communication system according to an embodiment;

FIG. 11 illustrates a method in which a base station and a UE transmit/receive data in consideration of a DL data channel and a rate matching resource (RMR) in a wireless communication system according to an embodiment;

FIG. 12 illustrates a method in which, upon receiving a DL control channel, a UE selects a receivable CORESET in consideration of priority in a wireless communication system according to an embodiment;

FIG. 13 illustrates an example of an aperiodic channel state information (CSI) reporting method according to an embodiment;

FIG. 14 illustrates an example of PUSCH repetition type B transmission in a wireless communication system according to an embodiment;

FIG. 15 illustrates radio protocol structures of a base station and a UE in single cell, carrier aggregation (CA), and dual connectivity (DC) situations in a wireless communication system according to an embodiment;

FIG. 16 illustrates an example of an antenna port configuration and resource allocation for cooperative communication in a wireless communication system according to an embodiment;

FIG. 17 illustrates an example of a DL control information (DCI) configuration for cooperative communication in a wireless communication system according to an embodiment;

FIG. 18 illustrates a procedure in which a base station controls transmission power of a UE according to an embodiment;

FIG. 19 illustrates a process of generating a Type-1 (semi-static) hybrid automatic repeat request (HARQ)-acknowledgment (ACK) codebook by a terminal according to an embodiment;

FIG. 20 illustrates a process of generating a Type-2 (dynamic) HARQ-ACK codebook by a terminal according to an embodiment;

FIG. 21 illustrates an orbital period of a communication satellite around the Earth according to the altitude or height of the satellite according to an embodiment;

FIG. 22 is a block diagram illustrating a method for generating long term evolution (LTE) physical DL control channel (PUCCH) format 5 according to an embodiment;

FIG. 23 illustrates a method in which different terminals perform mapping to virtual frequency tones by applying different orthogonal cover code (OCC) values according to an embodiment;

FIG. 24 is a flowchart illustrating a terminal processing procedure for PUSCH transmission according to an embodiment;

FIG. 25 illustrates a method for applying an OCC scheme when a terminal repeatedly transmits a PUSCH for each slot according to an embodiment;

FIG. 26 illustrates a method for applying an OCC scheme when a terminal repeatedly transmits a PUSCH within one slot according to an embodiment;

FIG. 27 illustrates a method for applying an OCC scheme in terms of time resources when a terminal transmits a PUSCH according to an embodiment;

FIG. 28 illustrates a method for applying an OCC scheme in terms of frequency resources when a terminal transmits a PUSCH according to an embodiment;

FIG. 29 illustrates a method for applying an OCC scheme in terms of time resources when a terminal transmits a PUSCH according to an embodiment;

FIG. 30 illustrates a method for applying an OCC scheme in terms of time resources when a terminal transmits a PUSCH according to an embodiment;

FIG. 31 illustrates a method for applying an OCC scheme in terms of frequency resources when a terminal transmits a PUSCH according to an embodiment;

FIG. 32 illustrates a method for applying an OCC scheme in terms of frequency resources when a terminal transmits a PUSCH according to an embodiment;

FIG. 33 illustrates a bit selection procedure according to a redundancy version (RV) value according to an embodiment;

FIG. 34 illustrates a process in which a transport block over multiple slots (TBoMS) scheme is mapped to a transmission resource according to an embodiment;

FIG. 35 illustrates a slot-level OCC application method according to an embodiment;

FIG. 36 illustrates a method for applying OCC by a terminal in a situation where TBoMS and repeated transmissions are applied, according to an embodiment;

FIG. 37 illustrates a method for applying OCC during repeated PUSCH transmissions according to an embodiment;

FIG. 38 illustrates a method for applying TBoMS and OCC during repeated PUSCH transmissions according to an embodiment;

FIG. 39 illustrates an example in which OCC is applied to two different PUSCHs within one slot according to an embodiment;

FIG. 40 illustrates PUSCH repeated transmission type B according to an embodiment;

FIG. 41 illustrates a procedure for performing PUSCH transmission to which an OCC scheme is applied, according to an embodiment;

FIG. 42 illustrates a UE according to an embodiment; and

FIG. 43 illustrates a base station according to an embodiment.

### DETAILED DESCRIPTION

Hereinafter, various embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

In the accompanying drawings, some elements may be exaggerated, omitted, or schematically illustrated. Also, the size of each element does not necessarily reflect the actual size.

In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms.

The following embodiments are provided only to completely disclose the disclosure and inform those skilled in the art of the scope of the disclosure, and the disclosure is defined only by the scope of the appended claims.

Furthermore, in describing the disclosure, a detailed description of known functions or configurations incorporated herein will be omitted when it is determined that the description may make the subject matter of the disclosure unnecessarily unclear.

The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node Ba wireless access unit, a base station controller, and a node on a network. A terminal may include a UE, a mobile station (MS), a cellular phone, a smartphone, a computer, or a multimedia system capable of performing a communication function.

In the disclosure, a “DL” refers to a radio link via which a base station transmits a signal to a terminal, and a “UL” refers to a radio link via which a terminal transmits a signal to a base station.

Furthermore, LTE or LTE-advanced (A) systems may be described by way of example, but the embodiments of the disclosure may also be applied to other communication systems having similar technical backgrounds or channel types. Examples of such communication systems may include 5G mobile communication technologies (e.g., NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). In some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” may refer to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3rd generation partnership project (3GPP), LTE (or evolved universal terrestrial radio access (E-UTRA)), LTE-A, LTE-Pro, high-rate packet data (HRPD) of 3GPP2, ultra-mobile broadband (UMB), IEEE 802.16e, etc., as well as typical voice-based services.

As an example of a broadband wireless communication system, an LTE system employs an orthogonal frequency division multiplexing (OFDM) scheme in a DL and employs a single carrier frequency division multiple access (SC-FDMA) scheme in a UL. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, should freely reflect various requirements of users, service providers, etc., services satisfying various requirements should be supported. The services considered in the 5G communication system include eMBB communication, mMTC, URLLC, etc.

eMBB aims at providing a data rate higher than that supported by existing LTE, LTE-A, or LTE-Pro. For example, in the 5G communication system, eMBB should provide a peak data rate of 20 Gbps in the DL and a peak data rate of 10 Gbps in the UL for a single base station. Furthermore, the 5G communication system should provide an increased user-perceived data rate to the UE, as well as the maximum data rate. In order to satisfy such requirements, transmission/reception technologies including a further enhanced MIMO transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of things (IoT) in the 5G communication system. mMTC also has various requirements, such as support of connection of a large number of UEs in a cell, enhancement coverage of UEs, improved battery time, a reduction in the cost of a UE, etc., in order to effectively provide the IoT. Since the IoT provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC should be configured to be inexpensive, and may require a very long battery life-time such as 10 to 15 years because it is difficult to frequently replace the battery of the UE.

URLLC is a cellular-based mission-critical wireless communication service. For example, URLLC may be used for services such as remote control for robots or machines, industrial automation, unmanned aerial vehicles, remote health care, and emergency alert. Thus, URLLC should provide communication with ultra-low latency and ultra-high reliability. For example, a service supporting URLLC should satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

### [NR Time-Frequency Resources]

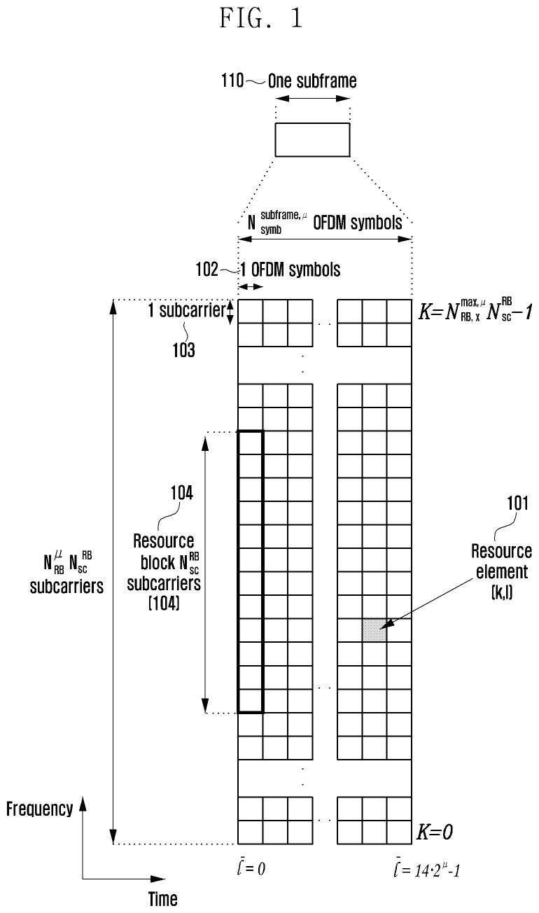

FIG. 1 illustrates a structure of a time-frequency domain in a wireless communication system according to an embodiment.

Referring to FIG. 1, the horizontal axis denotes a time domain, and the vertical axis denotes a frequency domain. The basic unit of resources in the time-frequency domain is a resource element (RE) 101, which may be defined as one OFDM symbol 102 on the time axis and one subcarrier 103 on the frequency axis. In the frequency domain,

$${N}_{SC}^{RB}$$

(e.g., 12) consecutive REs may constitute one resource block (RB) 104.

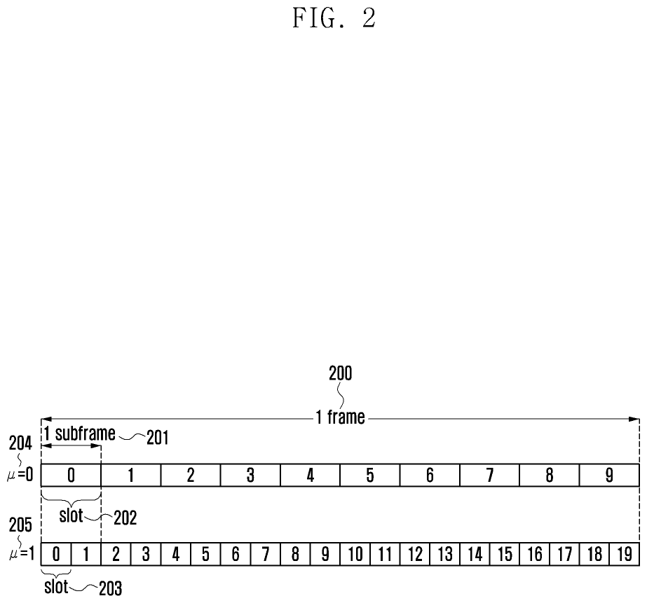

FIG. 2 illustrates a structure of a frame, a subframe, and a slot in a wireless communication system according to an embodiment.

Referring to FIG. 2, one frame 200 may be defined as 10 ms, and one subframe 201 may be defined as 1 ms. Thus, one frame 200 may include a total of ten subframes 201. One slot 202 or 203 may be defined as 14 OFDM symbols (that is, the number of symbols per one slot

$${N}_{symb}^{slot} = 14 ) .$$

One subframe 201 may include one or multiple slots 202 and 203, and the number of slots 202 and 203 per one subframe 201 may vary depending on configuration values μ for the SCS 204 or 205. The example in FIG. 2 illustrates a case in which the SCS configuration value is μ=0 (204), and a case in which μ=1 (205). In the case of μ=0 (204), one subframe 201 may include one slot 202, and in the case of μ=1 (205), one subframe 201 may include two slots 203. That is, the number of slots per one subframe may

$${N}_{slot}^{subframe , μ}$$

may differ depending on the SCS configuration value μ, and the number of slots per one frame

$${N}_{slot}^{frame , μ}$$

may differ accordingly.

$${N}_{slot}^{subframe , μ} and {N}_{slot}^{frame , μ}$$

may be defined according to each SCS configuration μ as in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [BWP]

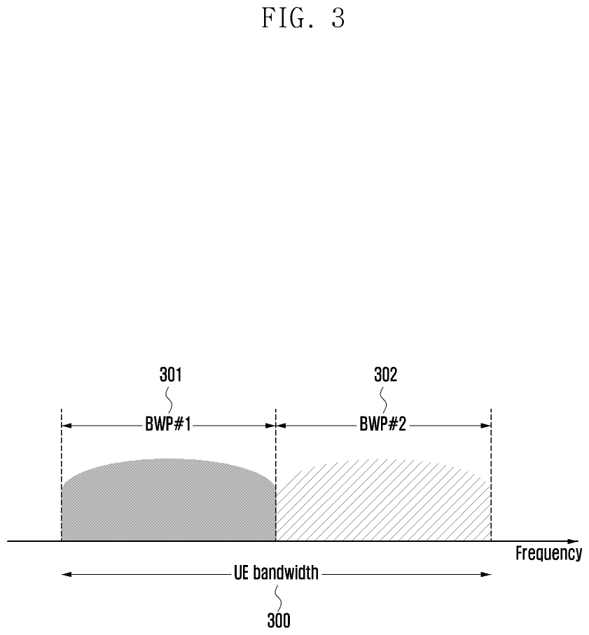

FIG. 3 illustrates an example of a BWP configuration in a wireless communication system according to an embodiment.

Referring to FIG. 3, a UE bandwidth 300 is configured to include two BWPs, i.e., BWP #1 301 and BWP #2 302. A base station may configure one or multiple BWPs for a UE, and may configure the following pieces of information with regard to each BWP as given below.

TABLE 2

| | |
|---|---|
| BWP ::= | SEQUENCE { |
| bwp-Id | BWP-Id, |
| locationAndBandwidth | INTEGER (1..65536), |
| subcarrierSpacing | ENUMERATED {n0, n1, n2, n3, n4, |

n5},

| | |
|---|---|
| cyclicPrefix | ENUMERATED { extended } |

}

The above example is not limiting, however, and various parameters related to the BWP may be configured for the UE, in addition to the above configuration information. The base station may transfer the configuration information to the UE through higher layer signaling, e.g., radio resource control (RRC) signaling. One configured BWP or at least one BWP among multiple configured BWPs may be activated. Whether or not the configured BWP is activated may be transferred from the base station to the UE semi-statically through RRC signaling, or dynamically through DCI.

According to some embodiments, before an RRC connection, an initial BWP for initial access may be configured for the UE by the base station through a master information block (MIB). More specifically, the UE may receive configuration information regarding a CORESET and a search space which may be used to transmit a PDCCH for receiving system information (SI) (which may correspond to remaining SI (RMSI) or SI block 1 (SIB1) for initial access through the MIB in the initial access step. Each of the CORESET and the search space configured through the MIB may be considered identity (ID) 0. The base station may notify the UE of configuration information, such as frequency allocation information, time allocation information, and numerology, regarding CORESET #0 through the MIB. In addition, the base station may notify the UE of configuration information regarding the monitoring cycle and occasion with regard to CORESET #0, that is, configuration information regarding search space #0, through the MIB. The UE may consider that a frequency domain configured by CORESET #0 acquired from the MIB is an initial BWP for initial access. The ID of the initial BWP may be considered to be 0.

The BWP-related configuration supported by 5G may be used for various purposes.

According to some embodiments, if the bandwidth supported by the UE is smaller than the system bandwidth, this may be supported through the BWP configuration. For example, the base station may configure the frequency location (configuration information 2) of the BWP for the UE, so that the UE can transmit/receive data at a specific frequency location within the system bandwidth.

In addition, according to some embodiments, the base station may configure multiple BWPs for the UE for the purpose of supporting different numerologies. For example, in order to support a UE's data transmission/reception using both an SCS of 15 kHz and an SCS of 30 kHz, two BWPs may be configured as SCSs of 15 kHz and 30 kHz, respectively. Different BWPs may be subjected to frequency division multiplexing (FDM), and if data is to be transmitted/received at a specific SCS, the BWP configured as the corresponding SCS may be activated.

In addition, according to some embodiments, the base station may configure BWPs having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the DL control channel with a large bandwidth of 100 MHz in the absence of traffic. In order to reduce power consumed by the UE, the base station may configure a BWP of a relatively small bandwidth (for example, a BWP of 20 MHz) for the UE. The UE may perform a monitoring operation in the 20 MHz BWP in the absence of traffic, and may transmit/receive data with the 100 MHz BWP as instructed by the base station if data has occurred.

In connection with the BWP configuring method, UEs, before being RRC-connected, may receive configuration information regarding the initial BWP through an MIB in the initial access step. More specifically, a UE may have a CORESET configured for a DL control channel which may be used to transmit DCI for scheduling an SI block (SIB) from the MIB of a physical broadcast channel (PBCH). The bandwidth of the CORESET configured by the MIB may be considered as the initial BWP, and the UE may receive, through the configured initial BWP, a physical DL shared channel (PDSCH) through which an SIB is transmitted. The initial BWP may be used not only for the purpose of receiving the SIB, but also for other SI (OSI), paging, random access, etc.

### [BWP Change]

If a UE has one or more BWPs configured therefor, the base station may indicate, to the UE, to change (or switch or transition) the BWPs by using a BWP indicator field inside DCI. As an example, if the currently activated BWP of the UE is BWP #1 301 in FIG. 3, the base station may indicate BWP #2 302 with a BWP indicator inside DCI, and the UE may change the BWP to BWP #2 302 indicated by the BWP indicator inside received DCI.

As described above, DCI-based BWP changing may be indicated by DCI for scheduling a PDSCH or a PUSCH, and thus, upon receiving a BWP change request, the UE needs to be able to receive or transmit the PDSCH or PUSCH scheduled by the corresponding DCI in the changed BWP with no problem. To this end, requirements for the delay time (T_{BWP}) required during a BWP change are specified in standards, and may be defined as given below, for example.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirements for the BWP change delay time support type 1 or type 2, depending on the capability of the UE. The UE may report the supportable BWP change delay time type to the base station.

If the UE has received DCI including a BWP change indicator in slot n, according to the above-described requirement regarding the BWP change delay time, the UE may complete a change to the new BWP indicated by the BWP change indicator at a time point not later than slot n+TBWP, and may transmit/receive a data channel scheduled by the corresponding DCI in the newly changed BWP. According to an embodiment, if the base station wants to schedule a data channel by using the new BWP, the base station may determine time domain resource allocation (TDRA) regarding the data channel, based on the UE's BWP change delay time (T_{BWP}). That is, when scheduling a data channel by using the new BWP, the base station may schedule the corresponding data channel after the BWP change delay time, in connection with the method for determining TDRA regarding the data channel. Accordingly, the UE may not expect that the DCI that indicates a BWP change will indicate a slot offset (K0 or K2) value smaller than the BWP change delay time (T_{BWP}).

If the UE has received DCI (e.g., DCI format 1_1 or 0_1) indicating a BWP change, the UE may perform no transmission or reception during a time interval from the third symbol of the slot used to receive a PDCCH including the corresponding DCI to the start point of the slot indicated by a slot offset (K0 or K2) value indicated by a TDRA indicator field in the corresponding DCI. For example, if the UE has received DCI indicating a BWP change in slot n, and if the slot offset value indicated by the corresponding DCI is K, the UE may perform no transmission or reception from the third symbol of slot n to the symbol before slot n+K (for example, the last symbol of slot n+K−1).

### [Synchronization Signal (SS)/PBCH Block]

An SS/PBCH block may refer to a physical layer channel block including a primary SS (PSS), a secondary SS (SSS), and a PBCH. Details thereof are as follows.
PSS: a signal which becomes a reference of DL time/frequency synchronization, and provides partial information of a cell ID.
SSS: becomes a reference of DL time/frequency synchronization, and provides remaining cell ID information not provided by the PSS. Additionally, the SSS may serve as a reference signal (RS) for PBCH demodulation of a PBCH.
PBCH: provides an MIB which is SI for the UE to transmit/receive data channels and control channels. The SI may include search space-related control information indicating a control channel's radio resource mapping information, scheduling control information regarding a separate data channel for transmitting SI, etc.
SS/PBCH block: the SS/PBCH block includes a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure CORESET #0 (which may correspond to a CORESET having a CORESET index of 0). The UE may monitor CORESET #0 by assuming that the DMRS transmitted in the selected SS/PBCH block and CORESET #0 are quasi-co-located (QCLed). The UE may receive SI with DL control information transmitted in CORESET #0. The UE may acquire configuration information related to a random access channel (RACH) for initial access from the received SI. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that CORESET #0 associated therewith is monitored.

### [PDCCH: Regarding DCI]

In a 5G system, scheduling information regarding UL data (or a PUSCH) or DL data (or PDSCH) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a PDCCH after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response (RAR). That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding SI may be scrambled by an SI-RNTI. DCI for scheduling a PDSCH regarding an RAR message may be scrambled by a random access (RA)-RNTI. DCI for scheduling a PDSCH regarding a paging message may be scrambled by a paging (P)-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information, for example.

TABLE 4

- Identifier for DCI formats − [1] bit
$- Frequency domain resource assignment - [ ⌈ {log}_{2} ( {N}_{RB}^{UL , BWP} ( {N}_{RB}^{UL , BWP} + 1 ) / 2 ) ⌉ ] bits$
- Time domain resource assignment − X bits
- Frequency hopping flag − 1 bit.
- Modulation and coding scheme (MCS) − 5 bits
- New data indicator (NDI) − 1 bit
- RV − 2 bits
- HARQ process number − 4 bits
- TPC command for scheduled PUSCH − [2] bits
- UL/ supplementary UL (UL/SUL) indicator − 0 or 1 bit

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information, for example.

```
TABLE 5
  - Carrier indicator − 0 or 3 bits
  - UL/SUL indicator − 0 or 1 bit
  - Identifier for DCI formats − [1] bits
  - BWP indicator − 0, 1 or 2 bits
  - Frequency domain resource assignment
    $* For resource allocation type 0 , ⌈ {N}_{RB}^{UL , BWP} / P ⌉ bits$
    $* For resource allocation type 1 , ⌈ {log}_{2} ( {N}_{RB}^{UL , BWP} ( {N}_{RB}^{UL , BWP} ( {N}_{RB}^{UL , BWP} + 1 ) / 2 ) ⌉ bits$
  - Time domain resource assignment −1, 2, 3, or 4 bits
  - Virtual RB (VRB)-to-physical RB (PRB) mapping − 0 or 1 bit, only
for resource allocation type 1.
    * 0 bit if only resource allocation type 0 is configured;
    * 1 bit otherwise.
  - Frequency hopping flag − 0 or 1 bit, only for resource allocation
  type 1.
    * 0 bit if only resource allocation type 0 is configured;
    * 1 bit otherwise.
  - MCS − 5 bits
  - NDI − 1 bit
  - RV − 2 bits
  - HARQ process number − 4 bits
  - 1st DL assignment index− 1 or 2 bits
    * 1 bit for semi-static HARQ-ACK codebook;
    * 2 bits for dynamic HARQ-ACK codebook with single HARQ-ACK
    codebook.
  - 2nd DL assignment index − 0 or 2 bits
    * 2 bits for dynamic HARQ-ACK codebook with two HARQ-ACK
    sub-codebooks;
    * 0 bit otherwise.
  - TPC command for scheduled PUSCH − 2 bits
  $- Sounding RS ( SRS ) resource indicator - ⌈ {log}_{2} ( {\sum }_{k = 1}^{{L}_{max} \sum } ( \begin{matrix}{N}_{SRS} \\ k\end{matrix} ) ) ⌉ or ⌈ {log}_{2} ( {N}_{SRS} ) ⌉ bits$
    $* ⌈ {log}_{2} ( {\sum }_{k = 1}^{{L}_{max} \sum } ( \begin{matrix}{N}_{SRS} \\ k\end{matrix} ) ) ⌉ bits for non - codebook based PUSCH transmission ;$
    * [log₂(N_{SRS})] bits for codebook based PUSCH transmission.
  - Precoding information and number of layers − up to 6 bits
  - Antenna ports − up to 5 bits
  - SRS request − 2 bits
  - CSI request − 0, 1, 2, 3, 4, 5, or 6 bits
  - Code block group (CBG) transmission information − 0, 2, 4, 6, or 8 bits
  8 bits
  - Phase tracking RS (PTRS)-DMRS association − 0 or 2 bits.
  - beta_offset indicator − 0 or 2 bits
  - DMRS sequence initialization − 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information, for example.

TABLE 6

- Identifier for DCI formats − [1] bit
$- Frequency domain resource assignment - [ ⌈ {log}_{2} ( {N}_{RB}^{DL , BWP} ( {N}_{RB}^{DL , BWP} + 1 ) / 2 ) ⌉ ]$
- Time domain resource assignment − X bits
- VRB-to-PRB mapping − 1 bit.
- MCS − 5 bits
- NDI − 1 bit
- RV − 2 bits
- HARQ process number − 4 bits
- DL assignment index − 2 bits
- TPC command for scheduled PUCCH − [2] bits
- PUCCH resource indicator − 3 bits
- PDSCH-to-HARQ feedback timing indicator − [3] bits

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information, for example.

```
TABLE 7
  - Carrier indicator − 0 or 3 bits
  - Identifier for DCI formats − [1] bits
  - BWP indicator − 0, 1 or 2 bits
  - Frequency domain resource assignment
      $* For resource allocation type 0 , ⌈ {N}_{RB}^{DL , BWP} / P ⌉ bits$
      $* For resource allocation type 1 , ⌈ {log}_{2} ( {N}_{RB}^{DL , BWP} ( {N}_{RB}^{DL , BWP} + 1 ) / 2 ) ⌉ bits$
- Time domain resource assignment −1, 2, 3, or 4 bits
- VRB-to-PRB mapping − 0 or 1 bit, only for resource allocation type 1.
      * 0 bit if only resource allocation type 0 is configured;
      * 1 bit otherwise.
- PRB bundling size indicator − 0 or 1 bit
- Rate matching indicator − 0, 1, or 2 bits
- Zero power (ZP) CSI- RS trigger − 0, 1, or 2 bits
For transport block (TB) 1:
  - MCS − 5 bits
  - NDI − 1 bit
  - RV − 2 bits
For TB 2:
  - MCS − 5 bits
  - NDI − 1 bit
  - RV − 2 bits
  - HARQ process number − 4 bits
  - DL assignment index − 0 or 2 or 4 bits
  - TPC command for scheduled PUCCH − 2 bits
  - PUCCH resource indicator − 3 bits
  - PDSCH-to-HARQ_feedback timing indicator − 3 bits
  - Antenna ports − 4, 5 or 6 bits
  - Transmission configuration indication − 0 or 3 bits
  - SRS request − 2 bits
  - CBG transmission information − 0, 2, 4, 6, or 8 bits
  - CBG flushing out information − 0 or 1 bit
  - DMRS sequence initialization − 1 bit
```

[PDCCH: CORESET, RE group (REG), control channel element (CCE), and Search Space]

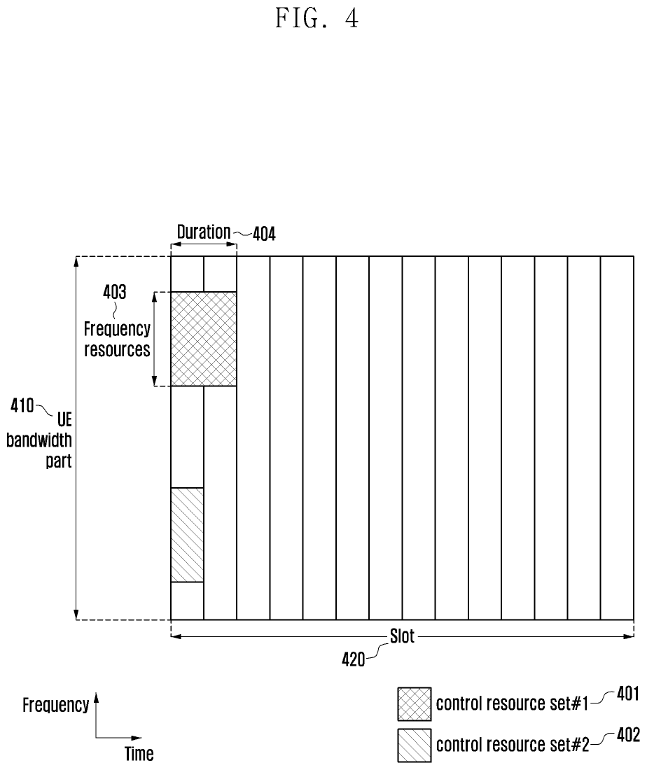

FIG. 4 illustrates an example of a CORESET used to transmit a DL control channel in a 5G wireless communication system according to an embodiment.

Referring to FIG. 4, a UE BWP 410 is configured along the frequency axis, and two CORESETs (CORESET #1 420 and CORESET #2 401) are configured within one slot 402 along the time axis. The CORESETs 401 and 402 may be configured in a specific frequency resource 410 within the entire UE BWP 403 along the frequency axis. The CORESETs 401 and 402 may be each configured as one or multiple OFDM symbols along the time domain, and the number of the OFDM symbols may be defined as a CORESET duration 404. In the example illustrated in FIG. 4, CORESET #1 401 is configured to have a CORESET duration corresponding to two symbols, and CORESET #2 402 is configured to have a CORESET duration corresponding to one symbol.

A CORESET in 5G described above may be configured for a UE by a base station through higher layer signaling (e.g., SI, MIB, RRC signaling). The description that a CORESET is configured for a UE means that information such as a CORESET identity, the CORESET's frequency location, and the CORESET's symbol duration is provided. For example, the following pieces of information may be included.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(CORESET identity)

| | |
|---|---|
| frequencyDomainResources | BIT STRING (SIZE (45)), |

(frequency domain resource assignment information)

| | |
|---|---|
| duration | INTEGER |

```
(1..maxCoReSetDuration),
  (time domain resource assignment information )
    cce-REG-MappingType
    CHOICE {
  (CCE-to-REG mapping scheme)
        interleaved
    SEQUENCE {
            reg-BundleSize
    ENUMERATED {n2, n3, n6},
      (REG bundle size)
            precoderGranularity
    ENUMERATED {sameAsREG-bundle, allContiguousRBs},
            interleaverSize
    ENUMERATED {n2, n3, n6}
            (interleaver size)
            shiftIndex
```

| | |
|---|---|
| INTEGER(0..maxNrofPhysicalResourceBlocks-1) | OPTIONAL |

```
          (interleaver shift)
    },
```

| | |
|---|---|
| nonInterleaved | NULL |

```
    },
    tci-StatesPDCCH
    SEQUENCE(SIZE (1..maxNrofTCI-StatesPDCCH)) OF TCI-StateId
            OPTIONAL,
  (QCL configuration information)
```

| tci-PresentInDCI | | ENUMERATED |
|---|---|---|
| {enabled} | OPTIONAL, | -- Need S |

}

In Table 8, tci-StatesPDCCH (simply referred to as TCI state) configuration information may include information of one or multiple SS/PBCH block indexes or CSI-RS indexes, which are QCLed with a DMRS transmitted in a corresponding CORESET.

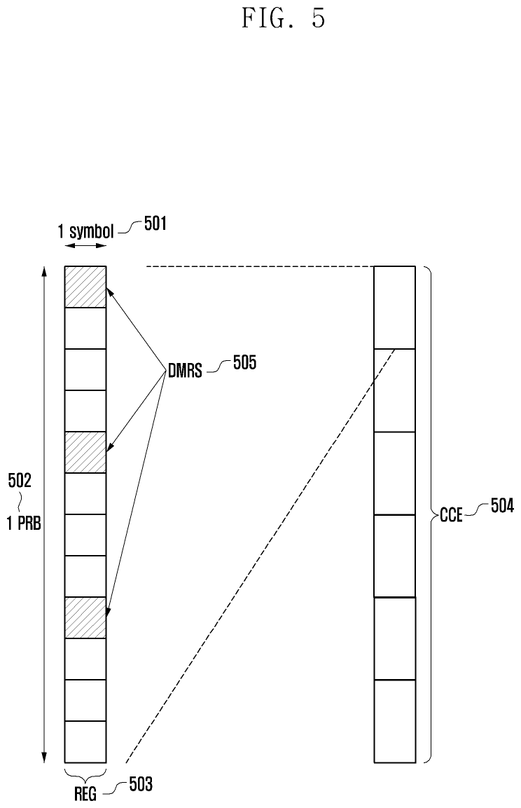

FIG. 5 illustrates a structure of a DL control channel in a wireless communication system according to an embodiment.

Referring to FIG. 5, the basic unit of time and frequency resources constituting a control channel may be referred to as a REG 503, and the REG 503 may be defined by one OFDM symbol 501 along the time axis and one PRB 502, that is, 12 subcarriers, along the frequency axis. The base station may configure a DL control channel allocation unit by concatenating the REGs 503.

Provided that the basic unit of DL control channel allocation in 5G is a CCE 504 as illustrated in FIG. 5, one CCE 504 may include multiple REGs 503. To describe the REG 503 illustrated in FIG. 5, for example, the REG 503 may include 12 REs, and if one CCE 504 includes six REGs 503, one CCE 504 may then include 72 REs. A DL CORESET, once configured, may include multiple CCEs 504, and a specific DL control channel may be mapped to one or multiple CCEs 504 and then transmitted according to the aggregation level (AL) in the CORESET. The CCEs 504 in the CORESET are distinguished by numbers, and the numbers of CCEs 504 may be allocated according to a logical mapping scheme.

The basic unit of the DL control channel illustrated in FIG. 5, that is, the REG 503, may include both REs to which DCI is mapped, and an area to which an RS (DMRS 505) for decoding the same is mapped. As in FIG. 5, three DMRSs 503 may be transmitted inside one REG 505. The number of CCEs necessary to transmit a PDCCH may be 1, 2, 4, 8, or 16 according to the AL, and different number of CCEs may be used to implement link adaption of the DL control channel. For example, in the case of AL=L, one DL control channel may be transmitted through L CCEs. The UE needs to detect a signal while being no information regarding the DL control channel, and thus a search space indicating a set of CCEs has been defined for blind decoding. The search space is a set of DL control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured ALs.

Search spaces may be classified into common search spaces and UE-specific search spaces. A group of UEs or all UEs may search a common search space of the PDCCH in order to receive cell-common control information such as dynamic scheduling regarding SI or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through higher layer signaling (e.g., SIB, MIB, or RRC signaling). For example, the base station may provide the UE with configurations such as the number of PDCCH candidates at each AL L, the monitoring cycle regarding the search space, the MO with regard to each symbol in a slot regarding the search space, the search space type (common search space or UE-specific search space), a combination of an RNTI and a DCI format to be monitored in the corresponding search space, a CORESET index for monitoring the search space, and the like. For example, the following pieces of information may be included.

TABLE 9

| | |
|---|---|
| SearchSpace ::= | SEQUENCE { |

-- Identity of the search space. SearchSpaceId = 0 identifies the SearchSpace
configured via PBCH (MIB) or ServingCellConfigCommon.

| | |
|---|---|
| searchSpaceId | SearchSpaceId, |

(search space identity)

| | |
|---|---|
| controlResourceSetId | ControlResourceSetId, |

(CORESET identity)

| | |
|---|---|
| monitoringSlotPeriodicityAndOffset | CHOICE { |

```
  (monitoring slot level periodicity)
      sl1
    NULL,
      sl2
    INTEGER (0..1),
      sl4
    INTEGER (0..3),
      sl5
    INTEGER (0..4),
      sl8
    INTEGER (0..7),
      sl10
    INTEGER (0..9),
      sl16
    INTEGER (0..15),
      sl20
    INTEGER (0..19)
    }
```

| | |
|---|---|
| | OPTIONAL, |
| duration(monitoring duration) | INTEGER (2..2559) |
| monitoringSymbolsWithinSlot | BIT STRING |

```
(SIZE (14))
      OPTIONAL,
  (monitoring symbols within slot)
```

| | |
|---|---|
| nrofCandidates | SEQUENCE { |

```
  (number of PDCCH candidates for each aggregation level)
      aggregationLevel1
    ENUMERATED {n0, n1, n2, n3, n4, n5, n6, n8},
      aggregationLevel2
    ENUMERATED {n0, n1, n2, n3, n4, n5, n6, n8},
      aggregationLevel4
    ENUMERATED {n0, n1, n2, n3, n4, n5, n6, n8},
      aggregationLevel8
    ENUMERATED {n0, n1, n2, n3, n4, n5, n6, n8},
      aggregationLevel16
    ENUMERATED {n0, n1, n2, n3, n4, n5, n6, n8}
    },
```

| | |
|---|---|
| searchSpaceType | CHOICE { |

```
    (search space type)
      -- Configures this search space as common search space (CSS) and DCI
formats to monitor.
      common
    SEQUENCE {
    (common search space)
    }
      ue-Specific
    SEQUENCE {
    (UE-specific search space)
        -- Indicates whether the UE monitors in this USS for DCI formats 0-
0 and 1-0 or for formats 0-1 and 1-1.
        formats
    ENUMERATED {formats0-0-And-1-0, formats0-1-And-1-1},
        ...
      }
```

According to configuration information, the base station may configure one or multiple search space sets for the UE. According to some embodiments, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the examples given below are not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Obviously, the examples given below are not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI Enumerated RNTIs may follow the definition and usage given below.

C-RNTI: used to schedule a UE-specific PDSCH

Temporary cell RNTI (TC-RNTI): used to schedule a UE-specific PDSCH

Configured scheduling RNTI (CS-RNTI): used to schedule a semi-statically configured UE-specific PDSCH

RA-RNTI: used to schedule a PDSCH in a random access step

P-RNTI: used to schedule a PDSCH in which paging is transmitted

SI-RNTI: used to schedule a PDSCH in which SI is transmitted

Interruption RNTI (INT-RNTI): used to indicate whether a PDSCH is punctured

TPC for PUSCH RNTI (TPC-PUSCH-RNTI): used to indicate a power control command regarding a PUSCH

TPC for PUCCH RNTI (TPC-PUCCH-RNTI): used to indicate a power control command regarding a PUCCH

TPC for SRS RNTI (TPC-SRS-RNTI): used to indicate a power control command regarding an SRS

The DCI formats enumerated above may follow the definitions given below.

TABLE 10

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

In 5G, the search space at AL L in connection with CORESET p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad [ Equation 1 ]$$

$$- L \text{:} AL$$

$$- {n}_{CI} \text{:} carrier index$$

$$- {n}_{CCE , p} \text{:} total number of CCEs existing in CORESET p$$

$$- {n}_{s , f}^{μ} \text{:} slot index$$

$$- {M}_{s , max}^{( L )} \text{:} number of PDCCH candidate at AL L$$

$$- {m}_{s , {n}_{CI}} = 0 , … , {M}_{s , max}^{( L )} - 1 \text{:} PDCCH candidate index at AL L$$

$$- i = 0 , … , L - 1$$

$$- {Y}_{p , {n}_{s , f}^{μ}} = ( {A}_{p} \cdot {Y}_{p , {n}_{s , f}^{μ} - 1} ) mod D , {Y}_{p , - 1} = {n}_{RNTI} \neq 0 , {A}_{p} = 39827 for pmod 3 = 0 , {A}_{p} = 39829 for pmod 3 = 1 , {A}_{p} = 39839 for pmod 3 = 2 , D = 65537$$

$$- {n}_{RNTI} \text{:} UE identity$$

The

$${Y}_{p , {n}_{s , f}^{μ}}$$

value may correspond to 0 in the case of a common search space.

The

$${Y}_{p , {n}_{s , f}^{μ}}$$

value may correspond to a value changed by the UE's identity (C-RNTI or ID configured for the UE by the base station) and the time index in the case of a UE-specific search space.

In 5G, multiple search space sets may be configured by different parameters (e.g., parameters in Table 10), and the group of search space sets monitored by the UE at each time point may differ accordingly. For example, if search space set #1 is configured at X-slot periodicity, if search space set #2 is configured at Y-slot periodicity, and if X and Y are different, the UE may monitor search space set #1 and search space set #2 both in a specific slot, and may monitor one of search space set #1 and search space set #2 both in another specific slot.

### [PDCCH: Span]

The UE may perform UE capability reporting at each SCS with regard to a case in which the same has multiple PDCCH MOs inside a slot, and the concept “span” may be used in this regard. A span refers to consecutive symbols configured such that the UE can monitor the PDCCH inside the slot, and each PDCCH MO is inside one span. A span may be expressed by (X,Y) wherein X refers to the minimum number of symbols by which the first symbols of two consecutive spans are spaced apart from each other, and Y refers to the number of consecutive symbols in which a PDCCH can be monitored within one span. The UE may monitor the PDCCH in a range inside a span corresponding to Y symbols from the first symbol of the span.

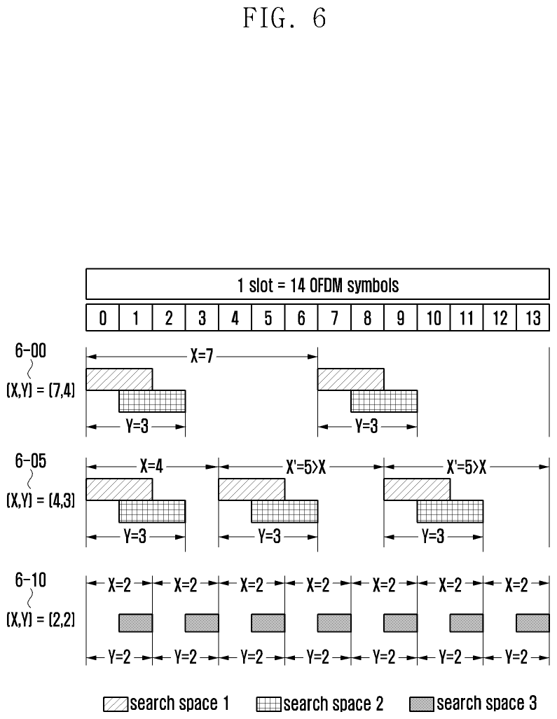

FIG. 6 illustrates, in terms of spans, a case in which a UE may have multiple PDCCH MOs within a slot in a wireless communication system according to an embodiment.

Referring to FIG. 6, possible spans are (X,Y)=(7,3), (4,3), (2,2), and the three cases may be indicated by “6-00”, “6-05”, and “6-10” in FIG. 6, respectively. As an example, “6-00” may describe a case in which there are two spans described by (7,4) inside a slot. The spacing between the first symbols of two spans is described as X=7, a PDCCH MO may exist inside a total of Y=3 symbols from the first symbol of each span, and search spaces 1 and 2 may exist inside Y=3 symbols, respectively. As another example, “6-05” may describe a case in which there are a total of three spans described by (4,3) inside a slot, and the second and third spans are spaced apart by X′=5 symbols which are larger than X=4.

### [PDCCH: UE Capability Report]

The slot location at which the above-described common search space and the UE-specific search space are positioned is indicated by parameter “monitoringSymbolsWitninSlot” in Table 11, and the symbol location inside the slot is indicated as a bitmap through parameter “monitoringSymbolsWithinSlot” in Table 9. Meanwhile, the symbol location inside a slot at which the UE can monitor search spaces may be reported to the base station through the following UE capabilities.
UE capability 1 (hereinafter referred to as FG 3-1). This UE capability may have the following meaning: if there is one MO regarding type land type 3 common search spaces or UE-specific search spaces inside a slot, as in Table 11 below, the UE can monitor the corresponding MO when the corresponding MO is located inside the first three symbols inside the slot. This UE capability is a mandatory capability which is to be supported by all UEs that support NR, and whether or not this UE capability is supported is not explicitly reported to the base station.

TABLE 11

| | | | Field |
|---|---|---|---|
| | | | name in |
| | Feature | | TS 38.331 |
| Index | group | Components | [2] |
| 3-1 | Basic DL | 1) One configured CORESET per BWP per cell in | n/a |
| | control | addition to CORESET0 | |
| | channel | CORESET resource allocation of 6RB bit-map | |
| | | and duration of 1-3 OFDM symbols for FR1 | |
| | | For type 1 CSS without dedicated RRC | |
| | | configuration and for type 0, 0A, and 2 CSSs, | |
| | | CORESET resource allocation of 6RB bit-map | |
| | | and duration 1-3 OFDM symbols for FR2 | |
| | | For type 1 CSS with dedicated RRC | |
| | | configuration and for type 3 CSS, UE specific SS, | |
| | | CORESET resource allocation of 6RB bit-map | |
| | | and duration 1-2 OFDM symbols for FR2 | |
| | | REG-bundle sizes of 2/3 RBs or 6 RBs | |
| | | Interleaved and non-interleaved CCE-to-REG | |
| | | mapping | |
| | | Precoder-granularity of REG-bundle size | |
| | | PDCCH DMRS scrambling determination | |
| | | TCI state(s) for a CORESET configuration | |
| | | 2) CSS and UE-SS configurations for unicast | |
| | | PDCCH transmission per BWP per cell | |
| | | PDCCH ALs 1, 2, 4, 8, 16 | |
| | | UP to 3 search space sets in a slot for a | |
| | | scheduled secondary cell (SCell) per BWP | |
| | | This search space limit is before applying all | |
| | | dropping rules. | |
| | | For type 1 CSS with dedicated RRC | |
| | | configuration, type 3 CSS, and UE-SS, the MO is | |
| | | within the first 3 OFDM symbols of a slot | |
| | | For type 1 CSS without dedicated RRC | |
| | | configuration and for type 0, 0A, and 2 CSS, the | |
| | | MO can be any OFDM symbol(s) of a slot, with | |
| | | the MOs for any of Type 1- CSS without | |
| | | dedicated RRC configuration, or Types 0, 0A, or 2 | |
| | | CSS configurations within a single span of three | |
| | | consecutive OFDM symbols within a slot | |
| | | 3) Monitoring DCI formats 0_0, 1_0, 0_1, 1_1 | |
| | | 4) Number of PDCCH blind decodes per slot with | |
| | | a given SCS follows Case 1-1 table | |
| | | 5) Processing one unicast DCI scheduling DL and | |
| | | one unicast DCI scheduling UL per slot per | |
| | | scheduled CC for frequency division duplex | |
| | | (FDD) | |
| | | 6) Processing one unicast DCI scheduling DL and | |
| | | 2 unicast DCI scheduling UL per slot per | |
| | | scheduled CC for time division duplex (TDD) | |

UE capability 2 (hereinafter referred to as FG 3-2). This UE capability has the following meaning: if there is one MO regarding a common search space or a UE-specific search space inside a slot, as in Table 12 below, the UE can monitor the corresponding MO no matter what of the startsymbol location of the corresponding MO may be. This UE capability is optionally supported by the UE, and whether or not this UE capability is supported is explicitly reported to the base station.

TABLE 12

| | Feature | | |
|---|---|---|---|
| Index | group | Components | Field name in TS 38.331 [2] |
| 3-2 | PDCCH | For a given UE, all search | pdcchMonitoringSingleOccasion |
| | monitoring | space configurations are within | |
| | on any | the same span of 3 consecutive | |
| | span of up | OFDM symbols in the slot | |
| | to 3 | | |
| | consecutive | | |
| | OFDM | | |
| | symbols | | |
| | of a slot | | |

UE capability 3 (hereinafter, referred to as FG 3-5, 3-5a, or 3-5b). This UE capability has the following meaning: if there are multiple MOs regarding a common search space or a UE-specific search space inside a slot, as in Table 13 below, the pattern of the MO which the UE can monitor is indicated. The above-mentioned pattern includes the spacing X between start symbols of different MOs, and the maximum symbol length Y regarding one MO. The combination of (X,Y) supported by the UE may be one or multiple among {(2,2), (4,3), (7,3)}. This UE capability is optionally supported by the UE, and whether or not this UE capability is supported and the above-mentioned combination of (X,Y) are explicitly reported to the base station.

TABLE 13

| | | | Field name in |
|---|---|---|---|
| | | | TS 38.331 |
| Index | Feature group | Components | [2] |
| 3-5 | For type 1 | For type 1 CSS with dedicated RRC | pdcch- |
| | CSS with | configuration, type 3 CSS, and UE-SS, | MonitoringAnyOccasions |
| | dedicated | MO can be any OFDM symbol(s) of a | {3-5. withoutDCI-Gap |
| | RRC | slot for Case 2 | 3-5a. withDCI-Gap} |
| | configuration, | | |
| | type 3 CSS, | | |
| | and UE-SS, | | |
| | MO can be | | |
| | any OFDM | | |
| | symbol(s) of | | |
| | a slot for | | |
| | Case 2 | | |
| 3-5a | For type 1 | For type 1 CSS with dedicated RRC | |
| | CSS with | configuration, type 3 CSS and UE-SS, | |
| | dedicated | MO can be any OFDM symbol(s) of a | |
| | RRC | slot for Case 2, with minimum time | |
| | configuration, | separation (including the cross-slot | |
| | type 3 CSS, | boundary case) between two DL | |
| | and UE-SS, | unicast DCIs, between two UL unicast | |
| | MO can be | DCIs, or between a DL and an UL | |
| | any OFDM | unicast DCI in different MOs where at | |
| | symbol(s) of | least one of them is not the MOs of | |
| | a slot for | FG-3-1, for a same UE as | |
| | Case 2 with a | 2OFDM symbols for 15 kHz | |
| | DCI gap | 4OFDM symbols for 30 kHz | |
| | | 7OFDM symbols for 60 kHz | |
| | | with NCP | |
| | | 11OFDM symbols for 120 kHz | |
| | | Up to one unicast DL DCI and up to | |
| | | one unicast UL DCI in a MO except | |
| | | for the MOs of FG 3-1. | |
| | | In addition for TDD the minimum | |
| | | separation between the first two UL | |
| | | unicast DCIs within the first 3 OFDM | |
| | | symbols of a slot can be zero OFDM | |
| | | symbols. | |
| 3-5b | All PDCCH | PDCCH MOs of FG-3-1, plus | |
| | MO can be | additional PDCCH MO(s) can be | |
| | any OFDM | any OFDM symbol(s) of a slot for | |
| | symbol(s) of | Case 2, and for any two PDCCH MOs | |
| | a slot for | belonging to different spans, where at | |
| | Case 2 with a | least one of them is not the MOs of | |
| | span gap | FG-3-1, in same or different search | |
| | | spaces, there is a minimum time | |
| | | separation of X OFDM symbols | |
| | | (including the cross-slot boundary | |
| | | case) between the start of two spans, | |
| | | where each span is of length up to Y | |
| | | consecutive OFDM symbols of a slot. | |
| | | Spans do not overlap. Every span is | |
| | | contained in a single slot. The same | |
| | | span pattern repeats in every slot. The | |
| | | separation between consecutive spans | |
| | | within and across slots may be | |
| | | unequal but the same (X, Y) limit | |
| | | must be satisfied by all spans. Every | |
| | | MO is fully contained in one span. In | |
| | | order to determine a suitable span | |
| | | pattern, first a bitmap b(l), 0 <= l <= 13 | |
| | | is generated, where b(l) = 1 if symbol l | |
| | | of any slot is part of a MO, b(l) = 0 | |
| | | otherwise. The first span in the span | |
| | | pattern begins at the smallest l for | |
| | | which b(l) = 1. The next span in the | |
| | | span pattern begins at the smallest l | |
| | | not included in the previous span(s) | |
| | | for which b(l) = 1. The span duration is | |
| | | max{maximum value of all | |
| | | CORESET durations, minimum value | |
| | | of Y in the UE reported candidate | |
| | | value} except possibly the last span in | |
| | | a slot which can be of shorter duration. | |
| | | A particular PDCCH monitoring | |
| | | configuration meets the UE capability | |
| | | limitation if the span arrangement | |
| | | satisfies the gap separation for at least | |
| | | one (X, Y) in the UE reported | |
| | | candidate value set in every slot, | |
| | | including cross slot boundary. | |
| | | For the set of MOs which are within | |
| | | the same span: | |
| | | Processing one unicast DCI | |
| | | scheduling DL and one unicast DCI | |
| | | scheduling UL per scheduled CC | |
| | | across this set of MOs for FDD | |
| | | Processing one unicast DCI | |
| | | scheduling DL and two unicast DCI | |
| | | scheduling UL per scheduled CC | |
| | | across this set of MOs for TDD | |
| | | Processing two unicast DCI | |
| | | scheduling DL and one unicast DCI | |
| | | scheduling UL per scheduled CC | |
| | | across this set of MOs for TDD | |
| | | The number of different start symbol | |
| | | indices of spans for all PDCCH MOs | |
| | | per slot, including PDCCH MOs of | |
| | | FG-3-1, is no more than floor(14/X) | |
| | | (X is minimum among values reported | |
| | | by UE). | |
| | | The number of different start symbol | |
| | | indices of PDCCH MOs per slot | |
| | | including PDCCH MOs of FG-3-1, is | |
| | | no more than 7. | |
| | | The number of different start symbol | |
| | | indices of PDCCH MOs per half-slot | |
| | | including PDCCH MOs of FG-3-1 is | |
| | | no more than 4 in SCell. | |

The UE may report whether the above-described capability 2 and/or capability 3 are supported and relevant parameters to the base station. The base station may allocate time-domain resources to the common search space and the UE-specific search space, based on the UE capability report. During the resource allocation, the base station may ensure that the MO is not positioned not at a location at which the UE cannot monitor the same.

### [QCL, TCI State]

In a wireless communication system, one or more different antenna ports (which may be replaced with one or more channels, signals, and combinations thereof, but in the following description of the disclosure, will be referred to as different antenna ports, as a whole, for the sake of convenience) may be associated with each other by a QCL configuration as in Table 14 below. A TCI state is for announcing the QCL relation between a PDCCH (or a PDCCH DMRS) and another RS or channel, and the description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) BM influenced by a spatial parameter. Accordingly, four types of QCL relations are supported in NR as in Table 14 below.

TABLE 14

| QCL type | Large-scale characteristics |
|---|---|
| A | Doppler shift, Doppler spread, |
| | average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE through RRC parameter TCI-state and QCL-info as in Table 15 below. Referring to Table 15, the base station may configure one or more TCI states for the UE, thereby informing of a maximum of two kinds of QCL relations (qcl-Type1, qcl-Type2) regarding the RS that refers to the ID of the TCI state, that is, the target RS. Each piece of QCL information (QCL-Info) included in each TCI state includes the serving cell index and the BWP index of the reference RS indicated by the corresponding QCL information, the type and ID of the reference RS, and a QCL type as in Table 14 above.

TABLE 15

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first reference RS of RS (target RS) referring to corresponding
TCI state ID)

| | |
|---|---|
| qcl-Type2 | QCL-Info |

```
      OPTIONAL, -- Need R
  (QCL information of second reference RS of RS (target RS) referring to
corresponding TCI state ID)
  ...
}
```

| | |
|---|---|
| QCL-Info ::= | SEQUENCE { |
| cell | ServCellIndex |
| OPTIONAL, | -- Need R |

(serving cell index of reference RS indicated by corresponding QCL information)

| | |
|---|---|
| bwp-Id | BWP-Id |
| | OPTIONAL, -- Cond CSI-RS-Indicated |

(BWP index of reference RS indicated by corresponding QCL information)

| | |
|---|---|
| referenceSignal | CHOICE { |
| csi-rs | NZP-CSI-RS- |

ResourceId,

| | |
|---|---|
| ssb | SSB- |

```
Index
    (one of CSI-RS ID or SSB ID indicated by corresponding QCL information)
  },
```

| | |
|---|---|
| qcl-Type | ENUMERATED |

{typeA, typeB, typeC, typeD},
...
}

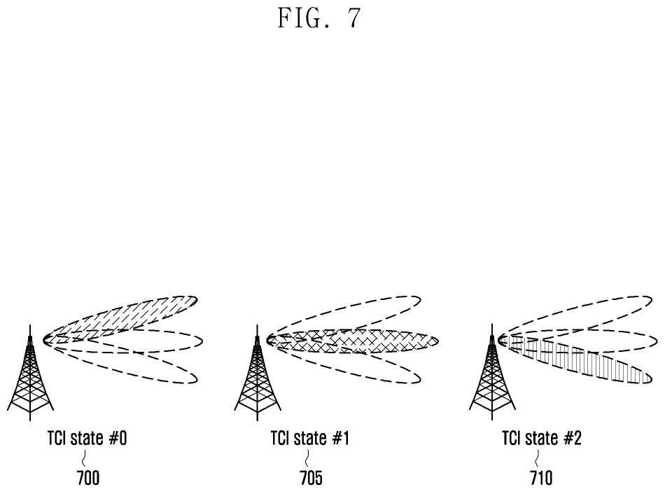

FIG. 7 illustrates an example of base station beam allocation according to a TCI state configurations in a wireless communication system according to an embodiment.

Referring to FIG. 7, the base station may transfer information regarding N different beams to the UE through N different TCI states. For example, in the case of N-3 as in FIG. 7, the base station may configure qcl-Type2 parameters included in three TCI states 700, 705, and 710 in QCL type D while being associated with CSI-RSs or SSBs corresponding to different beams, thereby notifying that antenna ports referring to the different TCI states 700, 705, and 710 are associated with different spatial Rx parameters, that is, different beams.

Tables 16 to 20 below enumerate valid TCI state configurations according to the target antenna port type.

Table 16 enumerates valid TCI state configurations when the target antenna port is a tracking CSI-RS (TRS). The TRS refers to an NZP CSI-RS which has no repetition parameter configured therefor, and trs-Info of which is configured as “true”, among CRI-RSs. In Table 16, configuration no. 3 may be used for an aperiodic TRS.

TABLE 16

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 17 enumerates valid TCI state configurations when the target antenna port is a CSI-RS for CSI. The CSI-RS for CSI refers to an NZP CSI-RS which has no parameter indicating repetition (e.g., repetition parameter) configured therefor, and trs-Info of which is not configured as “true”, among CRI-RSs.

TABLE 17
Valid TCI state configurations when the
target antenna port is a CSI-RS for CSI

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as | QCL-TypeD |
| | | | DL RS 1) | |
| 4 | TRS | QCL-TypeB | | |

Table 18 enumerates valid TCI state configurations when the target antenna port is a CSI-RS for beam management (BM) (which has the same meaning as CSI-RS for layer 1 (L1) RSRP reporting). The CSI-RS for BM refers to an NZP CSI-RS which has a repetition parameter configured to have a value of “on” or “off”, and trs-Info of which is not configured as “true”, among CRI-RSs.

TABLE 18
Valid TCI state configurations when the target antenna
port is a CSI-RS for BM (for L1 RSRP reporting)

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 19 enumerates valid TCI state configurations when the target antenna port is a PDCCH DMRS.

TABLE 19
Valid TCI state configurations when the
target antenna port is a PDCCH DMRS

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Table 20 enumerates valid TCI state configurations when the target antenna port is a PDSCH DMRS.

TABLE 20
Valid TCI state configurations when the
target antenna port is a PDSCH DMRS

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS | QCL-TypeD |
| | (CSI) | | (CSI) | |

According to a representative QCL configuration method based on Tables 16 to 20 above, the target antenna port and reference antenna port for each step are configured and operated such as “SSB”-> “TRS”-> “CSI-RS for CSI, or CSI-RS for BM, or PDCCH DMRS, or PDSCH DMRS”. Accordingly, it is possible to help the UE's receiving operation by associating statistical characteristics that can be measured from the SSB and TRS with respective antenna ports.

### [PDCCH: Regarding TCI State]

Specific TCI state combinations applicable to a PDCCH DMRS antenna port may be given in Table 21 below. The fourth row in Table 21 corresponds to a combination assumed by the UE before RRC configuration, and no configuration is possible after the RRC.

TABLE 21

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | TRS | QCL- | TRS | QCL-TypeD |
| | | TypeA | | |
| 2 | TRS | QCL- | CSI-RS (BM) | QCL-TypeD |
| | | TypeA | | |
| 3 | CSI-RS | QCL- | | |
| | (CSI) | TypeA | | |
| 4 | SS/PBCH | QCL- | SS/PBCH | QCL-TypeD |
| | Block | TypeA | Block | |

In NR, a hierarchical signaling method is supported for dynamic allocation regarding a PDCCH beam.

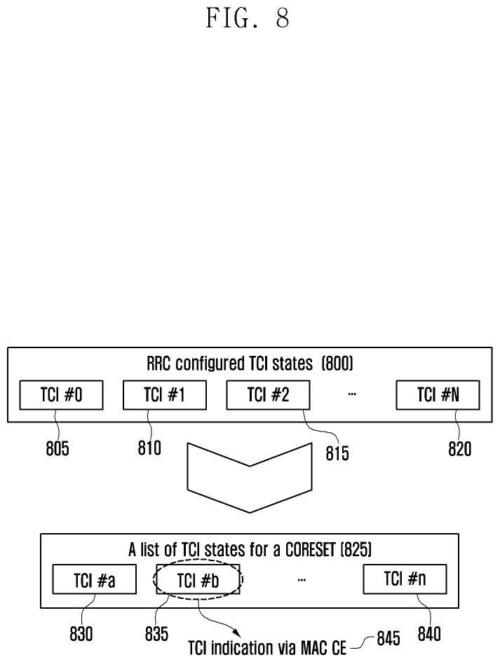

FIG. 8 illustrates an example of a method for allocating a TCI state to a PDCCH in a wireless communication system according to an embodiment.

Referring to FIG. 8, the base station may configure N TCI states 805, 810, . . . , 820 for the UE through RRC signaling 800, and may configure some of the states as TCI states for a CORESET (825). The base station may then indicate one of the TCI states 830, 835, and 840 for the CORESET to the UE through MAC CE signaling (845). The UE may then receive a PDCCH, based on beam information included in the TCI state indicated by the MAC CE signaling.

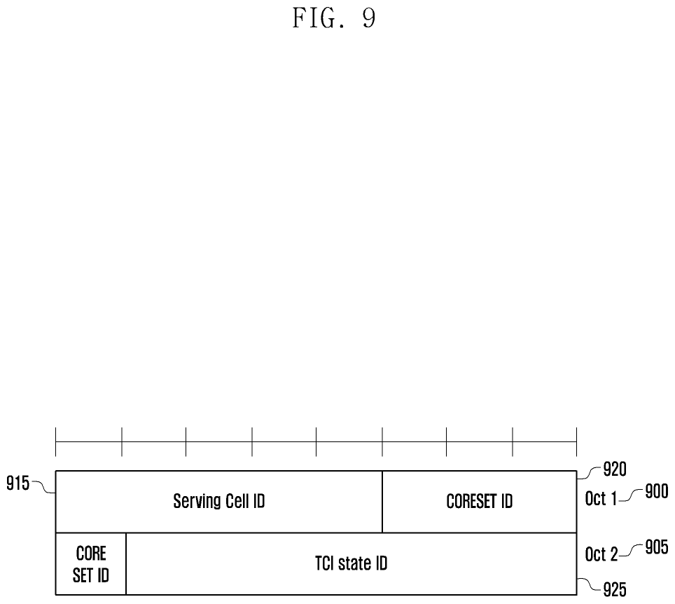

FIG. 9 illustrates a TCI indication MAC CE signaling structure for a PDCCH DMRS in a wireless communication system according to an embodiment.

Referring to FIG. 9, the TCI indication MAC CE signaling for the PDCCH DMRS may be configured by 2 bytes (16bits) 900 and 905, and include a 5-bit serving cell ID 915, a 4-bit CORESET ID 920, and a 7-bit TCI state ID 925.

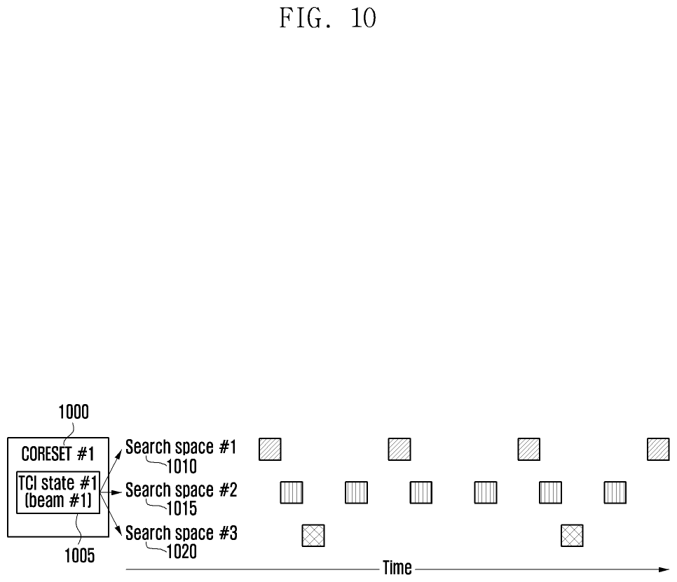

FIG. 10 illustrates an example of a beam configuration with regard to a CORESET and a search space in a wireless communication system according to an embodiment.

Referring to FIG. 10, the base station may indicate one of TCI state lists included in CORESET 1000 configuration through MAC CE signaling (1005). Until a different TCI state is indicated for the corresponding CORESET through different MAC CE signaling, the UE may consider that identical QCL information (beam #1) 1005 is all applied to one or more search spaces 1010, 1015, and 1020 connected to the CORESET. The above-described PDCCH beam allocation method may have a problem in that it is difficult to indicate a beam change faster than MAC CE signaling delay, and the same beam is unilaterally applied to each CORESET regardless of search space characteristics, thereby making flexible PDCCH beam operation difficult. Following embodiments of the disclosure provide more flexible PDCCH beam configuration and operation methods. Although multiple distinctive examples will be provided for convenience of description of embodiments of the disclosure, they are not mutually exclusive, and can be combined and applied appropriately for each situation.

The base station may configure one or multiple TCI states for the UE with regard to a specific CORESET, and may activate one of the configured TCI states through a MAC CE activation command. For example, if {TCI state #0, TCI state #1, TCI state #2} are configured as TCI states for CORESET #1, the base station may transmit an activation command to the UE through a MAC CE such that TCI state #0 is assumed as the TCI state regarding CORESET #1. That is, based on the activation command regarding the TCI state received through the MAC CE, the UE may correctly receive the DMRS of the corresponding CORESET, based on QCL information in the activated TCI state.

With regard to a CORESET having a configured index of 0 (CORESET #0), if the UE has failed to receive a MAC CE activation command regarding the TCI state of CORESET #0, the UE may assume that the DMRS transmitted in CORESET #0 has been QCL-ed with a SS/PBCH block identified in the initial access process, or in a non-contention-based random access process not triggered by a PDCCH command.

With regard to a CORESET having a configured index value other than 0 (CORESET #X), if the UE has no TCI state configured regarding CORESET #X, or if the UE has one or more TCI states configured therefor but has failed to receive a MAC CE activation command for activating one thereof, the UE may assume that the DMRS transmitted in CORESET #X has been QCL-ed with a SS/PBCH block identified in the initial access process.

### [Rate Matching/Puncturing]

If time and frequency resource A to transmit symbol sequence A overlaps time and frequency resource B, a rate matching or puncturing operation may be considered as an operation of transmitting/receiving channel A in consideration of resource C (region in which resource A and resource B overlap).

### Rate Matching Operation

A base station may transmit channel A after mapping the same only to remaining resource domains other than resource C (area overlapping resource B) among the entire resource A which is to be used to transmit symbol sequence A to the UE. For example, if symbol sequence A is configured as {symbol #1, symbol #2, symbol #3, symbol #4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3} (corresponding to resource C) among resource A. Consequently, the base station may transmit symbol sequence {symbol #1, symbol #2, symbol #3} after mapping the same to {resource #1, resource #2, resource #4}, respectively.

A UE may assess resource A and resource B from scheduling information regarding symbol sequence A from the base station, thereby assessing resource C (region in which resource A and resource B overlap). The UE may receive symbol sequence A, based on an assumption that symbol sequence A has been mapped and transmitted in the remaining area other than resource C among the entire resource A. For example, if symbol sequence A is configured as {symbol #1, symbol #2, symbol #3, symbol #4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3} (corresponding to resource C) among resource A. Consequently, the UE may perform a series of following receiving operations based on an assumption that symbol sequence {symbol #1, symbol #2, symbol #3} has been transmitted after being mapped to {resource #1, resource #2, resource #4}, respectively.

### Puncturing Operation

If there is resource C (region overlapping resource B) among the entire resource A which is to be used to transmit symbol sequence A to the UE, the base station may map symbol sequence A to the entire resource A, but may not perform transmission in the resource area corresponding to resource C, and may perform transmission with regard to only the remaining resource area other than resource C among resource A. For example, if symbol sequence A is configured as {symbol #1, symbol #2, symbol #3, symbol #4}, if resource A is {resource #1,resource #2, resource #3, and resource #4}, if resource B is {resource #3, resource #5}, the UE may assume that symbol sequence A {symbol #1, symbol #2,symbol #3, symbol #4} is mapped to resource A {resource #1, resource #2, resource #3,resource #4}, respectively, but {symbol #3} mapped to {resource #3} (corresponding to resource C) is not transmitted, and based on the assumption that symbol sequence {symbol #1, symbol #2, symbol #4} corresponding to remaining resources {resource #1, resource #2, resource #4} other than {resource #3} (corresponding to resource C) among resource A has been mapped and transmitted, the UE may receive the same. Consequently, the base station may transmit symbol sequence {symbol #1, symbol #2, symbol #4} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A, based on an assumption that symbol sequence A has been mapped to the entire resource A but transmitted only in the remaining area other than resource C among the resource area A. For example, if symbol sequence A is configured as {symbol #1, symbol #2, symbol #3, symbol #4}, if resource A is {resource #1, resource #2, resource #3, resource #4}, and if resource B is {resource #3, resource #5}, the UE may assume that symbol sequence A {symbol #1, symbol #2, symbol #3, symbol #4} is mapped to resource A {resource #1, resource #2, resource #3, resource #4}, respectively, but {symbol #3} mapped to {resource #3} (corresponding to resource C) is not transmitted, and based on the assumption that symbol sequence {symbol #1, symbol #2, symbol #4} corresponding to remaining resources {resource #1, resource #2, resource #4} other than {resource #3} (corresponding to resource C) among resource A has been mapped and transmitted, the UE may receive the same. Consequently, the UE may perform a series of following receiving operations based on an assumption that symbol sequence {symbol #1, symbol #2, symbol #4} has been transmitted after being mapped to {resource #1, resource #2, resource #4}, respectively.

Hereinafter, a method for configuring an RMR for the purpose of rate matching in a 5G communication system will be described. Rate matching refers to adjusting the size of a signal in consideration of the amount of resources that can be used to transmit the signal. For example, data channel rate matching may mean that a data channel is not mapped and transmitted with regard to specific time and frequency resource domains, and the size of data is adjusted accordingly.

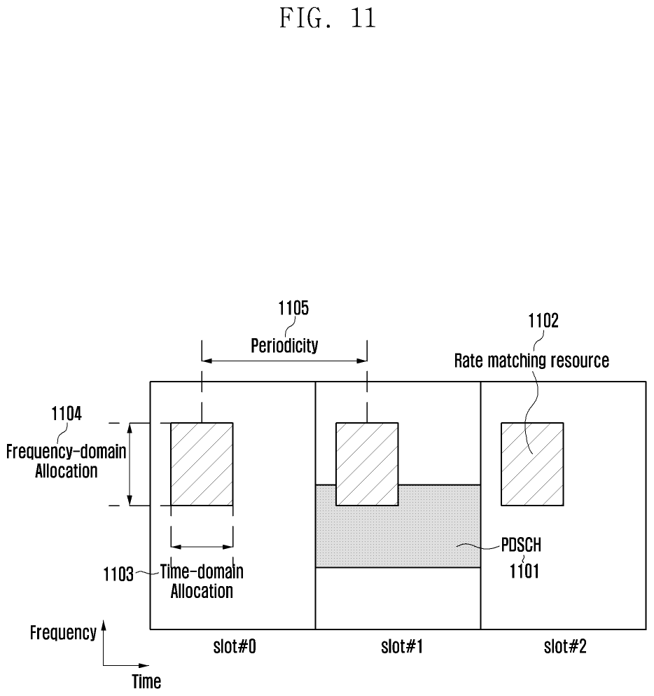

FIG. 11 illustrates a method in which a base station and a UE transmit/receive data in consideration of a DL data channel and an RMR in a wireless communication system according to an embodiment.

Referring to FIG. 11, a DL data channel (e.g., a PDSCH) 1101 and an RMR 1102 are provided. The base station may configure one or multiple RMRs 1102 for the UE through higher layer signaling (e.g., RRC signaling). RMR 1102 configuration information may include time-domain resource allocation information 1103, frequency-domain resource allocation information 1104, and periodicity information 1105. A bitmap corresponding to the frequency-domain resource allocation information 1104 will hereinafter be referred to as “first bitmap”, a bitmap corresponding to the time-domain resource allocation information 1103 will be referred to as “second bitmap”, and a bitmap corresponding to the periodicity information 1105 will be referred to as “third bitmap”. If all or some of time and frequency resources of the scheduled PDSCH 1101 overlap a configured RMR 1102, the base station may rate-match and transmit the PDSCH 1101 in an RMR 1102 part, and the UE may perform reception and decoding after assuming that the PDSCH 1101 has been rate-matched in an RMR 1102 part.

The base station may dynamically notify the UE, through DCI, of whether the PDSCH will be rate-matched in the configured RMR part through an additional configuration (e.g., corresponding to “rate matching indicator” inside DCI format described above). Specifically, the base station may select some from the configured RMRs and group them into an RMR group, and may indicate, to the UE, whether the PDSCH is rate-matched with regard to each RMR group through DCI by using a bitmap type. For example, if four RMRs RMR #1, RMR #2, RMR #3, and RMR #4 are configured, the base station may configure a rate matching groups RMG #1={RMR #1, RMR #2}, RMG #2={RMR #3, RMR #4}, and may indicate, to the UE, whether rate matching occurs in RMG #1 and RMG #2, respectively, through a bitmap by using two bits inside the DCI field. For example, in a case where rate matching is to be conducted, the base station may indicate this case by “1”, and in a case where rate matching is not to be conducted, the base station may indicate this case by “0”.

5G supports granularity of “RB symbol level” and “RE level” as a method for configuring the above-described RMRs for a UE. More specifically, the following configuration method may be followed.

### RB Symbol Level

The UE may have a maximum of four RateMatchPatterns configured per each BWP through higher layer signaling, and one RateMatchPattern may include:
in connection with a reserved resource inside a BWP, a resource having time and frequency resource domains of the corresponding reserved resource configured as a combination of an RB-level bitmap and a symbol-level bitmap in the frequency domain. The reserved resource may span one or two slots. A time domain pattern (periodicity AndPattern) may be additionally configured wherein time and frequency domains including respective RB-level and symbol-level bitmap pairs are repeated; and/or
a resource area corresponding to a time domain pattern configured by time and frequency domain resource areas configured by a CORESET inside a BWP and a search space configuration in which corresponding resource areas are repeated.

### RE Level

The UE may have the following contents configured through higher layer signaling.
configuration information (lte-CRS-ToMatchAround) regarding a RE corresponding to a LTE CRS (Cell-specific RS or common RS) pattern, which may include LTE CRS's port number (nrofCRS-Ports) and LTE-CRS-vshift(s) value (v-shift), location information (carrierFreqDL) of a center subcarrier of a LTE carrier from a reference frequency point (for example, reference point A), the LTE carrier's bandwidth size (carrierBandwidthDL) information, subframe configuration information (mbsfn-SubframConfigList) corresponding to a multicast-broadcast single-frequency network (MBSFN), etc. The UE may determine the position of the CRS inside the NR slot corresponding to the LTE subframe, based on the above-mentioned pieces of information.
may include configuration information regarding a resource set corresponding to one or multiple ZP CSI-RSs inside a BWP.

### [PDCCH: Regarding QCL Prioritization Rule]

If multiple CORESETs which operate according to CA inside a single cell or band and which exist inside a single or multiple in-cell activated BWPs overlap temporally while having identical or different QCL-TypeD characteristics in a specific PDCCH MO, the UE may select a specific CORESET according to a QCL priority determining operation and may monitor CORESETs having the same QCL-TypeD characteristics as the corresponding CORESET. That is, if multiple CORESETs overlap temporally, only one QCL-TypeD characteristic can be received. The QCL priority may be determined by the following criteria.
Criterion 1. A CORESET connected to a common search space having the lowest index inside a cell corresponding to the lowest index among cells including a common search space
Criterion 2. A CORESET connected to a UE-specific search space having the lowest index inside a cell corresponding to the lowest index among cells including a UE-specific search space

As described above, if one criterion among the criteria is not satisfied, the next criterion may be applied. For example, if CORESETs overlap temporally in a specific PDCCH MO, and if all CORESETs are not connected to a common search space but connected to a UE-specific search space (e.g., if criterion 1 is not satisfied), the UE may omit application of criterion 1 and apply criterion 2.

If selecting CORESET according to the above-mentioned criteria, the UE may additionally consider the two aspects with regard to QCL information configured for the CORESET. Firstly, if CORESET 1 has CSI-RS 1 as an RS having a relation of QCL-TypeD, if this CSI-RS 1 has a relation of QCL-TypeD with RS SSB 1, and if another CORESET 2 has a relation of QCL-TypeD with RS SSB 1, the UE may consider that the two CORESETs 1 and 2 have different QCL-TypeD characteristics. Secondly, if CORESET 1 has CSI-RS 1 configured for cell 1 as an RS having a relation of QCL-TypeD, if this CSI-RS 1 has a relation of QCL-TypeD with RS SSB 1, if CORESET 2 has a relation of QCL-TypeD with RS CSI-RS 2 configured for cell 2, and if this CSI-RS 2 has a relation of QCL-TypeD with the same RS SSB 1, the UE may consider that the two CORESETs have the same QCL-TypeD characteristics.

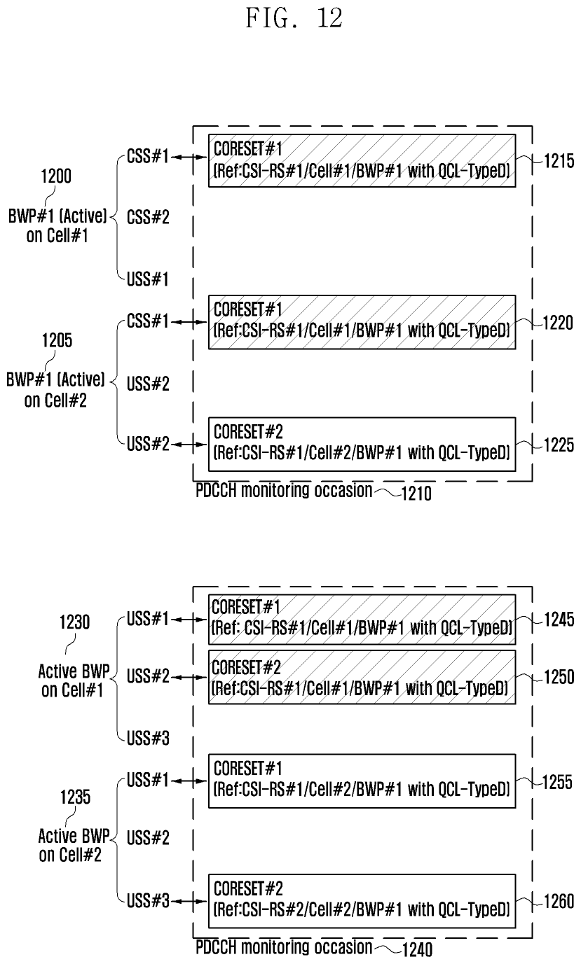

FIG. 12 illustrates a method in which, upon receiving a DL control channel, a UE selects a receivable CORESET in consideration of priority in a wireless communication system according to an embodiment.

Referring to FIG. 12, the UE may be configured to receive multiple CORESETs overlapping temporally in a specific PDCCH MO 1210, and such multiple CORESETs may be connected to a common search space or a UE-specific search space with regard to multiple cells. In the corresponding PDCCH MO, CORESET no. 1 1200 connected to common search space no. 1 may exist in BWP no. 1 1215 of cell no. 1, and CORESET no. 1 1205 connected to common search space no. 1 and CORESET no. 2 1220 connected to UE-specific search space no. 2 may exist in BWP no. 1 1225 of cell no. 2. The CORESETs 1215 and 1220 may have a relation of QCL-TypeD with CSI-RS resource no. 1 configured in BWP no. 1 of cell no. 1, and the CORESET 1225 may have a relation of QCL-TypeD with CSI-RS resource no. 1 configured in BWP no. 1 of cell no. 2. If criterion 1 is applied to the corresponding PDCCH MO 1210, all other CORESETs having the same RS of QCL-TypeD as CORESET no. 1 1215 may be received. Therefore, the UE may receive the CORESETs 1210 and 1215 in the corresponding PDCCH MO 1220. As another example, the UE may be configured to receive multiple CORESETs overlapping temporally in a specific PDCCH MO 1240, and such multiple CORESETs may be connected to a common search space or a UE-specific search space with regard to multiple cells. In the corresponding PDCCH MO, CORESET no. 1 1230 connected to UE-specific search space no. 1 and CORESET no. 2 1245 connected to UE-specific search space no. 2 may exist in BWP no. 1 1250 of cell no. 1, and CORESET no. 1 1235 connected to UE-specific search space no. 1 and CORESET no. 2 1255 connected to UE-specific search space no. 3 may exist in BWP no. 1 1260 of cell no. 2. The CORESETs 1245 and 1250 may have a relation of QCL-TypeD with CSI-RS resource no. 1 configured in BWP no. 1 of cell no. 1, the CORESET 1255 may have a relation of QCL-TypeD with CSI-RS resource no. 1 configured in BWP no. 1 of cell no. 2, and the CORESET 1260 may have a relation of QCL-TypeD with CSI-RS resource no. 2 configured in BWP no. 1 of cell no. 2. If criterion 1 is applied to the corresponding PDCCH MO 1240, there is no common search space, and the next criterion, that is, criterion 2, may thus be applied. If criterion 2 is applied to the corresponding PDCCH MO 1240, all other CORESETs having the same RS of QCL-TypeD as CORESET no. 1 1245 may be received. Therefore, the UE may receive the CORESETs 1240 and 1245 in the corresponding PDCCH MO 1250.

### [LTE Cell-Specific RS (CRS) Rate Match]

In NR, for coexistence between LTE and new RAT (NR) (LTE-NR coexistence), the pattern of CRS of LTE may be configured for an NR UE. More specifically, the CRS pattern may be provided by RRC signaling including at least one parameter inside ServingCellConfig information element (IE) or ServingCellConfigCommon IE. Examples of the parameter may include Ite-CRS-ToMatchAround, Ite-CRS-PatternList1-r16, Ite-CRS-PatternList2-r16, crs-RateMatch-PerCORESETPoolIndex-r16, and the like.

Rel-15 NR provides a function by which one CRS pattern can be configured per serving cell through parameter lte-CRS-ToMatchAround. In Rel-16 NR, the above function has been expanded such that multiple CRS patterns can be configured per serving cell.

More specifically, a UE having a single transmission and reception point (TRP) configuration may now have one CRS pattern configured per one LTE carrier, and a UE having a multi-TRP configuration may now have two CRS patterns configured per one LTE carrier. For example, the UE having a single-TRP configuration may have a maximum of three CRS patterns configured per serving cell through parameter lte-CRS-PatternList1-r16.

As another example, the UE having a multi-TRP configuration may have a CRS configured for each TRP. That is, the CRS pattern regarding TRP1 may be configured through parameter lte-CRS-PatternList1-r16, and the CRS pattern regarding TRP2 may be configured through parameter lte-CRS-PatternList2-r16. If two TRPs are configured as above, whether the CRS patterns of TRP1 and TRP2 are both to be applied to a specific PDSCH or only the CRS pattern regarding one TRP is to be applied is determined through parameter crs-RateMatch-PerCORESETPoolIndex-r16, wherein if parameter crs-RateMatch-PerCORESETPoolIndex-r16 is configured “enabled”, only the CRS pattern of one TRP is applied, and both CRS patterns of the two TRPs are applied in other cases.

Table 22 shows a ServingCellConfig IE including the CRS patterns, and Table 23 shows a RateMatchPatternLTE-CRS IE including at least one parameter regarding CRS patterns.

TABLE 22

| | |
|---|---|
| ServingCellConfig ::= | SEQUENCE |

| | |
|---|---|
| tdd-UL-DL-ConfigurationDedicated | TDD-UL-DL-ConfigDedicated |

| | |
|---|---|
| OPTIONAL, | -- Cond TDD |

| | |
|---|---|
| initialDLBWP | BWP-DLDedicated |

| | |
|---|---|
| OPTIONAL, | -- Need M |

| DLBWP-ToReleaseList | SEQUENCE (SIZE (1..maxNrofBWPs)) OF | |
|---|---|---|
| BWP-Id | OPTIONAL, | -- Need N |

| | |
|---|---|
| DLBWP-ToAddModList | SEQUENCE (SIZE (1..maxNrofBWPs)) OF |

| | | |
|---|---|---|
| BWP-DL | OPTIONAL, | -- Need N |

| | |
|---|---|
| firstActiveDLBWP-Id | BWP-Id |

| | |
|---|---|
| OPTIONAL, | -- Cond SyncAndCellAdd |

| | |
|---|---|
| bwp-InactivityTimer | ENUMERATED {ms2, ms3, ms4, ms5, |

ms6, ms8, ms10, ms20, ms30,

ms40,ms50, ms60,

ms80,ms100, ms200,ms300, ms500,

ms750, ms1280, ms1920,

ms2560, spare10, spare9, spare8,

spare7, spare6, spare5,

| | | |
|---|---|---|
| spare4, spare3, spare2, spare1 } | OPTIONAL, | -- Need R |

| | |
|---|---|
| defaultDLBWP-Id | BWP-Id |

| | |
|---|---|
| OPTIONAL, | -- Need S |

| | |
|---|---|
| ULConfig | ULConfig |

| | |
|---|---|
| OPTIONAL, | -- Need M |

| | |
|---|---|
| supplementaryUL | ULConfig |

| | |
|---|---|
| OPTIONAL, | -- Need M |

| | |
|---|---|
| pdcch-ServingCellConfig | SetupRelease { PDCCH- |

| | | |
|---|---|---|
| ServingCellConfig } | OPTIONAL, | -- Need M |

| | |
|---|---|
| pdsch-ServingCellConfig | SetupRelease { PDSCH- |

| | | |
|---|---|---|
| ServingCellConfig } | OPTIONAL, | -- Need M |

| | |
|---|---|
| csi-MeasConfig | SetupRelease { CSI-MeasConfig } |

| | |
|---|---|
| OPTIONAL, | -- Need M |

| | |
|---|---|
| sCellDeactivationTimer | ENUMERATED {ms20, ms40, ms80, |

ms160, ms200, ms240,

ms320, ms400, ms480,

ms520, ms640, ms720,

ms840, ms1280,

| | | |
|---|---|---|
| spare2,spare1} | OPTIONAL, | -- Cond ServingCellWithoutPUCCH |

| | |
|---|---|
| crossCarrierSchedulingConfig | CrossCarrierSchedulingConfig |

| | |
|---|---|
| OPTIONAL, | -- Need M |

| | |
|---|---|
| tag-Id | TAG-Id, |

| | |
|---|---|
| dummy | ENUMERATED {enabled} |

| | |
|---|---|
| OPTIONAL, | -- Need R |

| | |
|---|---|
| pathlossReferenceLinking | ENUMERATED {spCell, sCell} |

| | |
|---|---|
| OPTIONAL, | -- Cond SCellOnly |

| | |
|---|---|
| servingCellMO | MeasObjectId |

| | |
|---|---|
| OPTIONAL, | -- Cond MeasObject |

```
  ...,
  [[
```

| lte-CRS-ToMatchAround | SetupRelease { RateMatchPatternLTE- | |
|---|---|---|
| CRS } | OPTIONAL, | -- Need M |

| | |
|---|---|
| rateMatchPattern ToAddModList | SEQUENCE (SIZE |

| | | |
|---|---|---|
| (1..maxNrofRateMatchPatterns)) OF RateMatchPattern | OPTIONAL, | -- Need N |

| | |
|---|---|
| rateMatchPattern ToReleaseList | SEQUENCE (SIZE |

| | | |
|---|---|---|
| (1..maxNrofRateMatchPatterns)) OF RateMatchPatternId | OPTIONAL, | -- Need N |

| DLChannelBW-PerSCS-List | SEQUENCE (SIZE (1..maxSCSs)) OF SCS- | |
|---|---|---|
| SpecificCarrier | OPTIONAL | -- Need S |

```
  ]],
  [[
```

| | |
|---|---|
| supplementary ULRelease | ENUMERATED {true} |

| | |
|---|---|
| OPTIONAL, | -- Need N |

| tdd-UL-DL-ConfigurationDedicated-IAB-MT-r16 | TDD-UL-DL- | |
|---|---|---|
| ConfigDedicated-IAB-MT-r16 | OPTIONAL, | -- Cond |

TDD_IAB

| dormantBWP-Config-r16 | SetupRelease { DormantBWP-Config- | |
|---|---|---|
| r16 } | OPTIONAL, | -- Need M |

| | |
|---|---|
| ca-SlotOffset-r16 | CHOICE { |

| | |
|---|---|
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |

}

| | |
|---|---|
| OPTIONAL, | -- Cond AsyncCA |

| channelAccessConfig-r16 | SetupRelease { ChannelAccessConfig- | |
|---|---|---|
| r16 } | OPTIONAL, | -- Need M |
| intraCellGuardBandsDL-List-r16 | SEQUENCE (SIZE (1..maxSCSs)) OF | |
| IntraCellGuardBandsPerSCS-r16 | OPTIONAL, | -- Need S |
| intraCellGuardBandsUL-List-r16 | SEQUENCE (SIZE (1..maxSCSs)) OF | |
| IntraCellGuardBandsPerSCS-r16 | OPTIONAL, | -- Need S |

| | |
|---|---|
| csi-RS-ValidationWith-DCI-r16 | ENUMERATED {enabled} |

| | |
|---|---|
| OPTIONAL, | -- Need R |

| | |
|---|---|
| lte-CRS-PatternList1-r16 | SetupRelease { LTE-CRS-PatternList-r16 } |

| | |
|---|---|
| OPTIONAL, | -- Need M |

| | |
|---|---|
| lte-CRS-PatternList2-r16 | SetupRelease { LTE-CRS-PatternList-r16 } |

| | |
|---|---|
| OPTIONAL, | -- Need M |

| | |
|---|---|
| crs-RateMatch-PerCORESETPoolIndex-r16 | ENUMERATED {enabled} |

| | |
|---|---|
| OPTIONAL, | -- Need R |

| | |
|---|---|
| enableTwoDefaultTCI-States-r16 | ENUMERATED {enabled} |

| | |
|---|---|
| OPTIONAL, | -- Need R |

enableDefaultTCI-StatePerCoresetPoolIndex-r16 ENUMERATED {enabled}

| | |
|---|---|
| OPTIONAL, | -- Need R |

| | |
|---|---|
| enableBeamSwitchTiming-r16 | ENUMERATED {true} |

| | |
|---|---|
| OPTIONAL, | -- Need R |

| | |
|---|---|
| cbg-TxDiffTBsProcessingType1-r16 | ENUMERATED {enabled} |

| | |
|---|---|
| OPTIONAL, | -- Need R |

| | |
|---|---|
| cbg-TxDiffTBsProcessingType2-r16 | ENUMERATED {enabled} |

| | |
|---|---|
| OPTIONAL | -- Need R |

]]
}

TABLE 23
- RateMatchPatternLTE-CRS
The IE RateMatchPatternLTE-CRS is used to configure a pattern to rate match around LTE
CRS. See TS 38.214 [19], clause 5.1.4.2.

RateMatchPatternLTE-CRS IE

-- ASN1START
-- TAG-RATEMATCHPATTERNLTE-CRS-START

| | |
|---|---|
| RateMatchPatternLTE-CRS ::= | SEQUENCE { |
| carrierFreqDL | INTEGER (0..16383), |
| carrierBandwidthDL | ENUMERATED {n6, n15, n25, n50, n75, |

n100, spare2, spare1},

| | |
|---|---|
| mbsfn-SubframeConfigList | EUTRA-MBSFN-SubframeConfigList |

OPTIONAL, -- Need M

| | |
|---|---|
| nrofCRS-Ports | ENUMERATED {n1, n2, n4}, |
| v-Shift | ENUMERATED {n0, n1, n2, n3, n4, n5} |

}

| | |
|---|---|
| LTE-CRS-PatternList-r16 ::= | SEQUENCE (SIZE (1..maxLTE-CRS-Patterns- |

r16)) OF RateMatchPatternLTE-CRS
-- TAG-RATEMATCHPATTERNLTE-CRS-STOP
-- ASN1STOP

RateMatchPatternLTE-CRS field descriptions
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-Subframe ConfigList
LTE MBSFN subframe configuration (see TS 38.214 [19], clause 5.1.4.2).
nrofCRS-Ports
Number of LTE CRS antenna port to rate-match around (see TS 38.214 [19], clause
5.1.4.2).
v-Shift
Shifting value v-shift in LTE to rate match around LTE CRS (see TS 38.214 [19], clause
5.1.4.2).

### [PDSCH: Processing Time]

If the base station schedules the UE to transmit a PDSCH by using DCI format 1_0, 1_1 or 1_2, the UE may need a PDSCH processing time for receiving a PDSCH by applying a transmission method (modulation/demodulation and coding indication index, DMRS-related information, time and frequency resource allocation information, etc.) indicated through DCI. The PUSCH preparation procedure time is defined in NR in consideration thereof. The PUSCH processing time of the UE may follow Equation 2 given below.

$${T}_{proc , 1} = ( {N}_{1} + {d}_{1 , 1} + {d}_{2} ) ( 2048 + 1 \; 44 ) {κ2}^{- μ} {T}_{c} + {T}_{ext} \qquad [ Equation 2 ]$$

Each parameter in T_{proc,1} described above in Equation 2 may have the following meaning.
N₁: the number of symbols determined according to UE processing capability 1 or 2 based on the UE's capability and numerology μ. N₁ may have a value in Table 22 if UE processing capability 1 is reported according to the UE's capability report, and may have a value in Table 23 if UE processing capability 2 is reported, and if availability of UE processing capability 2 is configured through higher layer signaling. The numerology u may correspond to the minimum value among μ_{PDCCH}, μ_{PDSCH}. μ_{UL} SO as to maximize T_{proc,1}, and μ_{PDCCH}, μ_{PDSCH}, μ_{UL} may refer to the numerology of a PDCCH that scheduled a PDSCH, the numerology of the scheduled PDSCH, and numerology of an UL channel in which a HARQ-ACK is to be transmitted.

TABLE 24
PDSCH processing time in the case of PDSCH processing capability 1

| | PDSCH decoding time N₁ [symbols] | |
|---|---|---|
| | If PDSCH mapping type A and B | If PDSCH mapping type A and B both do |
| | both correspond to dmrs- | not correspond to dmrs-AdditionalPosition = |
| | AdditionalPosition = pos0 inside | pos0 inside DMRS-DownlinkConfig |
| | DMRS-DownlinkConfig which is | which is higher layer signaling, or if no |
| μ | higher layer signaling | higher layer parameter is configured |
| 0 | 8 | N_{1, 0} |
| 1 | 10 | 13 |
| 2 | 17 | 20 |
| 3 | 20 | 24 |

TABLE 25
PDSCH processing time in the case
of PDSCH processing capability 2

| | PDSCH decoding time N₁ [symbols] |
|---|---|
| | If PDSCH mapping type A and B both correspond to |
| | dmrs-AdditionalPosition = pos0 inside |
| μ | DMRS-DownlinkConfig which is higher layer signaling |
| 0 | 3 |
| 1 | 4.5 |
| 2 | 9 for frequency range 1 |

κ: 64
Tₑₓₜ: if the UE uses a shared spectrum channel access scheme, the UE may calculate Tₑₓₜ and apply the same to the PDSCH processing time. Otherwise, Tₑₓₜ is assumed to be 0.
If l₁ which represents the PDSCH DMRS location value is 12, N_{1,0} in Table 22 above has the value of 14, and otherwise has the value of 13.
With regard to PDSCH mapping type A, if the last symbol of the PDSCH is the i^{th} symbol in the slot in which the PDSCH is transmitted, and if i<7, d_{1,1} is then 7-i, and d_{1,1} is otherwise 0.
d₂: if a PUCCH having a high priority index temporally overlaps another PUCCH or a PUSCH having a low priority index, d₂ of the PUCCH having a high priority index may be configured as a value reported from the UE. Otherwise, d₂ is 0.
If PDSCH mapping type B is used with regard to UE processing capability 1, the d_{1,1} value may be determined by the number (L) of symbols of a scheduled PDSCH and the number of overlapping symbols between the PDCCH that schedules the PDSCH and the scheduled PDSCH, as follows.

$$- If L \geq 7 , then {d}_{1 , 1} = 0 .$$

$$- If - L \geq 4 and L \leq 6 , then {d}_{1 , 1} = 7 - L .$$

$$- If L = 3 , then {d}_{1 , 1} = min ( d , 1 ) .$$

$$- If L = 2 , then {d}_{1 , 1} = 3 + d .$$

If PDSCH mapping type B is used with regard to UE processing capability 2, the d_{1,1} value may be determined by the number (L) of symbols of a scheduled PDSCH and the number of overlapping symbols between the PDCCH that schedules the PDSCH and the scheduled PDSCH, as follows.

$$- If L \geq 7 , then {d}_{1 , 1} = 0 .$$

$$- If - L \geq 4 and L \leq 6 , then {d}_{1 , 1} = 7 - L .$$

$$- If L = 2 ,$$

If the scheduling PDCCH exists inside a CORESET including three symbols, and if the CORESET and the scheduled PDSCH have the same start symbol, then d_{1,1}=3.
Otherwise, d_{1,1}=d.
In the case of a UE supporting capability 2 inside a given serving cell, the PDSCH processing time based on UE processing capability 2 may be applied by the UE if processingType2Enabled (higher layer signaling) is configured as “enable” with regard to the corresponding cell.

If the location of the first UL transmission symbol of a PUCCH including HARQ-ACK information (in connection with the corresponding location, K1 defined as the HARQ-ACK transmission timepoint, a PUCCH resource used to transmit the HARQ-ACK, and the timing advance effect may be considered) does not start earlier than the first UL transmission symbol that comes after the last symbol of the PDSCH over a time of Tproc, 1, the UE needs to transmit a valid HARQ-ACK message. That is, the UE needs to transmit a PUCCH including a HARQ-ACK only if the PDSCH processing time is sufficient. The UE cannot otherwise provide the base station with valid HARQ-ACK information corresponding to the scheduled PDSCH. The aforementioned T_{proc,1} may be used in the case of both a normal and an extended CP. In the case of a PDSCH having two PDSCH transmission locations configured inside one slot, d1,1 is calculated with reference to the first PDSCH transmission location inside the corresponding slot.

### [PDSCH: Reception Preparation Time During Cross-Carrier Scheduling]

Next, in the case of cross-carrier scheduling in which the numerology (μ_{PDCCH}) by which a scheduling PDCCH is transmitted and the numerology (μ_{PDSCH}) by which a PDSCH scheduled by the corresponding PDCCH is transmitted are different from each other, the PDSCH reception reparation time (N_{pdsch}) of the UE defined with regard to the time interval between the PDCCH and PDSCH will be described.

If μ_{PDCCH}<μ_{PDSCH}, the scheduled PDSCH cannot be transmitted before the first symbol of the slot coming after N_{pdsch} symbols from the last symbol of the PDCCH that scheduled the corresponding PDSCH. The transmission symbol of the corresponding PDSCH may include a DM-RS.

If μ_{PDCCH}>μ_{PDSCH}, the scheduled PDSCH may be transmitted after N_{pdsch} symbols from the last symbol of the PDCCH that scheduled the corresponding PDSCH. The transmission symbol of the corresponding PDSCH may include a DM-RS.

TABLE 26
N_{pdsch} according to scheduled PDCCH SCS

| μ_{PDCCH} | N_{pdsch} [symbols] |
|---|---|
| 0 | 4 |
| 1 | 5 |
| 2 | 10 |
| 3 | 14 |

### [SRS]

A base station may configure at least one SRS configuration with regard to each UL BWP in order to transfer configuration information for SRS transmission to the UE, and may also configure as least one SRS resource set with regard to each SRS configuration. For example, the base station and the UE may exchange higher signaling information as follows, in order to transfer information regarding the SRS resource set.
srs-ResourceSetId: an SRS resource set index
srs-ResourceIdList: a set of SRS resource indices referred to by SRS resource sets
resourceType: time domain transmission configuration of SRS resources referred to by SRS resource sets, and may be configured as one of “periodic”, “semi-persistent”, and “aperiodic”. If configured as “periodic” or “semi-persistent”, associated CSI-RS information may be provided according to the place of use of SRS resource sets. If configured as “aperiodic”, an aperiodic SRS resource trigger list/slot offset information may be provided, and associated CSI-RS information may be provided according to the place of use of SRS resource sets.
usage: a configuration regarding the place of use of SRS resources referred to by SRS resource sets, and may be configured as one of “beamManagement”, “codebook”, “nonCodebook”, and “antennaSwitching”.
alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

In addition, the base station and the UE may transmit/receive higher layer signaling information in order to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. In addition, the individual configuration information regarding SRS resources may include time domain transmission configuration of SRS resources, and may be configured as one of “periodic”, “semi-persistent”, and “aperiodic”. The time domain transmission configuration of SRS resources may be limited to have the same time domain transmission configuration as the SRS resource set including the SRS resources. If the time domain transmission configuration of SRS resources is configured as “periodic” or “semi-persistent”, the time domain transmission configuration may further include an SRS resource transmission cycle and a slot offset (e.g., periodicityAndOffset).

The base station may activate or deactivate SRS transmission for the UE through higher layer signaling including RRC signaling or MAC CE signaling, or L1 signaling (e.g., DCI). For example, the base station may activate or deactivate periodic SRS transmission for the UE through higher layer signaling. The base station may indicate activation of an SRS resource set having resourceType configured as “periodic” through higher layer signaling, and the UE may transmit the SRS resource referred to by the activated SRS resource set. Intra-slot time-frequency domain resource mapping of the transmitted SRS resource follows resource mapping information configured for the SRS resource, and slot mapping, including the transmission cycle and slot offset, follows periodicity AndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the UL BWP activated with regard to the periodic SRS resource activated through higher layer signaling.

For example, the base station may activate or deactivate semi-persistent SRS transmission for the UE through higher layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent”. Intra-slot time-frequency domain resource mapping of the transmitted SRS resource follows resource mapping information configured for the SRS resource, and slot mapping, including the transmission cycle and slot offset, follows periodicity AndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. If the SRS resource has spatial relation info configured therefor, the spatial domain transmission filter may be determined, without following the same, by referring to configuration information regarding spatial relation info transferred through MAC CE signaling that activates semi-persistent SRS transmission. The UE may transmit the SRS resource inside the UL BWP activated with regard to the semi-persistent SRS resource activated through higher layer signaling.

For example, the base station may trigger aperiodic SRS transmission by the UE through DCI. The base station may indicate one of aperiodic SRS triggers (aperiodic SRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource follows resource mapping information configured for the SRS resource. In addition, slot mapping of the transmitted SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the UL BWP activated with regard to the aperiodic SRS resource triggered through DCI.

If the base station triggers aperiodic SRS transmission by the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. In addition, the minimum time interval may have a different value depending on the place of use of the SRS resource set including the transmitted SRS resource. For example, the minimum time interval may be determined as N2 symbols defined in consideration of UE processing capability that follows the UE's capability with reference to the UE's PUSCH preparation procedure time. In addition, if the place of use of the SRS resource set is configured as “codebook” or “antennaSwitching” in consideration of the place of use of the SRS resource set including the transmitted SRS resource, the minimum time interval may be determined as N2 symbols, and if the place of use of the SRS resource set is configured as “nonCodebook” or “beamManagement”, the minimum time interval may be determined as N2+14 symbols. The UE may transmit an aperiodic SRS if the time interval for aperiodic SRS transmission is larger than or equal to the minimum time interval, and may ignore the DCI that triggers the aperiodic SRS if the time interval for aperiodic SRS transmission is smaller than the minimum time interval.

TABLE 27

| SRS-Resource ::= | SEQUENCE { |
|---|---|
| srs-ResourceId | SRS-ResourceId, |
| nrofSRS-Ports | ENUMERATED {port1, |
| ports2, ports4}, | |
| ptrs-PortIndex | ENUMERATED {n0, n1} |
| OPTIONAL, -- Need R | |
| transmissionComb | CHOICE { |
| n2 | SEQUENCE { |
| combOffset-n2 | INTEGER |
| (0..1), | |
| cyclicShift-n2 | INTEGER (0..7) |
| }, | |
| n4 | SEQUENCE { |
| combOffset-n4 | INTEGER |
| (0..3), | |
| cyclicShift-n4 | INTEGER |
| (0..11) | |
| } | |
| }, | |
| resourceMapping | SEQUENCE { |
| startPosition | INTEGER (0..5), |
| nrofSymbols | ENUMERATED |
| {n1, n2, n4}, | |
| repetitionFactor | ENUMERATED {n1, |
| n2, n4} | |
| }, | |
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |
| }, | |
| groupOrSequenceHopping | ENUMERATED |
| { neither, groupHopping, sequenceHopping }, | |
| resourceType | CHOICE { |
| aperiodic | SEQUENCE { |
| ... | |
| }, | |
| semi-persistent | SEQUENCE { |
| periodicityAndOffset-sp | SRS- |
| PeriodicityAndOffset, | |
| ... | |
| }, | |
| periodic | SEQUENCE { |
| periodicityAndOffset-p | SRS- |
| PeriodicityAndOffset, | |
| ... | |
| } | |
| }, | |
| sequenceId | INTEGER (0..1023), |
| spatialRelationInfo | SRS-SpatialRelationInfo |

OPTIONAL, -- Need R
...
}

Configuration information spatialRelationInfo in Table 27 above may be applied, with reference to one RS, to a beam used for SRS transmission corresponding to beam information of the corresponding RS. For example, configuration of spatialRelationInfo may include information as in Table 28 below.

TABLE 28

| SRS-SpatialRelationInfo ::= | SEQUENCE |
|---|---|
| servingCellId | ServCellIndex |
| OPTIONAL, -- Need S | |
| referenceSignal | CHOICE { |
| ssb-Index | SSB-Index, |
| csi-RS-Index | NZP-CSI-RS- |
| ResourceId, | |
| srs | SEQUENCE { |
| resourceId | SRS-ResourceId, |
| uplinkBWP | BWP-Id |

```
    }
  }
}
```

Referring to the above-described spatialRelationInfo configuration, an SS/PBCH block index, CSI-RS index, or SRS index may be configured as the index of an RS to be referred to in order to use beam information of a specific RS. Higher signaling referenceSignal corresponds to configuration information indicating which RS's beam information is to be referred to for corresponding SRS transmission, ssb-Index refers to the index of an SS/PBCH block, csi-RS-Index refers to the index of a CSI-RS, and srs refers to the index of an SRS. If higher signaling referenceSignal has a configured value of “ssb-Index”, the UE may apply the reception beam which was used to receive the SS/PBCH block corresponding to ssb-Index as the transmission beam for the corresponding SRS transmission. If higher signaling referenceSignal has a configured value of “csi-RS-Index”, the UE may apply the reception beam which was used to receive the CSI-RS corresponding to csi-RS-Index as the transmission beam for the corresponding SRS transmission. If higher signaling referenceSignal has a configured value of “srs”, the UE may apply the reception beam which was used to transmit the SRS corresponding to srs as the transmission beam for the corresponding SRS transmission.

### [PUSCH: Regarding Transmission Scheme]

PUSCH transmission may be dynamically scheduled by a UL grant inside DCI, or operated by means of configured grant (CG) Type 1 or Type 2. Dynamic scheduling indication regarding PUSCH transmission may be made by DCI format 0_0 or 0_1.

CG Type 1 PUSCH transmission may be configured semi-statically by receiving configuredGrantConfig including rrc-ConfiguredUplinkGrant in Table 29 through higher signaling, without receiving a UL grant inside DCI. CG Type 2 PUSCH transmission may be scheduled semi-persistently by a UL grant inside DCI after receiving configuredGrantConfig not including rrc-ConfiguredUplinkGrant in Table 29 through higher signaling. If PUSCH transmission is operated by a CG, parameters applied to the PUSCH transmission are applied through configuredGrantConfig (higher signaling) in Table29 for except dataScramblingIdentityPUSCH, txConfig, codebookSubset, maxRank, and scaling of UCI-OnPUSCH, which are provided by pusch-Config (higher signaling) in Table 30. If provided with transformPrecoder inside configuredGrantConfig (higher signaling) in Table 29, the UE applies tp-pi2BPSK inside pusch-Config in Table 30 to PUSCH transmission operated by a CG.

TABLE 29

| | |
|---|---|
| ConfiguredGrantConfig ::= | SEQUENCE { |
| frequencyHopping | ENUMERATED {intraSlot, |

| | |
|---|---|
| interSlot} | OPTIONAL, -- |

| Need S, | |
|---|---|
| cg-DMRS-Configuration | DMRS-UplinkConfig, |
| mcs-Table | ENUMERATED {qam256, |
| qam64LowSE} | |
| OPTIONAL, -- Need S | |
| mcs-TableTransformPrecoder | ENUMERATED {qam256, |
| qam64LowSE} | |
| OPTIONAL, -- Need S | |
| uci-OnPUSCH | SetupRelease { CG-UCI- |

| | |
|---|---|
| OnPUSCH } | OPTIONAL, |

| -- Need M | |
|---|---|
| resourceAllocation | ENUMERATED |
| { resourceAllocation Type0, resourceAllocationType1, dynamicSwitch }, | |
| rbg-Size | ENUMERATED {config2} |
| OPTIONAL, -- Need S | |
| powerControlLoopToUse | ENUMERATED {n0, n1}, |
| p0-PUSCH-Alpha | P0-PUSCH-AlphaSetId, |
| transformPrecoder | ENUMERATED {enabled, |

| | |
|---|---|
| disabled} | OPTIONAL, |

| -- Need S | |
|---|---|
| nrofHARQ-Processes | INTEGER(1..16), |
| repK | ENUMERATED {n1, n2, |
| n4, n8}, | |
| repK-RV | ENUMERATED {s1-0231, |

| | |
|---|---|
| s2-0303, s3-0000} | OPTIONAL, - |

| - Need R | |
|---|---|
| periodicity | ENUMERATED { |

sym2, sym7,

sym1x14, sym2x14, sym4x14, sym5x14, sym8x14, sym10x14, sym16x14,
sym20x14,

sym32x14,

sym40x14, sym64x14, sym80x14, sym128x14, sym160x14, sym256x14,
sym320x14, sym512x14,

sym640x14,

sym1024x14, sym1280x14, sym2560x14, sym5120x14,

sym6, sym1x12,

sym2x12, sym4x12, sym5x12, sym8x12, sym10x12, sym16x12, sym20x12,
sym32x12,

sym40x12,

sym64x12, sym80x12, sym128x12, sym160x12, sym256x12, sym320x12,
sym512x12, sym640x12,

sym1280x12,

| sym2560x12 | |
|---|---|
| }, | |
| configuredGrantTimer | INTEGER (1..64) |
| OPTIONAL, -- Need R | |
| rrc-ConfiguredUplinkGrant | SEQUENCE { |

| timeDomainOffset | INTEGER |
|---|---|
| (0..5119), | |
| timeDomainAllocation | INTEGER (0..15), |
| frequencyDomainAllocation | BIT STRING |
| (SIZE(18)), | |
| antennaPort | INTEGER (0..31), |
| dmrs-SeqInitialization | INTEGER (0..1) |
| OPTIONAL, -- Need R | |
| precodingAndNumberOfLayers | INTEGER (0..63), |
| srs-ResourceIndicator | INTEGER (0..15) |
| OPTIONAL, -- Need R | |
| mcsAndTBS | INTEGER |
| (0..31), | |
| frequencyHoppingOffset | INTEGER (1.. |
| maxNrofPhysicalResourceBlocks-1) | OPTIONAL, - |
| - Need R | |
| pathlossReferenceIndex | INTEGER |

```
(0..maxNrofPUSCH-PathlossReferenceRSs-1),
    ...
  }
OPTIONAL, -- Need R
  ...
}
```

The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 30, which is higher signaling, is “codebook” or “nonCodebook”.

As described above, PUSCH transmission may be dynamically scheduled through DCI format 0_0 or 0_1, and may be semi-statically configured by a CG. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated UL BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 30, the UE does not expect scheduling through DCI format 0_1.

TABLE 30

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED |

{codebook, nonCodebook}
OPTIONAL, -- Need S

| | |
|---|---|
| dmrs-UplinkForPUSCH-MappingTypeA | SetupRelease |

{ DMRS-UplinkConfig }
OPTIONAL, -- Need M

| | |
|---|---|
| dmrs-UplinkForPUSCH-MappingTypeB | SetupRelease |

{ DMRS-UplinkConfig }
OPTIONAL, -- Need M

| | |
|---|---|
| pusch-PowerControl | PUSCH-PowerControl |

OPTIONAL, -- Need M

| | |
|---|---|
| frequencyHopping | ENUMERATED |
| {intraSlot, interSlot} | OPTIONAL, |

-- Need S

| | |
|---|---|
| frequencyHoppingOffsetLists | SEQUENCE (SIZE (1..4)) |

OF INTEGER (1.. maxNrofPhysicalResourceBlocks-1)
OPTIONAL, -- Need M

| | |
|---|---|
| resourceAllocation | ENUMERATED |

{ resourceAllocationType0, resourceAllocationType1, dynamicSwitch},

| | |
|---|---|
| pusch-TimeDomainAllocationList | SetupRelease { PUSCH- |
| TimeDomainResourceAllocationList } | OPTIONAL, -- |

Need M

| | |
|---|---|
| pusch-AggregationFactor | ENUMERATED { n2, n4, |
| n8 } | OPTIONAL, -- |

Need S

| | |
|---|---|
| mcs-Table | ENUMERATED |

{qam256, qam64LowSE}
OPTIONAL, -- Need S

| | |
|---|---|
| mcs-TableTransformPrecoder | ENUMERATED |

{qam256, qam64LowSE}
OPTIONAL, -- Need S

| | |
|---|---|
| transformPrecoder | ENUMERATED |

{enabled, disabled}
OPTIONAL, -- Need S

| | |
|---|---|
| codebookSubset | ENUMERATED |

{fullyAndPartialAndNonCoherent, partialAndNonCoherent,nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED |
| { config2} | OPTIONAL, -- Need |

S

| | |
|---|---|
| uci-OnPUSCH | SetupRelease { UCI- |
| OnPUSCH} | OPTIONAL, -- Need M |
| tp-pi2BPSK | ENUMERATED |
| {enabled} | OPTIONAL, -- |

Need S
...
}

A codebook-based PUSCH transmission may be dynamically scheduled through DCI format 0_0 or 0_1, and may be operated semi-statically by a CG. If a codebook-based PUSCH is dynamically scheduled through DCI format 0_1 or configured semi-statically by a CG, the UE determines a precoder for PUSCH transmission, based on an SRS resource indicator (SRI), a transmission precoding matrix indicator (TPMI), and a transmission rank (the number of PUSCH transmission layers).

The SRI may be given through the SRI (e.g., a field inside DCI) or configured through srs-ResourceIndicator (higher signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (higher signaling). The TPMI is used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission is selected from an UL codebook having the same number of antenna ports as the value of nrofSRS-Ports inside SRS-Config (higher signaling). In connection with codebook-based PUSCH transmission, the UE determines a codebook subset, based on codebookSubset inside pusch-Config (higher signaling) and TPMI. The codebookSubset inside pusch-Config (higher signaling) may be configured to be one of “fully AndPartialAndNonCoherent”, “partialAndNonCoherent”, or “nonCoherent”, based on UE capability reported by the UE to the base station. If the UE reported “partial AndNonCoherent” as UE capability, the UE does not expect that the value of codebookSubset (higher signaling) will be configured as “fully AndPartialAndNonCoherent”. In addition, if the UE reported “nonCoherent” as UE capability, UE does not expect that the value of codebook Subset (higher signaling) will be configured as “fully AndPartialAndNonCoherent” or “partialAndNonCoherent”. If nrofSRS-Ports inside SRS-ResourceSet (higher signaling) indicates two SRS antenna ports, the UE does not expect that the value of codebookSubset (higher signaling) will be configured as “partial AndNonCoherent”.

The UE may have one SRS resource set configured therefor, wherein the value of usage inside SRS-ResourceSet (higher signaling) is “codebook”, and one SRS resource may be indicated through an SRI inside the corresponding SRS resource set. If multiple SRS resources are configured inside the SRS resource set wherein the value of usage inside SRS-ResourceSet (higher signaling) is “codebook”, the UE expects that the value of nrofSRS-Ports inside SRS-Resource (higher signaling) is identical for all SRS resources.

The UE transmits, to the base station, one or multiple SRS resources included in the SRS resource set wherein the value of usage is configured as “codebook” according to higher signaling, and the base station selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the base station adds information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

A non-codebook-based PUSCH transmission may be dynamically scheduled through DCI format 0_0 or 0_1, and may be operated semi-statically by a CG. If at least one SRS resource is configured inside an SRS resource set wherein the value of usage inside SRS-ResourceSet (higher signaling) is “nonCodebook”, non-codebook-based PUSCH transmission may be scheduled for the UE through DCI format 0_1.

With regard to the SRS resource set wherein the value of usage inside SRS-ResourceSet (higher signaling) is “nonCodebook”, one connected non-ZP (NZP) CSI-RS resource (e.g., an NZP CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (higher signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS is indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is located in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associated CSI-RS inside SRS-ResourceSet (higher signaling). With regard to non-codebook-based transmission, the UE does not expect that spatialRelationInfo which is higher signaling regarding the SRS resource and associatedCSI-RS inside SRS-ResourceSet (higher signaling) will be configured together.

If multiple SRS resources are configured for the UE, the UE may determine a precoder to be applied to PUSCH transmission and the transmission rank, based on an SRI indicated by the base station. The SRI may be indicated through the SRI (a field inside DCI) or configured through srs-ResourceIndicator (higher signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (higher signaling) is “nonCodebook”, and a maximum of four SRS resources may be configured for non-codebook-based PUSCH transmission.

The base station transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

### [PUSCH: Preparation Procedure Time]

If a base station schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time is defined in NR in consideration thereof. The PUSCH preparation procedure time of the UE may follow Equation 3 given below.

$$[ Equation 3 ]$$

$${T}_{proc , 2} = max ( ( {N}_{2} + {d}_{2 , 1} + {d}_{2} ) ( 2048 + 1 \; 44 ) κ {2}^{- μ} {T}_{c} + {T}_{ext} + {T}_{switch} , {d}_{2 , 2} )$$

In Equation 3:
N₂: the number of symbols determined according to UE processing capability 1 or 2, based on the UE's capability, and numerology μ. N₂ may have a value in Table 31 if UE processing capability 1 is reported according to the UE's capability report, and may have a value in Table 32 if UE processing capability 2 is reported, and if availability of UE processing capability 2 is configured through higher layer signaling.

TABLE 31

| μ | PUSCH preparation time N₂ [symbols] |
|---|---|
| 0 | 10 |
| 1 | 12 |
| 2 | 23 |
| 3 | 36 |

TABLE 32

| μ | PUSCH preparation time N₂ [symbols] |
|---|---|
| 0 | 5 |
| 1 | 5.5 |
| 2 | 11 for frequency range 1 |

d_{2,1}: the number of symbols determined to be 0 if all REs of the first OFDM symbol of PUSCH transmission include DM-RSs, and to be 1 otherwise.
κ: 64
μ: follows a value, among μ_{DL} and μ_{UL}, which makes T_{proc,2} larger. μ_{DL} refers to the numerology of a DL used to transmit a PDCCH including DCI that schedules a PUSCH, and μ_{UL} refers to the numerology of an UL used to transmit a PUSCH.

$$- {T}_{c} \text{:} has 1 / ( Δ {f}_{max} \cdot {N}_{f} ) , Δ {f}_{max} = 480 \cdot {10}^{3} Hz , {N}_{f} = 4096 . .$$

d_{2,2}: follows a BWP switching time if DCI that schedules a PUSCH indicates BWP switching, and has 0 otherwise.
d₂: if OFDM symbols overlap temporally between a PUSCH having a high priority index and a PUCCH having a low priority index, the d₂ value of the PUSCH having a high priority index is used. Otherwise, d₂ is 0.
Tₑₓₜ: if the UE uses a shared spectrum channel access scheme, the UE may calculate Tₑₓₜ and apply the same to a PUSCH preparation procedure time. Otherwise, Tₑₓₜ is assumed to be 0.
T_{switch}: if an UL switching spacing has been triggered, T_{switch} is assumed to be the switching spacing time. Otherwise, T_{switch} is assumed to be 0.

The base station and the UE may determine that the PUSCH preparation procedure time is insufficient if the first symbol of a PUSCH starts earlier than the first UL symbol in which a CP starts after T_{proc,2} from the last symbol of a PDCCH including DCI that schedules the PUSCH, in view of the influence of timing advance between the UL and the DL and time domain resource mapping information of the PUSCH scheduled through the DCI. Otherwise, the base station and the UE determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

### [PUSCH: Frequency Hopping Process]

5G supports two kinds of PUSCH frequency hopping methods with regard to each PUSCH repeated transmission type. First of all, in PUSCH repeated transmission type A, intra-slot frequency hopping and inter-slot frequency hopping are supported, and in PUSCH repeated transmission type B, inter-repetition frequency hopping and inter-slot frequency hopping are supported.

The intra-slot frequency hopping method supported in PUSCH repetition type A transmission may include a method in which a UE transmits allocated resources in the frequency domain, after changing the same by a configured frequency offset, by two hops in one slot. The start RB of each hop in connection with intra-slot frequency hopping may be expressed by Equation 4 below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad [ Equation 4 ]$$

In Equation 4, i=0 and i=1 may denote the first and second hops, respectively, and RBₛₜₐᵣₜ may denote the start RB in a UL BWP and may be calculated from a frequency resource allocation method. RB_{offset} denotes a frequency offset between two hops through an higher layer parameter. The number of symbols of the first hop may be represented by

$$⌊ {N}_{symb}^{PUSCH , s} / 2 ⌋ ,$$

and number of symbols of the second hop may be represented by

$${N}_{symb}^{PUSCH , s} - ⌊ {N}_{symb}^{PUSCH , s} / 2 ⌋ \cdot {N}_{symb}^{PUSCH , s}$$

is the length of PUSCH transmission in one slot and is expressed by the number of OFDM symbols.

Next, the inter-slot frequency hopping method supported in PUSCH repetition type A and type B transmissions is a method in which the UE transmits allocated resources in the frequency domain, after changing the same by a configured frequency offset, in each slot. The start RB during a slot in connection with inter-slot frequency hopping may be expressed by Equation 5 below.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad [ Equation 5 ]$$

In Equation 5,

$${n}_{s}^{μ}$$

denotes the current slot number during multi-slot PUSCH transmission, and RBₛₜₐᵣₜ denotes the start RB inside a UL BWP and is calculated from a frequency resource allocation method. RB_{offset} denotes a frequency offset between two hops through an higher layer parameter.

Next, the inter-repetition frequency hopping method supported in PUSCH repetition type B transmission is a method in which resources allocated in the frequency domain regarding one or multiple actual repetitions in each nominal repetition are moved by a configured frequency offset and then transmitted. The index RBₛₜₐᵣₜ₍ₙ₎ of the start RB in the frequency domain regarding one or multiple actual repetitions in the nth nominal repetition may follow Equation 6 given below.

$${RB}_{start} ( n ) = \{ \begin{matrix}{RB}_{start} & nmod 2 = 0 \\ ( {RB}_{start} + {RB}_{offset} ) mod {N}_{BWP}^{size} & nmod 2 = 1\end{matrix} \qquad [ Equation 6 ]$$

In Equation 6, n denotes the index of nominal repetition, and RB_{offset} denotes an RB offset between two hops through an higher layer parameter.

### [PUSCH: Multiplexing Rules During Aperiodic (AP)/Semi-Persistent (SP) CSI Reporting]

CSI may include a channel quality indicator (channel quality information (CQI)), a precoding matrix index (precoding matrix indicator (PMI)), a CSI-RS resource indicator (CRI), an SS/PBCH block resource indicator (SSBRI), a layer indicator (LI), a rank indicator (RI), a RS received power (RSRP) (e.g., L1-RSRP), and/or the like. A base station may control time and frequency resources for the aforementioned CSI measurement and report of a UE.

For the aforementioned CSI measurement and report, the UE may be configured, via higher-layer signaling, with setting information for N (N≥1) CSI reports (CSI-ReportConfig), setting information for M (M≥1) RS transmission resources (CSI-ResourceConfig), and list information of one or two trigger states (CSI-AperiodicTriggerStateList, CSI-SemiPersistentOnPUSCH-TriggerStateList). The configuration information for CSI measurement and reporting described above may be, more specifically, as described in Tables 33 to 39 below.

TABLE 33
CSI-ReportConfig
The IE CSI-ReportConfig is used to configure a periodic or SP report
sent on PUCCH on the cell in which the CSI-ReportConfig is included,
or to configure an SP or AP report sent on PUSCH triggered by
DCI received on the cell in which the CSI-ReportConfig is included
(in this case, the cell on which the report is sent is determined
by the received DCI). See TS 38.214 [19], clause 5.2.1.
CSI-ReportConfig IE
-- ASN1START
-- TAG-CSI-REPORTCONFIG-START

| | |
|---|---|
| CSI-ReportConfig ::= | SEQUENCE { |

| | |
|---|---|
| reportConfigId | CSI-ReportConfigId, |
| carrier | ServCellIndex |

| | |
|---|---|
| OPTIONAL, | -- Need S |

| | |
|---|---|
| resourcesForChannelMeasurement | CSI-ResourceConfigId, |
| csi-IM-ResourcesForInterference | CSI-ResourceConfigId |

| | |
|---|---|
| OPTIONAL, | -- Need R |

| | |
|---|---|
| nzp-CSI-RS-ResourcesForInterference | CSI-ResourceConfigId |

| | |
|---|---|
| OPTIONAL, | -- Need R |

| | |
|---|---|
| reportConfigType | CHOICE { |

| | |
|---|---|
| periodic | SEQUENCE { |

| | |
|---|---|
| reportSlotConfig | CSI- |

ReportPeriodicity AndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUCCH | SEQUENCE { |

| | |
|---|---|
| reportSlotConfig | CSI- |

ReportPeriodicity AndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUSCH | SEQUENCE { |

| | |
|---|---|
| reportSlotConfig | ENUMERATED {sl5, sl10, |

sl20, sl40, sl80, sl160, sl320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH-AlphaSetId |

},

| | |
|---|---|
| aperiodic | SEQUENCE { |

| | |
|---|---|
| reportSlotOffsetList | SEQUENCE (SIZE |

```
(1..maxNrofUL-Allocations)) OF INTEGER(0..32)
      }
  },
```

| | |
|---|---|
| reportQuantity | CHOICE { |

| | |
|---|---|
| none | NULL, |
| cri-RI-PMI-CQI | NULL, |
| cri-RI-i1 | NULL, |
| cri-RI-i1-CQI | SEQUENCE { |

| | |
|---|---|
| pdsch-BundleSizeForCSI | ENUMERATED {n2, n4} |

| | |
|---|---|
| OPTIONAL | -- Need S |

},

| | |
|---|---|
| cri-RI-CQI | NULL, |
| cri-RSRP | NULL, |
| ssb-Index-RSRP | NULL, |
| cri-RI-LI-PMI-CQI | NULL |

},

| reportFreqConfiguration | SEQUENCE { | |
|---|---|---|
| cqi-FormatIndicator | ENUMERATED { widebandCQI, | |
| subbandCQI } | OPTIONAL, | -- Need R |

| | |
|---|---|
| pmi-FormatIndicator | ENUMERATED { |

| | |
|---|---|
| widebandPMI, subbandPMI } | OPTIONAL, -- Need R |

| | |
|---|---|
| csi-ReportingBand | CHOICE { |

| subbands3 | BIT STRING(SIZE(3)), |
|---|---|
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |
| ..., | |
| subbands 19-v1530 | BIT STRING(SIZE(19)) |

| | | |
|---|---|---|
| } | OPTIONAL | -- Need S |

}

| | |
|---|---|
| OPTIONAL, | -- Need R |

| | |
|---|---|
| timeRestrictionForChannelMeasurements | ENUMERATED {configured, |

notConfigured},

| | |
|---|---|
| timeRestrictionForInterferenceMeasurements | ENUMERATED {configured, |

notConfigured},

| | |
|---|---|
| codebookConfig | CodebookConfig |

| | |
|---|---|
| OPTIONAL, | -- Need R |

| dummy | | ENUMERATED {n1, | |
|---|---|---|---|
| n2} | OPTIONAL, | | -- Need R |

| | |
|---|---|
| groupBasedBeamReporting | CHOICE { |

| enabled | | NULL, |
|---|---|---|
| disabled | | SEQUENCE { |
| | nrofReportedRS | ENUMERATED {n1, n2, |

| | | |
|---|---|---|
| n3, n4} | OPTIONAL | -- Need S |

```
      }
    },
```

| | |
|---|---|
| cqi-Table | ENUMERATED {table1, table2, table3, spare1} |

| | |
|---|---|
| OPTIONAL, | -- Need R |

| | |
|---|---|
| subbandSize | ENUMERATED {value1, value2}, |

| | |
|---|---|
| non-PMI-PortIndication | SEQUENCE (SIZE (1..maxNrofNZP-CSI-RS- |

| | | |
|---|---|---|
| ResourcesPerConfig)) OF PortIndexFor8Ranks | OPTIONAL, | -- Need R |

```
  ...,
  [[
```

| | |
|---|---|
| semiPersistentOnPUSCH-v1530 | SEQUENCE { |
| reportSlotConfig-v1530 | ENUMERATED {sl4, sl8, sl16} |

}

| | |
|---|---|
| OPTIONAL | -- Need R |

```
  ]],
  [[
```

| | |
|---|---|
| semiPersistentOnPUSCH-v1610 | SEQUENCE { |
| reportSlotOffsetListDCI-0-2-r16 | SEQUENCE (SIZE (1..maxNrofUL- |

| | | |
|---|---|---|
| Allocations-r16)) OF INTEGER(0..32) | OPTIONAL, | -- Need R |

| | |
|---|---|
| reportSlotOffsetListDCI-0-1-r16 | SEQUENCE (SIZE (1..maxNrofUL- |

| | | |
|---|---|---|
| Allocations-r16)) OF INTEGER(0..32) | OPTIONAL | -- Need R |

}

| | |
|---|---|
| OPTIONAL, | -- Need R |

| | |
|---|---|
| aperiodic-v1610 | SEQUENCE { |
| reportSlotOffsetListDCI-0-2-r16 | SEQUENCE (SIZE (1..maxNrofUL- |

| | | |
|---|---|---|
| Allocations-r16)) OF INTEGER(0..32) | OPTIONAL, | -- Need R |

| | |
|---|---|
| reportSlotOffsetListDCI-0-1-r16 | SEQUENCE (SIZE (1..maxNrofUL- |

| | | |
|---|---|---|
| Allocations-r16)) OF INTEGER(0..32) | OPTIONAL | -- Need R |

}

| | |
|---|---|
| OPTIONAL, | -- Need R |

| | |
|---|---|
| reportQuantity-r16 | CHOICE { |

| | |
|---|---|
| cri-SINR-r16 | NULL, |
| ssb-Index-SINR-r16 | NULL |

}

| | |
|---|---|
| OPTIONAL, | -- Need R |

| | |
|---|---|
| codebookConfig-r16 | CodebookConfig-r16 |

| | |
|---|---|
| OPTIONAL | -- Need R |

]]
}

| | |
|---|---|
| CSI-ReportPeriodicityAndOffset ::= | CHOICE { |

| | |
|---|---|
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-CSI-Resource ::= | SEQUENCE { |
| ULBandwidthPartId | BWP-Id, |

| | |
|---|---|
| pucch-Resource | PUCCH-ResourceId |

}

| | |
|---|---|
| PortIndex For8Ranks ::= | CHOICE { |

| | |
|---|---|
| portIndex8 | SEQUENCE{ |
| rank1-8 | PortIndex8 |

| | |
|---|---|
| OPTIONAL, | -- Need R |

| rank2-8 | SEQUENCE(SIZE(2)) OF | |
|---|---|---|
| PortIndex8 | OPTIONAL, | -- Need R |
| rank3-8 | SEQUENCE(SIZE(3)) OF | |
| PortIndex8 | OPTIONAL, | -- Need R |
| rank4-8 | SEQUENCE(SIZE(4)) OF | |
| PortIndex8 | OPTIONAL, | -- Need R |
| rank5-8 | SEQUENCE(SIZE(5)) OF | |
| PortIndex8 | OPTIONAL, | -- Need R |
| rank6-8 | SEQUENCE(SIZE(6)) OF | |
| PortIndex8 | OPTIONAL, | -- Need R |
| rank7-8 | SEQUENCE(SIZE(7)) OF | |
| PortIndex8 | OPTIONAL, | -- Need R |
| rank8-8 | SEQUENCE(SIZE(8)) OF | |
| PortIndex8 | OPTIONAL | -- Need R |

},

| | |
|---|---|
| portIndex4 | SEQUENCE{ |
| rank1-4 | PortIndex4 |

| | |
|---|---|
| OPTIONAL, | -- Need R |

| rank2-4 | SEQUENCE(SIZE(2)) OF | |
|---|---|---|
| PortIndex4 | OPTIONAL, | -- Need R |
| rank3-4 | SEQUENCE(SIZE(3)) OF | |
| PortIndex4 | OPTIONAL, | -- Need R |
| rank4-4 | SEQUENCE(SIZE(4)) OF | |
| PortIndex4 | OPTIONAL | -- Need R |

},

| | |
|---|---|
| portIndex2 | SEQUENCE{ |
| rank1-2 | PortIndex2 |

| | |
|---|---|
| OPTIONAL, | -- Need R |

| rank2-2 | SEQUENCE(SIZE(2)) OF | |
|---|---|---|
| PortIndex2 | OPTIONAL | -- Need R |

},

| | |
|---|---|
| portIndex1 | NULL |

}

| | |
|---|---|
| PortIndex8::= | INTEGER (0..7) |
| PortIndex4::= | INTEGER (0..3) |
| PortIndex2::= | INTEGER (0..1) |

-- TAG-CSI-REPORTCONFIG-STOP
-- ASN1STOP

CSI-ReportConfig field descriptions
carrier
Indicates in which serving cell the CSI-ResourceConfig indicated below are to be
found. If the field is absent, the resources are on the same serving cell as this report
configuration.
codebookConfig
Codebook configuration for Type-1 or Type-2 including codebook subset restriction.
Network does not configure codebookConfig and codebookConfig-r16
simultaneously to a UE
cqi-FormatIndicator
Indicates whether the UE shall report a single (wideband) or multiple (subband) CQI.
(see TS 38.214 [19], clause 5.2.1.4).
cqi-Table
Which CQI table to use for CQI calculation (see TS 38.214 [19], clause 5.2.2.1).
csi-IM-ResourcesForInterference
CSI IM resources for interference measurement. csi-ResourceConfigId of a CSI-
ResourceConfig included in the configuration of the serving cell indicated with the
field “carrier” above. The CSI-ResourceConfig indicated here contains only CSI-IM
resources. The bwp-Id in that CSI-ResourceConfig is the same value as the bwp-Id in
the CSI-ResourceConfig indicated by resourcesForChannelMeasurement.
csi-ReportingBand
Indicates a contiguous or non-contiguous subset of subbands in the BWP which CSI
shall be reported for. Each bit in the bit-string represents one subband. The right-most
bit in the bit string represents the lowest subband in the BWP. The choice determines
the number of subbands (subbands3 for 3 subbands, subbands4 for 4 subbands, and so
on) (see TS 38.214 [19], clause 5.2.1.4). This field is absent if there are less than 24
PRBs (no sub band) and present otherwise, the number of sub bands can be from 3
(24 PRBs, sub band size 8) to 18 (72 PRBs, sub band size 4).
dummy
This field is not used in the specification. If received it shall be ignored by the UE.
group BasedBeamReporting
Turning on/off group beam based reporting (see TS 38.214 [19], clause 5.2.1.4).
non-PMI-PortIndication
Port indication for RI/CQI calculation. For each CSI-RS resource in the linked
ResourceConfig for channel measurement, a port indication for each rank R,
indicating which R ports to use. Applicable only for non-PMI feedback (see TS
38.214 [19], clause 5.2.1.4.2).
The first entry in non-PMI-PortIndication corresponds to the NZP-CSI-RS-Resource
indicated by the first entry in nzp-CSI-RS-Resources in the NZP-CSI-RS-ResourceSet
indicated in the first entry of nzp-CSI-RS-ResourceSetList of the CSI-ResourceConfig
whose CSI-ResourceConfigId is indicated in a CSI-MeasId together with the above
CSI-ReportConfigId; the second entry in non-PMI-PortIndication corresponds to the
NZP-CSI-RS-Resource indicated by the second entry in nzp-CSI-RS-Resources in the
NZP-CSI-RS-ResourceSet indicated in the first entry of nzp-CSI-RS-ResourceSetList
of the same CSI-ResourceConfig, and so on until the NZP-CSI-RS-Resource
indicated by the last entry in nzp-CSI-RS-Resources in the in the NZP-CSI-RS-
ResourceSet indicated in the first entry of nzp-CSI-RS-ResourceSetList of the same
CSI-ResourceConfig. Then the next entry corresponds to the NZP-CSI-RS-Resource
indicated by the first entry in nzp-CSI-RS-Resources in the NZP-CSI-RS-ResourceSet
indicated in the second entry of nzp-CSI-RS-ResourceSetList of the same CSI-
ResourceConfig and so on.
nrofReportedRS
The number (N) of measured RS resources to be reported per report setting in a non-
group-based report. N <= N_max, where N_max is either 2 or 4 depending on UE
capability.
(see TS 38.214 [19], clause 5.2.1.4) When the field is absent the UE applies the value
1.
nzp-CSI-RS-ResourcesForInterference
NZP CSI RS resources for interference measurement. csi-ResourceConfigId of a CSI-
ResourceConfig included in the configuration of the serving cell indicated with the
field “carrier” above. The CSI-ResourceConfig indicated here contains only NZP-
CSI-RS resources. The bwp-Id in that CSI-ResourceConfig is the same value as the
bwp-Id in the CSI-ResourceConfig indicated by resourcesForChannelMeasurement.
p0alpha
Index of the p0-alpha set determining the power control for this CSI report
transmission (see TS 38.214 [19], clause 6.2.1.2).
pdsch-BundleSizeForCSI
PRB bundling size to assume for CQI calculation when reportQuantity is
CRI/RI/i1/CQI. If the field is absent, the UE assumes that no PRB bundling is applied
(see TS 38.214 [19], clause 5.2.1.4.2).
pmi-FormatIndicator
Indicates whether the UE shall report a single (wideband) or multiple (subband) PMI.
(see TS 38.214 [19], clause 5.2.1.4).
pucch-CSI-ResourceList
Indicates which PUCCH resource to use for reporting on PUCCH.
reportConfigType
Time domain behavior of reporting configuration.
reportFreqConfiguration
Reporting configuration in the frequency domain. (see TS 38.214 [19], clause
5.2.1.4).
reportQuantity
The CSI related quantities to report. see TS 38.214 [19], clause 5.2.1. If the field
reportQuantity-r16 is present, UE shall ignore reportQuantity (without suffix).
reportSlotConfig
Periodicity and slot offset (see TS 38.214 [19], clause 5.2.1.4). If the field
reportSlotConfig-v1530 is present, the UE shall ignore the value provided in
reportSlotConfig (without suffix).
reportSlotOffsetList, reportSlotOffsetListDCI-0-1, reportSlotOffsetListDCI-0-2
Timing offset Y for semi persistent reporting using PUSCH. This field lists the
allowed offset values. This list must have the same number of entries as the pusch-
TimeDomainAllocationList in PUSCH-Config. A particular value is indicated in DCI.
The network indicates in the DCI field of the UL grant, which of the configured
report slot offsets the UE shall apply. The DCI value 0 corresponds to the first report
slot offset in this list, the DCI value 1 corresponds to the second report slot offset in
this list, and so on. The first report is transmitted in slot n + Y, second report in
n + Y + P, where P is the configured periodicity.
Timing offset Y for aperiodic reporting using PUSCH. This field lists the allowed
offset values. This list must have the same number of entries as the pusch-
TimeDomainAllocationList in PUSCH-Config. A particular value is indicated in DCI.
The network indicates in the DCI field of the UL grant, which of the configured
report slot offsets the UE shall apply. The DCI value 0 corresponds to the first report
slot offset in this list, the DCI value 1 corresponds to the second report slot offset in
this list, and so on (see TS 38.214 [19], clause 6.1.2.1). The field reportSlotOffsetList
applies to DCI format 0_0, the field reportSlotOffsetListDCI-0-1 applies to DCI
format 0_1 and the field reportSlotOffsetListDCI-0-2 applies to DCI format 0_2 (see
TS 38.214 [19], clause 6.1.2.1).
resourcesForChannelMeasurement
Resources for channel measurement. csi-ResourceConfigId of a CSI-ResourceConfig
included in the configuration of the serving cell indicated with the field “carrier”
above. The CSI-ResourceConfig indicated here contains only NZP-CSI-RS resources
and/or SSB resources. This CSI-ReportConfig is associated with the DL BWP
indicated by bwp-Id in that CSI-ResourceConfig.
subbandSize
Indicates one out of two possible BWP-dependent values for the subband size as
indicated in TS 38.214 [19], table 5.2.1.4-2. If csi-ReportingBand is absent, the UE
shall ignore this field.
timeRestrictionForChannelMeasurements
Time domain measurement restriction for the channel (signal) measurements (see TS
38.214 [19], clause 5.2.1.1).
timeRestrictionForInterferenceMeasurements
Time domain measurement restriction for interference measurements (see TS 38.214
[19], clause 5.2.1.1).

TABLE 34
CSI-ReportConfig
The IE CSI-ResourceConfig defines a group of one or more NZP-CSI-
RS-ResourceSet, CSI-IM-ResourceSet and/or CSI-SSB-ResourceSet.
CSI-ResourceConfig IE
-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |

| | |
|---|---|
| nzp-CSI-RS-SSB | SEQUENCE { |
| nzp-CSI-RS-ResourceSetList | SEQUENCE (SIZE (1..maxNrofNZP-CSI- |

RS-ResourceSetsPerConfig)) OF NZP-CSI-RS-ResourceSetId
OPTIONAL, -- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId OPTIONAL -- Need R
},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resourceType | ENUMERATED { aperiodic, semiPersistent, |

periodic },
...
}
-- TAG-CSI-RESOURCECONFIG-STOP
-- ASN1STOP

CSI-ResourceConfig field descriptions
bwp-Id
The DL BWP which the CSI-RS associated with this CSI-ResourceConfig are located
in (see TS 38.214 [19], clause 5.2.1.2.
csi-IM-ResourceSetList
List of references to CSI-IM resources used for beam measurement and reporting in a
CSI-RS resource set. Contains up to maxNrofCSI-IM-ResourceSetsPerConfig
resource sets if resourceType is ‘aperiodic’ and 1 otherwise (see TS 38.214 [19],
clause 5.2.1.2).
csi-ResourceConfigId
Used in CSI-ReportConfig to refer to an instance of CSI-ResourceConfig.
csi-SSB-ResourceSetList
List of references to SSB resources used for beam measurement and reporting in a
CSI-RS resource set (see TS 38.214 [19], clause 5.2.1.2).
nzp-CSI-RS-ResourceSetList
List of references to NZP CSI-RS resources used for beam measurement and
reporting in a CSI-RS resource set. Contains up to maxNrofNZP-CSI-RS-
ResourceSetsPerConfig resource sets if resourceType is ‘aperiodic’ and 1 otherwise
(see TS 38.214 [19], clause 5.2.1.2).
resourceType
Time domain behavior of resource configuration (see TS 38.214 [19], clause 5.2.1.2).
It does not apply to resources provided in the csi-SSB-ResourceSetList.

TABLE 35
NZP-CSI-RS-ResourceSet
The IE NZP-CSI-RS-ResourceSet is a set of Non-Zero-Power
(NZP) CSI-RS resources (their IDs) and set-specific parameters.
NZP-CSI-RS-ResourceSet IE
-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI- |

RS-ResourcesPerSet)) OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

```
OPTIONAL, -- Need R
  ...,
  [[
```

| | |
|---|---|
| aperiodicTriggeringOffset-r16 | INTEGER(0..31) |

OPTIONAL -- Need S
]]
}
-- TAG-NZP-CSI-RS-RESOURCESET-STOP
-- ASN1STOP

NZP-CSI-RS-ResourceSet field descriptions
aperiodicTriggeringOffset, aperiodicTriggeringOffset-r16
Offset X between the slot containing the DCI that triggers a set of aperiodic NZP
CSI-RS resources and the slot in which the CSI-RS resource set is transmitted. For
aperiodicTriggeringOffset, the value 0 corresponds to 0 slots, value 1 corresponds to
1 slot, value 2 corresponds to 2 slots, value 3 corresponds to 3 slots, value 4
corresponds to 4 slots, value 5 corresponds to 16 slots, value 6 corresponds to 24
slots. For aperiodicTriggeringOffset-r16, the value indicates the number of slots. The
network configures only one of the fields. When neither field is included, the UE
applies the value 0.
nzp-CSI-RS-Resources
NZP-CSI-RS-Resources associated with this NZP-CSI-RS resource set (see TS
38.214 [19], clause 5.2). For CSI, there are at most 8 NZP CSI RS resources per
resource set.
repetition
Indicates whether repetition is on/off. If the field is set to off or if the field is absent,
the UE may not assume that the NZP-CSI-RS resources within the resource set are
transmitted with the same DL spatial domain transmission filter (see TS 38.214 [19],
clauses 5.2.2.3.1 and 5.1.6.1.2). It can only be configured for CSI-RS resource sets
which are associated with CSI-ReportConfig with report of L1 RSRP or “no report”.
trs-Info
Indicates that the antenna port for all NZP-CSI-RS resources in the CSI-RS resource
set is same. If the field is absent or released the UE applies the value false (see TS
38.214 [19], clause 5.2.2.3.1).

TABLE 36
CSI-SSB-ResourceSet
The IE CSI-SSB-ResourceSet is used to configure
one SS/PBCH block resource set which refers to
SS/PBCH as indicated in ServingCellConfigCommon.
CSI-SSB-ResourceSet IE

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB- |

ResourcePerSet)) OF SSB-Index,
...
}
-- TAG-CSI-SSB-RESOURCESET-STOP
-- ASN1STOP

TABLE 37
CSI-IM-ResourceSet
The IE CSI-IM-ResourceSet is used to configure a
set of one or more CSI Interference Management (IM)
resources (their IDs) and set-specific parameters.
CSI-IM-ResourceSet IE
-- ASN1START
-- TAG-CSI-IM-RESOURCESET-START

| | |
|---|---|
| CSI-IM-ResourceSet ::= | SEQUENCE { |
| csi-IM-ResourceSetId | CSI-IM-ResourceSetId, |
| csi-IM-Resources | SEQUENCE (SIZE(1..maxNrofCSI-IM- |

ResourcesPerSet)) OF CSI-IM-ResourceId,
...
}
-- TAG-CSI-IM-RESOURCESET-STOP
-- ASN1STOP

CSI-IM-ResourceSet field descriptions
csi-IM-Resources
CSI-IM-Resources associated with this CSI-IM-ResourceSet (see
TS 38.214 [19], clause 5.2)

TABLE 38
CSI-AperiodicTrrigerStateList
The CSI-AperiodicTriggerStateList IE is used to configure
the UE with a list of aperiodic trigger states. Each
codepoint of the DCI field “CSI request” is associated
with one trigger state. Upon reception of the value associated
with a trigger state, the UE will perform measurement of CSI-RS
and aperiodic reporting on L1 according to all entries in the
associatedReportConfigInfoList for that trigger state.
CSI-AperiodicTriggerState List IE
-- ASN1START
-- TAG-CSI-APERIODICTRIGGERSTATELIST-START

| | |
|---|---|
| CSI-AperiodicTriggerStateList ::= | SEQUENCE (SIZE (1..maxNrOfCSI- |

AperiodicTriggers)) OF CSI-AperiodicTriggerState

| | |
|---|---|
| CSI-AperiodicTriggerState ::= | SEQUENCE { |
| associatedReportConfigInfoList | SEQUENCE |

(SIZE(1..maxNrofReportConfigPerAperiodicTrigger)) OF CSI-
AssociatedReportConfigInfo,
...
}

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP- |

CSI-RS-ResourceSetsPerConfig),

| | |
|---|---|
| qcl-info | SEQUENCE |

(SIZE(1..maxNrofAP-CSI-RS-ResourcesPerSet)) OF TCI-StateId OPTIONAL -- Cond
Aperiodic
},

| | |
|---|---|
| csi-SSB-ResourceSet | INTEGER (1..maxNrofCSI-SSB- |

ResourceSetsPerConfig)
},

| | |
|---|---|
| csi-IM-ResourcesForInterference | INTEGER(1..maxNrofCSI-IM- |

| | |
|---|---|
| ResourceSetsPerConfig) | OPTIONAL, -- Cond CSI-IM-ForInterference |

nzp-CSI-RS-ResourcesForInterference INTEGER (1..maxNrofNZP-CSI-RS-

| | |
|---|---|
| ResourceSetsPerConfig) | OPTIONAL, -- Cond NZP-CSI-RS-ForInterference |

...
}
-- TAG-CSI-APERIODICTRIGGERSTATELIST-STOP
-- ASN1STOP

CSI-AssociatedReportConfigInfo field descriptions
csi-IM-ResourcesForInterference
CSI-IM-ResourceSet for interference measurement. Entry number in csi-IM-
ResourceSetList in the CSI-ResourceConfig indicated by csi-IM-
ResourcesForInterference in the CSI-ReportConfig indicated by reportConfigId above
(1 corresponds to the first entry, 2 to the second entry, and so on). The indicated CSI-
IM-ResourceSet should have exactly the same number of resources like the NZP-CSI-
RS-ResourceSet indicated in nzp-CSI-RS-ResourcesforChannel.
csi-SSB-ResourceSet
CSI-SSB-ResourceSet for channel measurements. Entry number in csi-SSB-
ResourceSetList in the CSI-ResourceConfig indicated by
resourcesForChannelMeasurement in the CSI-ReportConfig indicated by
reportConfigId above (1 corresponds to the first entry, 2 to the second entry, and so
on)
nzp-CSI-RS-ResourcesForInterference
NZP-CSI-RS-ResourceSet for interference measurement. Entry number in nzp-CSI-
RS-ResourceSetList in the CSI-ResourceConfig indicated by nzp-CSI-RS-
ResourcesForInterference in the CSI-ReportConfig indicated by reportConfigId above
(1 corresponds to the first entry, 2 to the second entry, and so on).
qcl-info
List of references to TCI-States for providing the QCL source and QCL type for each
NZP-CSI-RS-Resource listed in nzp-CSI-RS-Resources of the NZP-CSI-RS-
ResourceSet indicated by nzp-CSI-RS-ResourcesforChannel. Each TCI-StateId refers
to the TCI-State which has this value for tci-StateId and is defined in tci-
StatesToAddModList in the PDSCH-Config included in the BWP-Downlink
corresponding to the serving cell and to the DL BWP to which the
resourcesForChannelMeasurement (in the CSI-ReportConfig indicated by
reportConfigId above) belong to. First entry in qcl-info-forChannel corresponds to first
entry in nzp-CSI-RS-Resources of that NZP-CSI-RS-ResourceSet, second entry in qcl-
info-forChannel corresponds to second entry in nzp-CSI-RS-Resources, and so on (see
TS 38.214 [19], clause 5.2.1.5.1)
reportConfigId
The reportConfigId of one of the CSI-ReportConfigToAddMod configured in CSI-
MeasConfig
resourceSet
NZP-CSI-RS-ResourceSet for channel measurements. Entry number in nzp-CSI-RS-
ResourceSetList in the CSI-ResourceConfig indicated by
resourcesForChannelMeasurement in the CSI-ReportConfig indicated by
reportConfigId above (1 corresponds to the first entry, 2 to the second entry, and so
on).

| Conditional Presence | Explanation |
|---|---|
| Aperiodic | The field is mandatory present if the NZP-CSI-RS- |
| | Resources in the associated resourceSet have the |
| | resourceType aperiodic. The field is absent otherwise. |
| CSI-IM-ForInterference | This field is optional need M if the CSI-ReportConfig |
| | identified by reportConfigId is configured with csi-IM- |
| | ResourcesForInterference; otherwise, it is absent. |
| NZP-CSI-RS- | This field is optional need M if the CSI-ReportConfig |
| ForInterference | identified by reportConfigId is configured with nzp-CSI- |
| | RS-ResourcesForInterference; otherwise, it is absent. |

TABLE 39
CSI-SemiPersistentOnPUSCH-TriggerStateList
The CSI-SemiPersistentOnPUSCH-TriggerStateList IE is used to
configure the UE with list of trigger states for semi-persistent
reporting of CSI on L1. See TS 38.214 [19], clause 5.2.1.
CSI-SemiPersistentOnPUSCH-TriggerState List IE

-- ASN1START
-- TAG-CSI-SEMIPERSISTENTONPUSCHTRIGGERSTATELIST-START

| | |
|---|---|
| CSI-SemiPersistentOnPUSCH-TriggerStateList ::= | SEQUENCE(SIZE |

(1..maxNrOfSemiPersistentPUSCH-Triggers)) OF CSI-SemiPersistentOnPUSCH-
TriggerState

| | |
|---|---|
| CSI-SemiPersistentOnPUSCH-TriggerState ::= | SEQUENCE { |
| associatedReportConfigInfo | CSI-ReportConfigId, |

...
}
-- TAG-CSI-SEMIPERSISTENTONPUSCHTRIGGERSTATELIST-STOP
-- ASN1STOP

With regard to the aforementioned CSI report settings (CSI-ReportConfig), each report setting CSI-ReportConfig may be associated with one DL (DL) BWP identified by a higher-layer parameter BWP identifier (bwp-id) given by CSI resource setting CSI-ResourceConfig associated with the corresponding report setting. As time domain reporting for each report setting CSI-ReportConfig, “aperiodic”, “semi-persistent”, and “periodic” schemes may be supported, and these schemes may be configured for the UE by the base station via a reportConfigType parameter configured from a higher layer. A semi-persistent CSI report method may support a “PUCCH-based semi-persistent (semi-PersistentOnPUCCH)” method and a “PUSCH-based semi-persistent (semi-PersistentOnPUSCH)” method. In the case of the periodic or semi-persistent CSI report method, a PUCCH or PUSCH resource in which CSI is to be transmitted may be configured for the UE by the base station via higher-layer signaling. A periodicity and a slot offset of the PUCCH or PUSCH resource in which CSI is to be transmitted may be given by a numerology of a UL BWP configured for CSI report transmission. In the case of the aperiodic CSI report method, a PUSCH resource in which CSI is to be transmitted may be scheduled for the UE by the base station via L1 signaling (aforementioned DCI format 0_1).

With regard to the aforementioned CSI resource settings (CSI-ResourceConfig), each CSI resource setting CSI-ReportConfig may include S (≥1) CSI resource sets (e.g., given via a higher-layer parameter of csi-RS-ResourceSetList). A CSI resource set list may include an NZP CSI-RS resource set and an SS/PBCH block set or may include a CSI-interference measurement (CSI-IM) resource set. Each CSI resource setting may be positioned in a DL BWP identified by higher-layer parameter bwp-id and may be connected to CSI report setting in the same DL BWP. A time domain operation of a CSI-RS resource in CSI resource setting may be configured to be one of “aperiodic”, “periodic”, or “semi-persistent” from the higher-layer parameter resourceType. With regard to the periodic or semi-persistent CSI resource setting, the number of CSI-RS resource sets may be limited to S (S=1), and the configured periodicity and slot offset may be given based on numerology of the DL BWP identified by bwp-id. One or more CSI resource settings for channel or interference measurement may be configured for the UE by the base station via higher-layer signaling, and may include, for example, the following CSI resources.
CSI-IM resource for interference measurement
NZP CSI-RS resource for interference measurement
NZP CSI-RS resource for channel measurement

With regard to CSI-RS resource sets associated with a resource setting in which the higher-layer parameter of resourceType is configured to be “aperiodic”, “periodic”, or “semi-persistent”, a trigger state of CSI report setting having reportType configured to be “aperiodic”, and a resource setting for channel or interference measurement on one or multiple component cells (CCs) may be configured via the higher-layer parameter of CSI-AperiodicTriggerStateList.

Aperiodic CSI reporting of the UE may be performed using a PUSCH, periodic CSI reporting may be performed using a PUCCH, and semi-persistent CSI reporting may be performed using a PUSCH when triggered or activated via DCI, and may be performed using a PUCCH after activated via a MAC CE. As described above, CSI resource setting may also be configured to be aperiodic, periodic, or semi-persistent. A combination of CSI reporting setting and CSI resource setting may be supported based on Table 40 below.

TABLE 40
Triggering/Activation of CSI Reporting
for the possible CSI-RS Configurations.

| CSI-RS | Periodic CSI | Semi-Persistent | Aperiodic CSI |
|---|---|---|---|
| Configuration | Reporting | CSI Reporting | Reporting |
| Periodic | No dynamic | For reporting on | Triggered by DCI; |
| CSI-RS | triggering/ | PUCCH, the UE | additionally, |
| | activation | receives an | activation command |
| | | activation | [10, TS 38.321] |
| | | command [10, TS | possible as defined |
| | | 38.321]; for | in Subclause |
| | | reporting on | 5.2.1.5.1. |
| | | PUSCH, the UE | |
| | | receives | |
| | | triggering | |
| | | on DCI | |
| Semi- | Not | For reporting on | Triggered by DCI; |
| Persistent | Supported | PUCCH, the UE | additionally, |
| CSI-RS | | receives an | activation command |
| | | activation | [10, TS 38.321] |
| | | command [10, TS | possible as defined |
| | | 38.321]; for | in Subclause |
| | | reporting on | 5.2.1.5.1. |
| | | PUSCH, the UE | |
| | | receives | |
| | | triggering | |
| | | on DCI | |
| Aperiodic | Not | Not | Triggered by DCI; |
| CSI-RS | Supported | Supported | additionally, |
| | | | activation command |
| | | | [10, TS 38.321] |
| | | | possible as defined |
| | | | in Subclause |
| | | | 5.2.1.5.1. |

AP CSI reporting may be triggered by a “CSI request” field in DCI format 0_1 described above, which corresponds to scheduling DCI for a PUSCH. The UE may monitor a PDCCH, may acquire DCI format 0_1, and may acquire scheduling information of a PUSCH and a CSI request indicator. The CSI request indicator may be configured to have NTS(=0, 1, 2, 3, 4, 5, or 6) bits, and may be determined by higher-layer signaling (reportTriggerSize). One trigger state among one or multiple aperiodic CSI report trigger states which may be configured via higher-layer signaling (CSI-AperiodicTriggerStateList) may be triggered by the CSI request indicator.
If all bits in the CSI request field are 0, this may indicate that CSI reporting is not requested.
If the number M of configured CSI trigger states in CSI-AperiodicTriggerStateLite is greater than 2NTs-1, M CSI trigger states may be mapped to 2NTs-1 trigger states according to a predefined mapping relation, and one trigger state among the 2NTs-1 trigger states may be indicated by the CSI request field.
If the number M of configured CSI trigger states in CSI-AperiodicTriggerStateLite is less than or equal to 2NTs-1, one of the M CSI trigger states may be indicated by the CSI request field.

Table 41 below shows an example of a relationship between a CSI request indicator and a CSI trigger state that may be indicated by a corresponding indicator.

TABLE 41

| CSI request | | CSI- | CSI- |
|---|---|---|---|
| field | CSI trigger state | ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

The UE may measure a CSI resource in a CSI trigger state triggered via the CSI request field, and then generate CSI (including, for example, at least one of the CQI, PMI, CRI, SSBRI, LI, RI, or L1-RSRP described above) based on the measurement. The UE may transmit the acquired CSI by using the PUSCH scheduled via corresponding DCI format 0_1. If one bit corresponding to an UL data indicator (UL-SCH indicator) in DCI format 0_1 indicates “1”, the UE may multiplex UL data (UL-SCH) and the acquired CSI on the PUSCH resource scheduled by DCI format 0_1 so as to transmit the same. If one bit corresponding to the UL data indicator (UL-SCH indicator) in DCI format 0_1 indicates “0”, the UE may map only CSI, without UL data (UL-SCH), to the PUSCH resource scheduled by DCI format 0_1 so as to transmit the same.

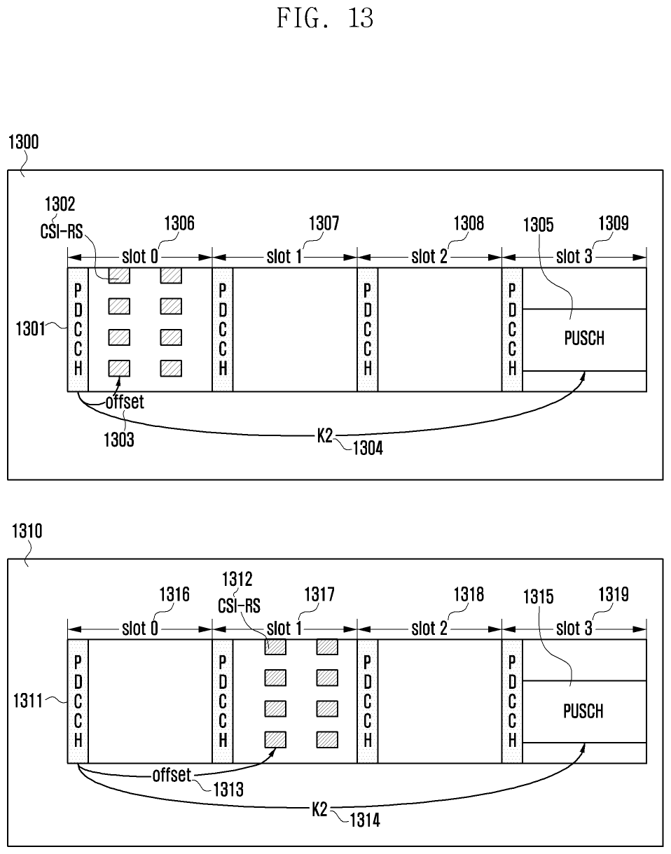

FIG. 13 illustrates an example of an aperiodic CSI reporting method according to an embodiment.

Referring to FIG. 13, in example 1300, a UE may acquire DCI format 0_1 by monitoring a PDCCH 1301, and may acquire scheduling information and CSI request information for a PUSCH 1305 therefrom. The UE may acquire resource information of a CSI-RS 1302 to be measured, from a received CSI request indicator. The UE may determine a time point at which the UE needs to measure a resource of the CSI-RS 1302, based on a time point at which DCI format 0_1 is received, and a parameter for an offset 1303 (e.g., aforementioned aperiodicTriggeringOffset) in a CSI resource set configuration (e.g., an NZP CSI-RS resource set configuration (NZP-CSI-RS-ResourceSet)). More specifically, the UE may be configured with an offset value X of the parameter, aperiodicTriggeringOffset, in the NZP-CSI-RS resource set configuration from a base station via higher-layer signaling, and the configured offset value X may refer to an offset between a slot in which DCI triggering aperiodic CSI reporting is received, and a slot in which the CSI-RS resource is transmitted. For example, aperiodicTriggeringOffset parameter values and offset values X may have mapping relationships as shown in Table 42 below.

TABLE 42

| aperiodicTriggeringOffset | Offset X | |
|---|---|---|
| 0 | 0 | slot |
| 1 | 1 | slot |
| 2 | 2 | slots |
| 3 | 3 | slots |
| 4 | 4 | slots |
| 5 | 16 | slots |
| 6 | 24 | slots |

FIG. 13 shows an example 1300 in which aforementioned offset value X is configured to be 0 (X=0). In this case, the UE may receive the CSI-RS 1302 in a slot (corresponding to slot 0 1306 of FIG. 13) in which DCI format 0_1 triggering aperiodic CSI reporting is received, and may report CSI information, which is measured based on the received CSI-RS, to the base station via the PUSCH 1305. The UE may acquire, from DCI format 0_1, scheduling information (information corresponding to each field of DCI format 0_1 described above) on the PUSCH 1305 for CSI reporting. For example, in DCI format 0_1, the UE may acquire information on a slot in which the PUSCH 1305 is to be transmitted, from TDRA information for the PUSCH 1305 described above. In the example 1300 of FIG. 13, the UE acquires 3 as a K2 value corresponding to a slot offset value for PDCCH-to-PUSCH, and accordingly, the PUSCH 1305 may be transmitted in slot 3 1309, which is spaced 3 slots apart from slot 0 1306, i.e., a time point at which the PDCCH 1301 has been received.

In an example 1310 of FIG. 13, the UE may acquire DCI format 0_1 by monitoring a PDCCH 1311, and may acquire scheduling information and CSI request information for a PUSCH 1315 therefrom. The UE may acquire resource information of a CSI-RS 1312 to be measured, from a received CSI request indicator. The example 1310 of FIG. 13 shows an example in which the offset value X for CSI-RS described above is configured to be 1 (X=1). In this case, the UE may receive the CSI-RS 1312 in a slot (corresponding to slot 0 1316 of FIG. 13) in which DCI format 0_1 triggering aperiodic CSI reporting is received among slot 0 1316, slot 1 1317, slot 2 1318, and slot 3 1319, and may report CSI information, which is measured based on the received CSI-RS, to the base station via the PUSCH 1315. The UE may acquire, from DCI format 0_1, scheduling information (information corresponding to each field of DCI format 0_1 described above) on the PUSCH 1315 for CSI reporting. For example, in DCI format 0_1, the UE may acquire information on a slot in which the PUSCH 1315 is to be transmitted, from TDRA information for the PUSCH 1315 described above. In the example 1310 of FIG. 13, the UE acquires 3 as a K2 value 1314 corresponding to a slot offset value for PDCCH-to-PUSCH, and accordingly, the PUSCH 1315 may be transmitted in slot 3 1319, which is spaced 3 slots apart from slot 0 1316, i.e., a time point at which the PDCCH 1311 has been received.

The AP CSI report may include at least one of or both CSI part 1 and CSI part 2, and when the AP CSI report is transmitted via the PUSCH, the aperiodic CSI report may be multiplexed on a TB. After a CRC is inserted into an input bit of aperiodic CSI for multiplexing, encoding and rate matching may be performed, and then transmission may be performed by mapping to REs within the PUSCH in a specific pattern. The CRC insertion may be omitted depending on a coding method or a length of the input bit. The number of modulation symbols, which is calculated for rate matching during multiplexing of CSI part 1 or CSI part 2 included in the aperiodic CSI report, may be calculated as shown below in Table 43.

```
TABLE 43
For CSI part 1 transmission on PUSCH not using repetition type B with UL-SCH, the
number of coded modulation symbols per layer for CSI part 1 transmission, denoted as
${Q}_{CSI - part 1}^{′} , is determined as follows :$
    ${Q}_{CSI - 1}^{′} = min \{ ⌈ \frac{( {o}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \}$
. . .
For CSI part 1 transmission on an actual repetition of a PUSCH with repetition Type B
with UL-SCH, the number of coded modulation symbols per layer for CSI part 1
$transmission , denoted as {Q}_{CSI - part 1}^{′} , is determind as follows :$
    ${Q}_{CSI - 1}^{′} = min \{ ⌈ \frac{\begin{matrix}( {o}_{CSI - 1} + {L}_{CSI - 1} ) \cdot {β}_{offset}^{PUSCH} \cdot \\ {\sum }_{l = 0}^{{N}_{symb , nominal}^{PUSCH} - 1} {M}_{sc , nominal}^{UCI} ( l )\end{matrix}}{{\sum }_{r = 0}^{{C}_{UL - SCH} - 1} {K}_{r}} ⌉ , ⌈ α \cdot {{{\sum }^{{N}_{symb , nominal}^{PUSCH} - 1}}_{l = 0}}^{} {M}_{sc , nominal}^{UCI} ( l ) ⌉ - {Q}_{ACK / CG - UCI}^{′} , {{\sum }^{{N}_{symb , actual}^{PUSCH} - 1}}_{l = 0} {M}_{sc , actual}^{UCI} ( l ) - {Q}_{ACK / CG - UCI}^{′} \}$
. . .
For CSI part 1 transmission on PUSCH without UL-SCH, the number of coded
modulation symbols per layer for CSI part 1 transmission, denoted as
${Q}_{CSI - part 1}^{′} , is determined as follows :$
if there is CSI part 2 to be transmitted on the PUSCH,
    ${Q}_{CSI - 1}^{′} = min \{ ⌈ \frac{( {o}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$
else
    ${Q}_{CSI - 1}^{′} = {\sum }_{l = 0}^{{N}_{symb , all}^{PUSCH} - 1} {M}_{sc}^{UCI} ( l ) - {Q}_{ACK}^{′}$
end if
. . .
For CSI part 2 transmission on PUSCH not using repetition type B with UL-SCH, the
number of coded modulation symbols per layer for CSI part 2 transmission, denoted as
${Q}_{CSI - part 2}^{′} , is determined as follows :$
    ${Q}_{CSI - 2}^{′} = min \{ ⌈ \frac{( {o}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \}$
For CSI part 2 transmission on an actual repetition of a PUSCH with repetition Type B
with UL-SCH, the number of coded modulation symbols per layer for CSI part 2
$transmission , denoted as {Q}_{CSI - part 2}^{′} , is determind as follows :$
    ${Q}_{CSI - 2}^{′} = min \{ ⌈ \frac{\begin{matrix}( {o}_{CSI - 2} + {L}_{CSI - 2} ) \cdot {β}_{offset}^{PUSCH} \cdot \\ {\sum }_{l = 0}^{{N}_{symb , nominal}^{PUSCH} - 1} {M}_{sc , nominal}^{UCI} ( l )\end{matrix}}{{\sum }_{r = 0}^{{C}_{UL - SCH} - 1} {K}_{r}} ⌉ , ⌈ α \cdot {{{\sum }^{{N}_{symb , nominal}^{PUSCH} - 1}}_{l = 0}}^{} {M}_{sc , nominal}^{UCI} ( l ) ⌉ - {Q}_{ACK / CG - UCI}^{′} - {Q}_{CSI - 1}^{′} , {{\sum }^{{N}_{symb , actual}^{PUSCH} - 1}}_{l = 0} {M}_{sc , actual}^{UCI} ( l ) - {Q}_{ACK / CG - UCI}^{′} - {Q}_{CSI - 1}^{′} \}$
. . .
For CSI part 2 transmission on PUSCH without UL-SCH, the number of coded
modulation symbols per layer for CSI part 2 transmission, denoted as
${Q}_{CSI - part 2}^{′} , is determined as follows :$
    ${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′}$
```

Specifically, for repeated PUSCH transmission schemes A and B, the UE may multiplex the aperiodic CSI report only on the first repetition transmission among PUSCH repetition transmissions, so as to transmit the same. This is because aperiodic CSI report information to be multiplexed is encoded in a polar code scheme, and at this time, each PUSCH repetition needs to have the same frequency and time resource allocation in order to multiplex the aperiodic CSI report information on multiple PUSCH repetitions. Particularly, in the case of PUSCH repetition type B transmission, since each actual repetition may have different OFDM symbol durations, the aperiodic CSI report may be multiplexed only on the first repetition and then transmitted.

In addition, for repeated PUSCH transmission scheme B, when the UE receives DCI for activation of semi-persistent CSI reporting or scheduling of aperiodic CSI reporting without scheduling for a TB, the UE may assume that a value of nominal repetition is 1 even if the number of repeated PUSCH transmissions, which is configured via higher-layer signaling, is greater than 1. In addition, when the aperiodic or semi-persistent CSI reporting is scheduled or activated without scheduling for a TB, based on repeated PUSCH transmission scheme B, the UE may expect that a first nominal repetition is identical to a first actual repetition. With regard to the PUSCH transmitted while including semi-persistent CSI, based on repeated PUSCH transmission scheme B, without scheduling for DCI after the semi-persistent CSI reporting has been activated via the DCI, if the first nominal repetition is different from the first actual repetition, transmission for the first nominal repetition may be ignored.

### [PUSCH: Regarding Repetition Transmission]

A 5G system supports two types of UL data channel repetition transmission methods, PUSCH repetition type A transmission and PUSCH repetition type B transmission. One of PUSCH repetition type A transmission and PUSCH repetition type B transmission may be configured for a UE through higher layer signaling.

### PUSCH Repetition Type a Transmission

As described above, the symbol length of an UL data channel and the location of the start symbol may be determined by a TDRA method in one slot, and a base station may notify a UE of the number of repetition transmissions through higher layer signaling (for example, RRC signaling) or L1 signaling (e.g., DCI).

Based on the number of repetition transmissions received from the base station, the UE may repetitively transmit a UL data channel having the same length and start symbol as the configured UL data channel, in consecutive slots. If the base station configured a slot as a DL for the UE, or if at least one of symbols of the UL data channel configured for the UE is configured as a DL, the UE omits UL data channel transmission, but counts the number of repetition transmissions of the UL data channel.

### PUSCH Repetition Type B Transmission

As described above, the symbol length of an UL data channel and the location of the start symbol may be determined by a TDRA method in one slot, and a base station may notify a UE of the number of repetition transmissions (numberofrepetitions) through higher layer signaling (e.g., RRC signaling) or L1 signaling (e.g., DCI).

The nominal repetition of the UL data channel is determined as follows, based on the previously configured start symbol and length of the UL data channel. The slot in which the n^{th} nominal repetition starts is given by

$${K}_{s} = ⌊ \frac{S + n \cdot L}{{N}_{symb}^{slot}} ⌋ ,$$

and the symbol starting in that slot is given by

$$mod ( S + n \cdot L , {N}_{symb}^{slot} )$$

The slot in which the n^{th} nominal repetition ends is given by

$${K}_{s} + ⌊ \frac{S + ( n + 1 ) \cdot L - 1}{{N}_{symb}^{slot}} ⌋ ,$$

and the symbol ending in that slot is given by

$$mod ( S + ( n + 1 ) \cdot L - 1 , {N}_{symb}^{slot} ) .$$

Here, n=0, . . . , numberofrepetitions-1, S may denote the configured start symbol of the UL data channel, and L may indicate the configured symbol length of the UL data channel. Kₛ refers to the slot in which PUSCH transmission starts, and

$${N}_{symb}^{slot}$$

refers to the number of symbols per slot.
The UE determines an invalid symbol for PUSCH repetition type B transmission. A symbol configured as a DL by tdd-UL-DL-ConfigurationCommon or tdd-UL-DL-ConfigurationDedicated is determined as the invalid symbol for PUSCH repetition type B transmission. Additionally, the invalid symbol may be configured in an higher layer parameter (e.g., InvalidSymbolPattern). The higher layer parameter (for example, InvalidSymbolPattern) may provide a symbol level bitmap across one or two slots, thereby configuring the invalid symbol. In the bitmap, 1 represents the invalid symbol. Additionally, the periodicity and pattern of the bitmap may be configured through the higher layer parameter (e.g., InvalidSymbolPattern). If an higher layer parameter (for example, InvalidSymbolPattern) is configured, and if parameter InvalidSymbolPatternIndicator-ForDCIFormat0_1 or InvalidSymbolPatternIndicator-ForDCIFormat0_2 indicates 1, the UE applies an invalid symbol pattern, and if the above parameter indicates 0, the UE does not apply the invalid symbol pattern. If an higher layer parameter (e.g., InvalidSymbolPattern) is configured, and if parameter InvalidSymbolPatternIndicator-ForDCIFormat0_1 or InvalidSymbolPatternIndicator-ForDCIFormat0_2 is not configured, the UE applies the invalid symbol pattern.

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition includes a set of consecutive valid symbols available for PUSCH repeated transmission type B in one slot.

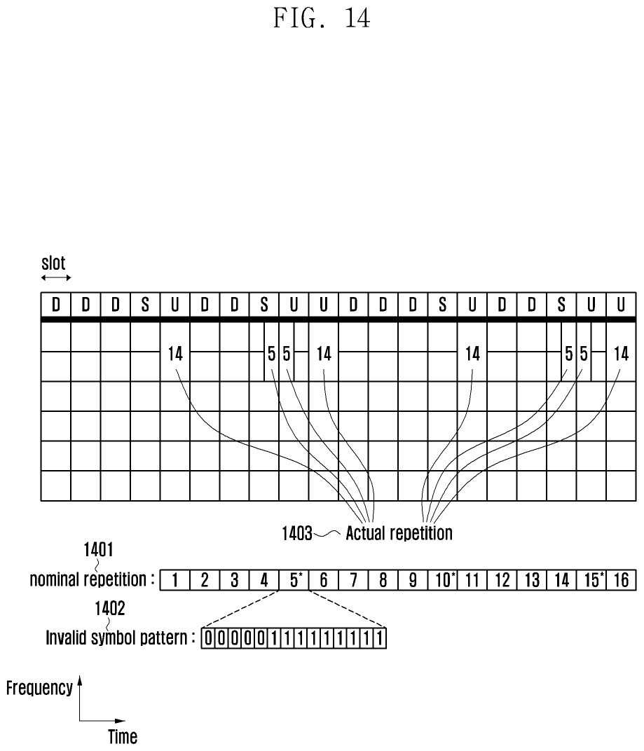

FIG. 14 illustrates an example of PUSCH repetition type B transmission in a wireless communication system according to an embodiment.

Referring to FIG. 14, the UE may receive the following configurations: the start symbol S of an UL data channel is 0, the length L of the UL data channel is 14, and the number of repetition transmissions is 16. In this case, nominal repetitions may appear in 16 consecutive slots (1401). Thereafter, the UE may determine that the symbol configured as a DL symbol in each nominal repetition % n is an invalid symbol. The UE determines that symbols configured as 1 in the invalid symbol pattern % n are invalid symbols. If valid symbols other than invalid symbols in respective nominal repetitions constitute one or more consecutive symbols in one slot, they are configured and transmitted as actual repetitions (1403).

In addition, with regard to PUSCH repetition transmission, additional methods may be defined in NR Release 16 with regard to UL grant-based PUSCH transmission and CG-based PUSCH transmission, across slot boundaries, as follows:
Method 1 (mini-slot level repetition): through one UL grant, two or more PUSCH repetition transmissions are scheduled inside one slot or across the boundary of consecutive slots. In connection with method 1, TDRA information inside DCI indicates resources of the first repetition transmission. In addition, time domain resource information of remaining repetition transmissions may be determined according to time domain resource information of the first repetition transmission, and the UL or DL direction determined with regard to each symbol of each slot. Each repetition transmission occupies consecutive symbols.
Method 2 (multi-segment transmission): through one UL grant, two or more PUSCH repetition transmissions are scheduled in consecutive slots. Transmission no. 1 is designated for each slot, and the start point or repetition length differs between respective transmissions. In method 2, TDRA information inside DCI indicates the start point and repetition length of all repetition transmissions. In the case of performing repetition transmissions inside a single slot through method 2, if there are multiple bundles of consecutive UL symbols in the corresponding slot, respective repetition transmissions may be performed with regard to respective UL symbol bundles. If there is only a single bundle of consecutive UL symbols in the corresponding slot, PUSCH repetition transmission is performed once according to the method of NR Release 15.
Method 3: two or more PUSCH repetition transmissions are scheduled in consecutive slots through two or more UL grants. Transmission no. 1 may be designated with regard to each slot, and the n^{th} UL grant may be received before PUSCH transmission scheduled by the (n−1)th UL grant is over.
Method 4: through one UL grant or one CG, one or multiple PUSCH repetition transmissions inside a single slot, or two or more PUSCH repetition transmissions across the boundary of consecutive slots may be supported. The number of repetitions indicated to the UE by the base station is only a nominal value, and the UE may actually perform a larger number of PUSCH repetition transmissions than the nominal number of repetitions. TDRA information inside DCI or CG refers to resources of the first repetition transmission indicated by the base station. Time domain resource information of remaining repetition transmissions may be determined with reference to resource information of the first repetition transmission and the UL or DL direction of symbols. If time domain resource information of repetition transmission indicated by the base station spans a slot boundary or includes an UL/DL switching point, the corresponding repetition transmission may be divided into multiple repeated transmissions. One repetition transmission may be included in one slot with regard to each UL period.

The above-described repetition transmission may be applied to both a dynamic grant (DG) PUSCH and a CG PUSCH. The DG PUSCH refers to a scheme in which all scheduling information is provided by DCI, and the CG PUSCH refers to a scheme in which PUSCH scheduling information is provided only through an higher signal or partially provided through DCI. In addition, the DG PUSCH corresponds to a scheme in which a UE transmits a PUSCH only in a scheduling region provided by DCI, and the CG PUSCH corresponds to a scheme in which a UE periodically transmits a PUSCH at periodicity configured by an higher signal without separately receiving DCI.

### [UE Capability Report]

In LTE and NR, a UE may perform a procedure in which, while being connected to a serving base station, the UE may report capability supported by the UE to the corresponding base station. In the following description, the above-described procedure will be referred to as a UE capability report.

The base station may transfer a UE capability enquiry message to a UE in a connected state so as to request a capability report. The message may include a UE capability request with regard to each radio access technology (RAT) type of the base station. The RAT type-specific request may include supported frequency band combination (BC) information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT DC (MR-DC), such as NR, LTE, E-UTRA-NR DC (EN-DC). The UE capability enquiry message may be transmitted initially after the UE is connected to the base station, in general, but may be requested in any condition if needed by the base station.

Upon receiving the UE capability report request from the base station in the above step, the UE configures UE capability according to band information and RAT type requested by the base station. The method in which the UE configures UE capability in an NR system is summarized below.
1. If the UE receives a list regarding LTE and/or NR bands from the base station at a UE capability request, the UE constructs BCs regarding EN-DC and NR standalone (SA). That is, the UE configures a candidate list of BCs regarding EN-DC and NR SA, based on bands received from the base station at a request through FreqBandList. Bands have priority in the order described in FreqBandList.
2. If the base station sets “eutra-nr-only” flag or “eutra” flag and requests a UE capability report, the UE removes everything related to NR SA BCs from the configured BC candidate list. Such an operation may occur only if an LTE base station (eNB) requests “eutra” capability.
3. The UE then removes fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same may be omitted. This step is applied in MR-DC as well, that is, LTE bands are also applied. BCs remaining after the above step constitute the final “candidate BC list”.
4. The UE selects BCs appropriate for the requested RAT type from the final “candidate BC list” and configures BCs to report. In this step, the UE configures supportedBandCombinationList in a determined order. That is, the UE configures BCs and UE capability to report according to a preconfigured rat-Type order. (nr->eutra-nr->eutra). In addition, the UE configures featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be acquired from feature set combinations of containers of UE-NR-Capabilities and UE-MRDC-Capabilities.
5. If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the base station. The base station performs scheduling and transmission/reception management appropriate for the UE, based on the UE capability received from the UE.

### [CA/DC]

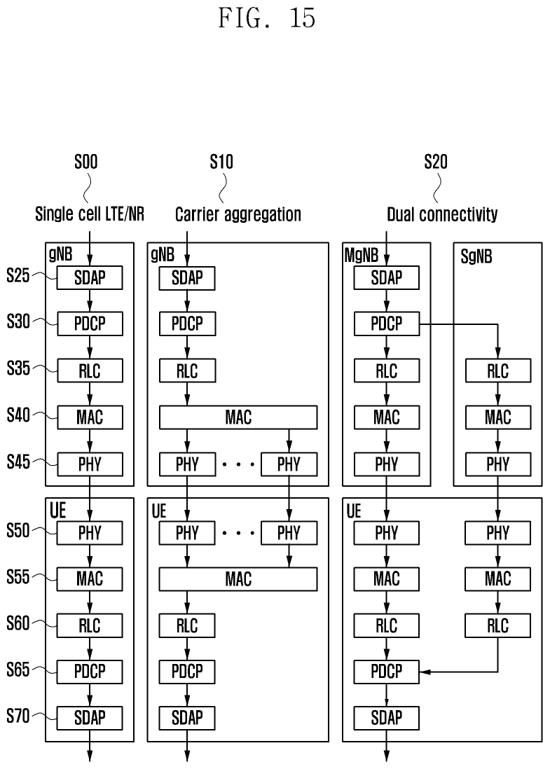

FIG. 15 illustrates radio protocol structures of a base station and a UE in single cell, CA, and DC situations according to an embodiment.

Referring to FIG. 15, a radio protocol of a mobile communication system includes an NR service data adaptation protocol (SDAP) S25 or S70, an NR packet data convergence protocol (PDCP) S30 or S65, an NR radio link control (RLC) S35 or S60, and an NR MAC S40 or S55, on each of UE and NR base station sides.

Functions of the NR SDAP S25 or S70 may include some of functions below.
Transfer of user plane data
Mapping between a quality of service (QOS) flow and a data radio bearer (DRB) for both DL and UL
Marking QoS flow ID in both DL and UL packets
Reflective QoS flow to DRB mapping for the UL SDAP protocol data units (PDUs)

With regard to the SDAP layer device, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QOS reflection configuration 1-bit indicator (NAS reflective QoS) and an access stratum (AS) QoS reflection configuration 1-bit indicator (AS reflective QoS) of the SDAP header may be indicated so that the UE can update or reconfigure mapping information regarding the QoS flow and data bearer of the UL and DL. The SDAP header may include QoS flow ID information indicating the QoS. The QoS information may be used as data processing priority, scheduling information, etc. for smoothly supporting services.

Functions of the NR PDCP S30 or S65 may include some of functions below.
Header compression and decompression: Robust header compression (ROHC) only
Transfer of user data
In-sequence delivery of upper layer PDUs
Out-of-sequence delivery of upper layer PDUs
PDCP PDU reordering for reception
Duplicate detection of lower layer service data units (SDUs)
Retransmission of PDCP SDUs
Ciphering and deciphering
Timer-based SDU discard in UL

The above-mentioned reordering of the NR PDCP device refers to a function of reordering PDCP PDUs received from a lower layer in an order based on the PDCP sequence number (SN), and may include a function of transferring data to an upper layer in the reordered sequence. Alternatively, the reordering of the NR PDCP device may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

Functions of the NR RLC S35 or S60 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device refers to a function of delivering RLC SDUs, received from the lower layer, to the upper layer in sequence. The in-sequence delivery of the NR RLC device may include a function of reassembling and delivering multiple RLC SDUs received, into which one original RLC SDU has been segmented, may include a function of reordering the received RLC PDUs with reference to the RLC SN or PDCP SN, may include a function of recording RLC PDUs lost as a result of reordering, may include a function of reporting the state of the lost RLC PDUs to the transmitting side, and may include a function of requesting retransmission of the lost RLC PDUs. The in-sequence delivery of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer.

Alternatively, the in-sequence delivery of the NR RLC device may include a function of, if a predetermined timer has expired although there is a lost RLC SDU, successively delivering all RLC SDUs received until now to the upper layer. In addition, the in-sequence delivery of the NR RLC device may include a function of processing RLC PDUs in the received order (regardless of the SN order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device refers to a function of instantly delivering RLC SDUs received from the lower layer to the upper layer regardless of the order, may include a function of, if multiple RLC SDUs received, into which one original RLC SDU has been segmented, are received, reassembling and delivering the same, and may include a function of storing the RLC SN or PDCP SN of received RLC PDUs, and recording RLC PDUs lost as a result of reordering.

The NR MAC S40 or S55 may be connected to multiple NR RLC layer devices configured in one UE, and functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
Multimedia broadcast multicast services (MBMS) service identification
Transport format selection
Padding

An NR PHY layer S45 or S50 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as S00. On the other hand, in case that the base station transmits data to the UE, based on CA that uses multiple carriers in a single TRP, the base station and the UE may use a protocol structure which has a single structure up to the RLC, but multiplexes the PHY layer through a MAC layer, such as S10. As another example, in case that the base station transmits data to the UE, based on DC that uses multiple carriers in multiple TRPs, the base station and the UE may use a protocol structure which has a single structure up to the RLC, but multiplexes the PHY layer through a MAC layer, such as S20.

Referring to the above description relating to the PDCCH and beam configuration, PDCCH repetitive transmission is not supported in current Rel-15 and Rel-16 NR, and it may be thus difficult to achieve required reliability in a scenario requiring high reliability, such as URLLC. The disclosure may improve the PDCCH reception reliability of a UE by providing a PDCCH repetitive transmission method through multiple TRPs. Specific methods thereof will be described hereinafter through the embodiments below.

As used herein, higher signaling (or higher layer signaling) is a method for transferring signals from a base station to a UE by using a DL data channel of a physical layer, or from the UE to the base station by using an UL data channel of the physical layer, and may also be referred to as “RRC signaling”, “PDCP signaling”, or “MAC CE”.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an higher layer. Hereinafter, it will be assumed for the sake of descriptive convenience that a non-coherent joint transmission (NC-JT) case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

### [NC-JT]

According to an embodiment of the disclosure, in order to receive a PDSCH from a plurality of TRPs, the UE may use NC-JT.

A 5G wireless communication system may support a service requiring a high transmission rate, and also a service having a very short transmission delay and a service requiring a high connection density.

In a wireless communication network including multiple cells, TRPs, or beams, cooperative communication (coordinated transmission) between the respective cells, TRPs, or/and beams may satisfy various service requirements by enhancing the strength of a signal received by a UE or efficiently performing interference control between the respective cells, TRPs, or/and beams.

Joint transmission (JT) is a representative transmission scheme for the aforementioned cooperative communication, and is a scheme for increasing the strength or throughput of a signal received by a UE, by transmitting the signal to one UE via multiple different cells, TRPs, and/or beams. In this case, channels between the UE and the respective cells, TRPs, and/or beams may have significantly different characteristics, and in particular, NC-JT supporting non-coherent precoding between the respective cells, TRPs, and/or beams may require individual precoding, MCS, resource allocation, TCI indication, etc. according to a channel characteristic for each link between the UE and the respective cells, TRPs, and/or beams.

The aforementioned NC-JT transmission may be applied to at least one channel among a DL data channel (e.g., a PDSCH), a DL control channel (e.g., PDCCH), an UL data channel (e.g., a PUSCH), and a UL control channel (e.g., PUCCH). During PDSCH transmission, transmission information such as precoding, MCS, resource allocation, and TCI may be indicated through DL DCI, and should be independently indicated for each cell, TRP, and/or beam for the NC-JT. This is a significant factor that increases payload required for DL DCI transmission, which may have a bad influence on reception performance of a PDCCH for transmitting the DCI. Accordingly, in order to support JT of the PDSCH, carefully designing a tradeoff between an amount of DCI information and reception performance of control information is required.

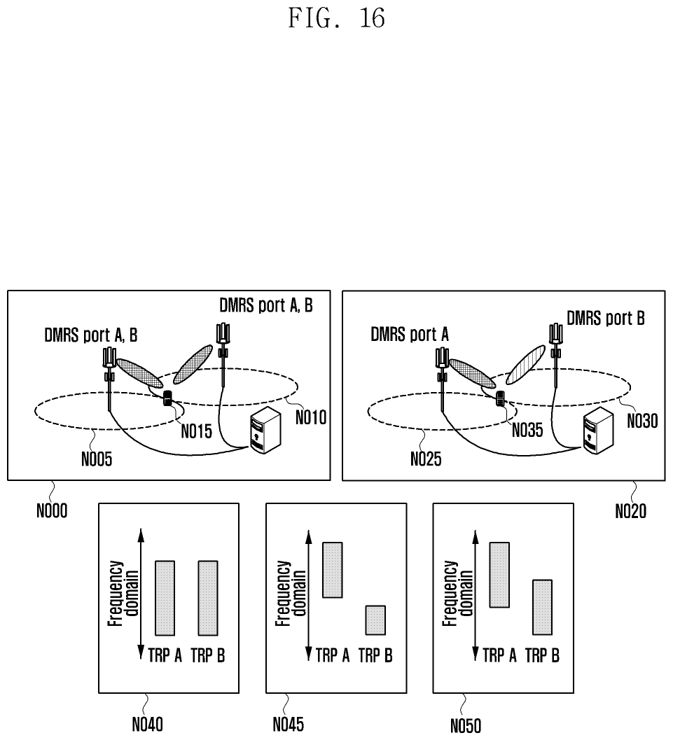

FIG. 16 illustrates an example of an antenna port configuration and resource allocation for PDSCH transmission using cooperative communication in the wireless communication system according to an embodiment.

Referring to FIG. 16, the example for PDSCH transmission is described for each scheme of JT, and examples for allocating radio resources for each TRP are described.

Referring to FIG. 16, an example N000 for coherent JT (C-JT) supporting coherent precoding between respective cells, TRPs, or/and beams is illustrated.

For C-JT, TRP A N005 and TRP B N010 transmit a single piece of data (e.g., a PDSCH) to a UE N015, and joint precoding may be performed in multiple TRPs. This may indicate that DMRSs are transmitted through identical DMRS ports in order for TRP A N005 and TRP B N010 to transmit the same PDSCH. For example, TRP A N005 and TRP B N010 may transmit DMRSs to the UE through DMRS port A and DMRS port B, respectively. In this case, the UE may receive one piece of DCI information for receiving one PDSCH demodulated based on the DMRSs transmitted through the DMRS port A and the DMRS port B.

FIG. 16 shows an example N020 of non-coherent joint transmission (NC-JT) supporting non-coherent precoding between respective cells, TRPs, and/or beams for PDSCH transmission.

For NC-JT, a PDSCH is transmitted to a UE N035 for each cell, TRP, or/and beam N025 or N030, and individual precoding may be applied to each PDSCH. Respective cells, TRPs, and/or beams may transmit different PDSCHs or different PDSCH layers to the UE, thereby improving throughput compared to single cell, TRP, and/or beam transmission. Furthermore, the respective cells, TRPs, and/or beams may repeatedly transmit the same PDSCH to the UE, thereby improving reliability as compared to single cell, TRP, and/or beam transmission. For the sake of descriptive convenience, a cell, a TRP, and/or a beam may be collectively referred to as a TRP.

In this case, various radio resource allocations may be considered, such as a case N040 where frequency and time resources used in multiple TRPs for PDSCH transmission are all identical, a case N045 where frequency and time resources used in multiple TRPs do not overlap at all, and a case N050 where some of frequency and time resources used in multiple TRPs overlap.

To support NC-JT, DCI of various types, structures, and relations may be considered to assign multiple PDSCHs simultaneously to a single UE.

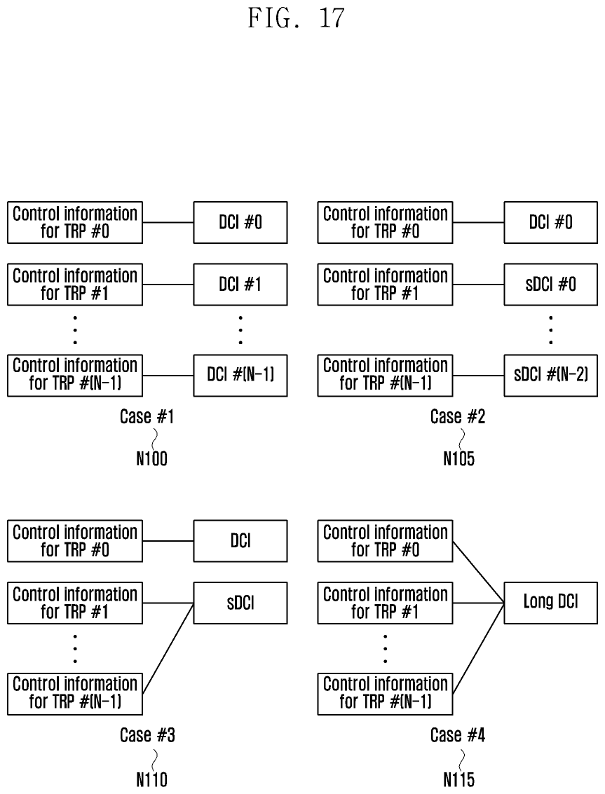

FIG. 17 illustrates an example of a DCI configuration for NC-JT in which respective TRPs transmit different PDSCHs or different PDSCH layers to a UE in a wireless communication system according to an embodiment.

Referring to FIG. 17, case #1 N100 is an example in which, in a situation where different N−1 PDSCHs are transmitted from N−1 additional TRPs (TRP #1 to TRP #N−1) in addition to a serving TRP (TRP #0) used during single PDSCH transmission, control information for PDSCHs transmitted in the additional N−1 TRPs is transmitted independently of control information for a PDSCH transmitted in the serving TRP. That is, the UE may acquire control information for PDSCHs transmitted from different TRPs (TRP #0 to TRP #(N−1)) through independent DCIs (DC1 #0 to DCI #(N−1)). Formats between the independent pieces of DCI may be the same or different from each other, and payloads between the pieces of DCI may also be the same or different from each other. In case #1 described above, a degree of freedom of PDSCH control or allocation may be completely guaranteed, but when respective pieces of the DCI are transmitted by different TRPs, a difference between DCI coverages may be generated and reception performance may deteriorate.

Case #2 N105 is an example in which pieces of control information (DCI) for PDSCHs of (N−1) additional TRPs are transmitted and each piece of the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, DCI #0 that is control information for a PDSCH transmitted from the serving TRP (TRP #0) may include all IEs of DCI format 1_0, DCI format 1_1, and DCI format 1_2, but shortened DCIs (hereinafter, referred to as sDCIs) (sDCI #0 to sDCI #(N−2)) that are control information for PDSCHs transmitted from the cooperative TRPs (TRP #1 to TRP #(N−1)) may include only some of the IEs of DCI format 1_0, DCI format 1_1, and DCI format 1_2. Accordingly, in the case of sDCI for transmission of the control information for the PDSCHs transmitted from the cooperative TRPs, a payload is small compared to normal DCI (nDCI) for transmission of the control information related to the PDSCH transmitted from the serving TRP, so that reserved bits may be included in comparison with nDCI.

In case #2 described above, a degree of freedom of each PDSCH control or allocation may be limited according to content of IEs included in the sDCI, but reception capability of the sDCI is better than the nDCI, and thus a probability of the generation of difference between DCI coverages may become lower.

Case #3 N110 is an example in which one piece of control information for PDSCHs of (N−1) additional TRPs is transmitted and the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, in the case of DCI #0 that is control information for the PDSCH transmitted from the serving TRP (TRP #0), all IEs of DCI format 1_0, DCI format 1_1, and DCI format 1_2 may be included, and in the case of control information for PDSCHs transmitted from cooperative TRPs (TRP #1 to TRP #(N−1)), only some of the IEs of DCI format 1_0, DCI format 1_1, and DCI format 1_2 may be gathered in one “secondary” DCI (sDCI) and transmitted. For example, the sDCI may include at least one piece of HARQ-related information such as frequency domain resource assignment and time domain resource assignment of the cooperative TRPs and the MCS. In addition, information that is not included in the sDCI such as a BWP (BWP) indicator and a carrier indicator may follow the DCI (DCI #0, normal DCI, or nDCI) of the serving TRP.

In case #3 N110, each PDSCH control or allocation freedom may be restricted according to content of the IE included in the sDCI, but sDCI reception performance may be adjustable, and complexity of DCI blind decoding of the UE may be reduced compared to case #1 N100 or case #2 N105.

Case #4 N115 is an example in which, in a situation where N−1 different PDSCHs are transmitted from N−1 additional TRPs (TRP #1 to TRP #N−1) in addition to a serving TRP (TRP #0) used during single PDSCH transmission, control information for PDSCHs transmitted from the N−1 additional TRPs is transmitted in the same DCI (long DCI) as that for the control information for the PDSCH transmitted from the serving TRP. That is, the UE may acquire control information for PDSCHs transmitted from different TRPs (TRP #0 to TRP #(N−1)) through single DCI. In case #4 N115, complexity of DCI blind decoding of the UE may not increase, but a PDSCH control or allocation freedom may be low, such that the number of cooperative TRPs is limited according to long DCI payload restrictions.

In the following description and embodiments, sDCI may refer to various pieces of supplementary DCI such as shortened DCI, secondary DCI, or normal DCI (DCI formats 1_0 and 1_1 described above) including PDSCH control information transmitted in the cooperative TRP, and unless specific restriction is mentioned, the corresponding description may be similarly applied to the various pieces of supplementary DCI.

In the following descriptions and embodiments, aforementioned cases #1 N100, case #2 N105, and case #3 N110, in which one or more pieces of DCI are used for NC-JT support, may be classified as multiple-PDCCH-based NC-JT, and aforementioned case #4 N115, in which a single piece of DCI (e.g., a PDCCH) is used for NC-JT support, may be classified as single-PDCCH-based NC-JT. In multiple PDCCH-based PDSCH transmission, a CORESET for scheduling the DCI of the serving TRP (TRP #0) is separated from CORESETs for scheduling the DCI of cooperative TRPs (TRP #1 to TRP #(N−1)). A method of distinguishing the CORESETs may include a distinguishing method through a higher-layer indicator for each CORESET and a distinguishing method through a beam configuration for each CORESET. Also, in single PDCCH-based NC-JT, single DCI schedules a single PDSCH having a plurality of layers instead of scheduling a plurality of PDSCHs, and the plurality of layers may be transmitted from a plurality of TRPs. In this case, association between a layer and a TRP transmitting the corresponding layer may be indicated through a TCI indication for the layer.

In embodiments of the disclosure, the term “cooperative TRP” may be replaced with various terms, such as “cooperative panel” or “cooperative beam” when actually applied.

In embodiments of the disclosure, “the case in which NC-JT is applied” may be variously interpreted as “the case in which the UE simultaneously receives one or more PDSCHs in one BWP”, “the case in which the UE simultaneously receives PDSCHs based on two or more TCI indications in one BWP”, and “the case in which the PDSCHs received by the UE are associated with one or more DMRS port groups” according to circumstances, but is used by one expression for the sake of descriptive convenience.

In the disclosure, a radio protocol structure for NC-JT may be used in various ways according to a TRP deployment scenario. For example, if there is a small backhaul delay or no backhaul delay between cooperative TRPs, a method (CA-like method) using a structure based on MAC layer multiplexing is possible in a similar manner to reference numeral S10 of FIG. 7. On the other hand, if a backhaul delay between cooperative TRPs is so large that the backhaul delay cannot be ignored (e.g., when a time of 2 ms or longer is required for exchange of information, such as CSI, scheduling, and HARQ-ACK, between the cooperative TRPs), a method (DC-like method) of securing characteristics robust to a delay by using an independent structure for each TRP starting from the RLC layer is possible in a similar manner to reference numeral S20 of FIG. 15.

The UE supporting C-JT/NC-JT may receive a C-JT/NC-JT-related parameter, setting value, or the like from a higher-layer configuration, and may set an RRC parameter of the UE, based on the parameter, the setting value, or the like. For the higher-layer configuration, the UE may use a UE capability parameter, for example, tci-StatePDSCH. Here, the UE capability parameter, for example, tci-StatePDSCH may define TCI states for PDSCH transmission, the number of TCI states may be configured as 4, 8, 16, 32, 64, and 128 in FR1 and as 64 and 128 in FR2, and a maximum of 8 states which can be indicated by 3 bits of a TCI field of the DCI may be configured through a MAC CE message among the configured numbers. A maximum value 128 refers to a value indicated by maxNumberConfiguredTCI statesPerCC within the parameter tci-StatePDSCH which is included in capability signaling of the UE. In this way, a series of configuration procedures from the higher-layer configuration to the MAC CE configuration may be applied to a beamforming change command or a beamforming indication for at least one PDSCH in one TRP.

### [Multi-DCI-Based Multi-TRP]

According to an embodiment of the disclosure, a DL control channel for NC-JT transmission may be configured based on multiple PDCCHs.

In NC-JT based on multiple PDCCHs, there may be a CORESET or a search space separated for each TRP when the DCI for scheduling the PDSCH of each TRP is transmitted. The CORESET or search space for each TRP may be configured as at least one of the following cases.
A configuration of a higher-layer index for each CORESET: CORESET configuration information configured by a higher layer may include an index value, and a TRP for transmitting a PDCCH in the corresponding CORESET may be distinguished by the configured index value for each CORESET. That is, in a set of CORESETs having the same higher-layer index value, it may be considered that the same TRP transmits the PDCCH or that the PDCCH for scheduling the PDSCH of the same TRP is transmitted. The aforementioned index for each CORESET may be named CORESETPoolIndex, and for CORESETs for which the same CORESETPoolIndex value has been configured, it may be considered or determined that PDCCHs are transmitted from the same TRP. For a CORESET for which no CORESETPoolIndex value has been configured, it may be considered that a default value has been configured for CORESETPoolIndex, and the default value may be 0.
A configuration of multiple PDCCH-Config: a plurality of PDCCH-Config are configured in one BWP, and each PDCCH-Config may include a PDCCH configuration for each TRP. That is, a list of CORESETs for each TRP and/or a list of search spaces for each TRP may be included in one PDCCH-Config, and it may be considered that one or more CORESETs and one or more search spaces included in one PDCCH-Config correspond to a specific TRP.
CORESET beam/beam group configuration: A TRP corresponding to a corresponding CORESET may be distinguished via a beam or beam group configured for each CORESET. For example, if the same TCI state is configured for multiple CORESETs, it may be considered or determined that the CORESETs are transmitted via the same TRP, or that a PDCCH for scheduling of a PDSCH of the same TRP is transmitted in the corresponding CORESET.
Search space beam/beam group configuration: A beam or beam group may be configured for each search space, and a TRP for each search space may be distinguished based on the configured beam or beam group. For example, if the same beam/beam group or TCI state is configured in a plurality of search spaces, the same TRP may transmit the PDCCH in the corresponding search space or a PDCCH for scheduling a PDSCH of the same TRP may be transmitted in the corresponding search space.

As described above, by distinguishing the CORESETs or search spaces according to TRPs, it may be possible to classify PDSCH and HARQ-ACK information for each TRP, and based on this, it may be possible to independently generate a HARQ-ACK codebook and independently use a PUCCH resource for each TRP.

The configuration may be independent for each cell or each BWP. For example, while two different CORESETPoolIndex values may be configured in a primary cell (PCell), no CORESETPoolIndex value may be configured in a specific SCell. In this case, it may be considered that NC-JT transmission has been configured for the PCell, whereas NC-JT transmission has not been configured for the SCell for which no CORESETPoolIndex value has been configured.

### [Single-DCI-Based Multi-TRP]

According to another embodiment of the disclosure, a DL beam for NC-JT transmission may be configured based on a single PDCCH.

In single-PDCCH-based NC-JT, PDSCHs transmitted by multiple TRPs may be scheduled via one piece of DCI. Here, as a method of indicating the number of TRPs transmitting the corresponding PDSCHs, the number of TCI states may be used. That is, if the number of TCI states indicated in DCI for scheduling of a PDSCH is two, single-PDCCH-based NC-JT transmission may be considered, and if the number of TCI states is one, single-TRP transmission may be considered. The TCI states indicated by the DCI may correspond to one or two TCI states among TCI states activated by the MAC CE. If the TCI states of the DCI correspond to two TCI states activated via the MAC-CE, a correspondence is established between a TCI codepoint indicated in the DCI and the TCI states activated via the MAC-CE, and there may be two TCI states activated via the MAC-CE, which correspond to the TCI codepoint.

The configuration may be independent for each cell or each BWP. For example, while a maximum number of activated TCI states corresponding to one TCI codepoint is 2 in the PCell, a maximum number of activated TCI states corresponding to one TCI codepoint may be 1 in a specific SCell. In this case, it may be considered that NC-JT may be configured in the PCell but NC-JT may not be configured in the SCell.

### [Power Headroom Reporting (PHR)]

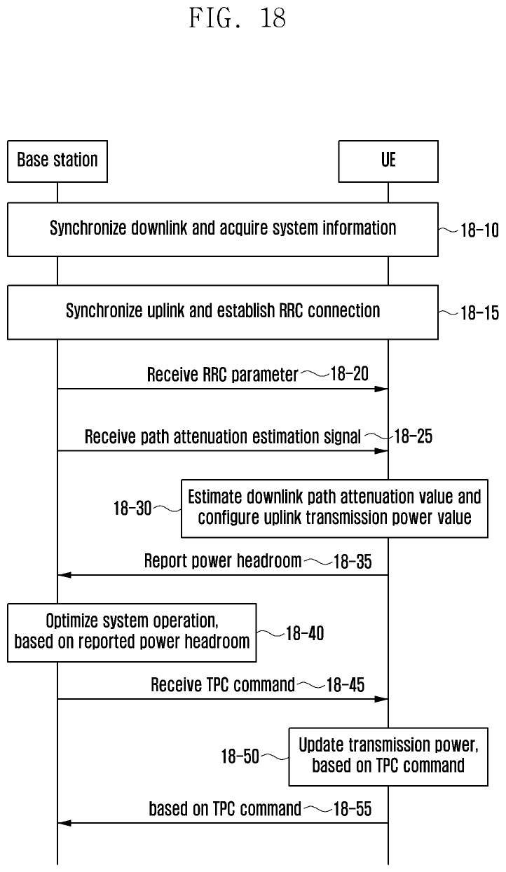

FIG. 18 illustrates a procedure in which a base station controls transmission power of a UE according to an embodiment of the disclosure.

Referring to FIG. 18, in operation 18-10, a UE in coverage of a base station may perform DL synchronization with the base station, and acquire SI. According to some embodiments, DL synchronization may be performed using a PSS/SSS received from the base station. UEs having performed DL synchronization may receive an MIB and an SIB from the base station, and acquire SI. In operation 18-15, via a random-access procedure, the UE may perform UL synchronization with the base station and establish an RRC connection. In the random-access procedure, the UE may transmit a random-access preamble and message3 (msg3) to the base station via an UL. In this case, when the random-access preamble and message3 are transmitted, UL TPC may be performed. Specifically, the UE may receive parameters for the UL TPC from the base station via the acquired SI, for example, the SIB, or may perform the UL TPC using a predetermined parameter. In another embodiment of the disclosure, the UE may measure RSRP from a path attenuation estimation signal transmitted by the base station, and may estimate a DL path attenuation value as shown in Equation 7. In addition, based on the estimated path attenuation value, the UE may configure an UL transmission power value for transmitting the random-access preamble and message3.

DL path attenuation=transmission power of a base station signal−RSRP measured by the UE [Equation 7]

In Equation 7, the transmission power of the base station signal refers to transmission power of a DL path attenuation estimation signal transmitted by the base station. The DL path attenuation estimation signal transmitted by the base station may be a CRS or an SS block (SSB). If the path attenuation estimation signal is a CRS, the transmission power of the base station signal may indicate transmission power of the CRS, and may be transmitted to the UE via a referenceSignalPower parameter of the SI. If the path attenuation estimation signal is an SSB, the transmission power of the base station signal may indicate transmission power of an SSS and of a DMRS that is transmitted via a PBCH, and may be transmitted to the UE via an ss-PBCH-BlockPower parameter of the SI.

In operation 18-20, the UE may receive, from the base station, RRC parameters for the UL TPC via UE-specific RRC or common RRC. In this case, the received TPC parameters may be different from each other according to an UL channel type and a signal type. That is, TPC parameters to be applied to transmission of a PUCCH, a PUSCH, and an SRS may be different from each other.

In addition, as described above, a TPC parameter received by the UE from the base station via the SIB before RRC connection establishment or TPC parameters that the UE has used as predetermined values before the RRC connection establishment may be included in the RRC parameters transmitted from the base station after the RRC connection establishment. The UE may use an RRC parameter value, which is received from the base station after the RRC connection establishment, to control UL transmission power.

In operation 18-25, the UE may receive a path attenuation estimation signal from the base station. More specifically, after the RRC connection establishment of the UE, the base station may configure a CSI-RS as the path attenuation estimation signal for the UE. In this case, the base station may transmit information on transmission power of the CSI-RS to the UE via a powerControlOffsetSS parameter of UE-dedicated RRC information. Here, powerControlOffsetSS may indicate a transmission power difference (offset) between the SSB and the CSI-RS. In operation 18-30, the UE may estimate the DL path attenuation value and configure the UL transmission power value. More specifically, the UE may measure a DL RSRP by using the CSI-RS, and may estimate the DL path attenuation value via Equation 7 by using the information on transmission power of the CSI-RS received from the base station. In addition, based on the estimated DL path attenuation value, the UE may configure the UL transmission power value for PUCCH, PUSCH, and SRS transmission.

In operation 18-35, the UE may perform PHR to the base station. A power headroom may indicate a difference between current transmission power of the UE and maximum output power of the UE.

In operation 18-40, the UE may optimize system operation, based on the reported power headroom. For example, if a power headroom value reported to the base station by a specific UE is a positive value, the base station may allocate more RBs to the UE, thereby increasing a system yield. In operation 18-45, the UE may receive, from the base station, a TPC command. If a power headroom value reported to the base station by a specific UE is a negative value, the base station may allocate fewer resources to the UE or may decrease transmission power of the UE via the TPC command. Accordingly, the system throughput may be increased, or unnecessary power consumption of the UE may be decreased.

In operation 18-50, the UE may update transmission power, based on the TPC command. In this case, the TPC command may be transmitted to the UE via UE-specific DCI or group common DCI. Therefore, the base station may dynamically control transmission power of the UE via the TPC command.

In operation 18-55, the UE may perform UL transmission based on the updated transmission power.

### [PUSCH Power Control]

A PUSCH transmission power may be determined through the following [Equation 8].

$${P}_{PUSCH} ( i , j , {q}_{d} , l ) = min \{ \begin{matrix}{P}_{CMAX , f , c} ( i ) , \\ {P}_{{0}_{PUSCH} , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} [ dBm ] \qquad [ Equation 8 ]$$

In [Equation 8], P_{CMAX, f, c} (i) denotes a maximum transmission power configured for a UE for carrier f of serving cell c at PUSCH transmission time point i. P_{0PUSCH, b, f, c} (j) denotes a reference configuration transmission power configuration value according to an activated UL BWP b of the carrier f of the serving cell c, and has different values according to various transmission types j. Further, the values may be various according to a case in which PUSCH transmission is a message 3 PUSCH for random access, or a case in which a PUSCH is a CG PUSCH, or a scheduled PUSCH.

$${M}_{RB , b , f , c}^{PUSCH} ( i )$$

denotes the size of a frequency to which a PUSCH is allocated. α_{b, f, c}(j) denotes a compensation ratio value for path loss of UL BWP b of the carrier f of the serving cell c, and may be configured by a higher-layer signal and may have different values according to j. PL_{b, f, c}(q_{d}) denotes a DL path loss estimation value of the UL BWP b of the carrier f of the serving cell c, and uses a value measured through an RS in an activated DL BWP. The RS may be an SS/PBCH block or a CSI-RS.

As described above in [equation 7], DL path loss may be calculated. In another embodiment of the disclosure, PL_{b, f, c}(q_{d}) denotes a DL path attenuation value and corresponds to path attenuation calculated by the UE as shown in [Equation 7]. The UE calculates path attenuation, based on an RS resource associated with the SS/PBCH block or the CSI-RS depending on whether a higher-layer signal is configured. For the RS resource, one of multiple RS resource sets may be selected by a higher-layer signal or an L1 signal, and the UE calculates path attenuation with reference to the RS resource. Δ_{TF, b, f, c}(i) denotes a value determined by a MCS value of a PUSCH at the PUSCH transmission time point i of the UL BWP b of the carrier f of the serving cell c. f_{p, f, c}(i, l) denotes a power control adaptation value and may dynamically control a power value by a TPC command. In addition, it may be possible to determine a specific value by the following [Table 44].

```
TABLE 44
$- {Δ}_{TF , b , f , c} ( i ) = 10 {log}_{10} ( ( {2}^{BPRE \cdot {K}_{s}} - 1 ) \cdot {β}_{offset}^{PUSCH} )$
  for Kₛ = 1.25 and
  Δ_{TF,b,f.c}(i) = 0 for Kₛ = 0 where Kₛ is provided by deltaMCS for each UL
  BWP b of each carrier f and serving cell c. If the PUSCH transmission is
  over more than one layer [6, TS 38.214], Δ_{TF,b,f.c}(i) = 0. BPRE and
  ${β}_{offset}^{PUSCH} ,$
  for active UL BWP b of each carrier f and each serving cell c, are computed
  as below
  $- BPRE = {\sum }_{r = 0}^{C - 1} {K}_{r} / {N}_{RE}$
  for PUSCH with UL-SCH data and
  $BPRE = {Q}_{m} \cdot R / {β}_{offset}^{PUSCH}$
    for CSI transmission in a PUSCH without UL-SCH data,
    where
    - C is a number of transmitted code blocks, Kᵣ is a size for code block r,
      and N_{RE} is a number of REs determined as
      ${N}_{RE} = N \cdot {M}_{RB , b , f , c}^{PUSCH} ( i ) \cdot {\sum }_{j = 0}^{{N}_{symb , b , f , c}^{PUSCH} ( i ) - 1} {N}_{sc , data}^{RB} ( i , j ) ,$
      where N ≥ 1 is provided by
      numberOfSlotsTBoMS as described in [6, TS 38.214] and N = 1 if
      numberOfSlotsTBoMS is not provided,
      ${N}_{symb , b , f , c}^{PUSCH} ( i )$
      is a number of
      symbols for PUSCH transmission occasion i on active UL BWP b of
      carrier f of serving cell c,
      ${N}_{sc , data}^{RB} ( i , j )$
      is a number of subcarriers
      excluding DM-RS subcarriers and phase-tracking RS samples [4, TS
      38.211] in PUSCH symbol j and assuming no segmentation for a
      nominal repetition in case the PUSCH transmission is with repetition
      Type B,
      $0 \leq j < {N}_{symb , b , f , c}^{PUSCH} ( i ) ,$
      and c, Ky are defined in [5, TS 38.212]
      $- {β}_{offset}^{PUSCH} = 1$
      when the PUSCH includes UL-SCH data and
      ${β}_{offset}^{PUSCH} = {β}_{offset}^{CSI , 1} ,$
        as described in clause 9.3, when the PUSCH includes CSI and does
        not include UL-SCH data
      - Qₘ is the modulation order and R is the target code rate, as described in [6,
        TS 38.214], provided by the DCI format scheduling the PUSCH
        transmission that includes CSI and does not include UL-SCH data
```

The TPC command is divided into an accumulated mode and an absolute mode, and one of the two modes is determined by a higher-layer signal. In the accumulated mode, the currently determined power control adaptation value is accumulated on a value indicated by the TPC command and may increase or decrease according to the TPC command, and has the relation of f_{b, f, c}(i, l)=f_{b, f, c}(i−i₀, l)+Σδ_{PUSCH, b, f, c}. δ_{PUSCH, b, f, c} is a value indicated by the TPC command. In the absolute mode, a value is determined by the TPC command regardless of the currently determined power control adaptation value, and has the relation of f_{b, f, c}(i, l)=δ_{PUSCH, b, f, c}. [Table 45] below shows values which may be indicated by the TPC command.

TABLE 45

| | Accumulated | Absolute |
|---|---|---|
| | δ_{PUSCH, b, f, c} or | δ_{PUSCH, b, f, c} or |
| TPC Command Field | δ_{SRS, b, f, c} [dB] | δ_{SRS, b, f, c} [dB] |
| 0 | −1 | −4 |
| 1 | 0 | −1 |
| 2 | 1 | 1 |
| 3 | 3 | 4 |

### [PUCCH Power Control]

The following [Equation 9] is an equation of determining PUCCH transmission power.

$${M}_{RB , b , f , c}^{PUCCH} ( i ) \qquad [ Equation 9 ]$$

In [Equation 9], P₀_{_{PUCCH}}_{, b, f, c}(qᵤ) denotes a reference configuration transmission power configuration value, and has different values according to various transmission types qᵤ, and may be changed by a higher level signal such as an RRC or a MAC CE. When the value is changed by the MAC CE and a slot for transmitting HARQ-ACK is k for a PDSCH having received the MAC CE, the UE determines that the corresponding value is applied starting at a slot k+k_{offset}. k_{offset} may have different values according to SCS and have, for example, 3 ms.

$${M}_{RB , b , f , c}^{PUCCH} ( i )$$

is the size of a frequency resource area to which the PUCCH is allocated. PL_{b, f, c}(q_{d}) denotes a path attenuation estimation value of the UE and is calculated by the UE based on a specific RS among various CSI-RSs or SS/PBCHs according to whether a higher-layer signal is configured and according to the type thereof as shown in [Equation 7]. The same q_{d} is applied to repeatedly transmitted PUCCHs. The same qᵤ is applied to repeatedly transmitted PUCCHs.

### [HARQ-ACK: Type 1 (Semi-Static) Codebook]

In a situation in which a HARQ-ACK PUCCH that a UE may transmit within one slot is limited to one, if the UE receives a semi-static HARQ-ACK codebook higher configuration, the UE reports HARQ-ACK information for PDSCH reception or semi-persistent scheduling (SPS) PDSCH release within a HARQ-ACK codebook in a slot indicated by a value of a PDSCH-to-HARQ_feedback timing indicator in DCI format 1_0 or DCI format 1_1. The UE reports a value of a HARQ-ACK information bit within the HARQ-ACK codebook as NACK in a slot not indicated by a PDSCH-to-HARQ_feedback timing indicator field in DCI format 1_0 or DCI format 1_1. If the UE reports only HARQ-ACK information for one SPS PDSCH release or one PDSCH reception in MA,C cases for candidate PDSCH reception, and such reporting is scheduled by DCI format 1_0 including information indicating that a counter DACI field is 1 in a Pcell, the UE determines one HARQ-ACK codebook for the corresponding SPS PDSCH release or the corresponding PDSCH reception.

Other cases follow a HARQ-ACK codebook determination method according to the method described below.

Assuming that a set of PDSCH reception candidate cases in serving cell c is MA, c, MA, c may be obtained in the following [pseudo-code 1] steps.

### [Start of Pseudo-Code 1]

Step 1: j is initialized to 0 and MA, c is initialized to a null set. K, which is a HARQ-ACK transmission timing index, is initialized to 0.
Step 2: R is configured as a set of respective rows in a table including information on a slot to which a PDSCH is mapped, start symbol information, the number of symbols, or length information. If a mapping symbol available for a PDSCH, indicated by each value of R, is configured as a UL symbol according to DL and UL configurations configured in a higher layer, the corresponding row is deleted from R.
Step 3-1: The UE may receive one PDSCH for unicast in one slot, and one PDSCH is added to a set of MA, c if R is not a null set.
Step 3-2: If the UE may receive more than one PDSCH for unicast in one slot, the number of PDSCHs assignable to different symbols is counted in the calculated R and the corresponding number of PDSCHs is added to MA, c.
Step 4: k is increased by 1 to restart from step 2. [End of pseudo-code 1]

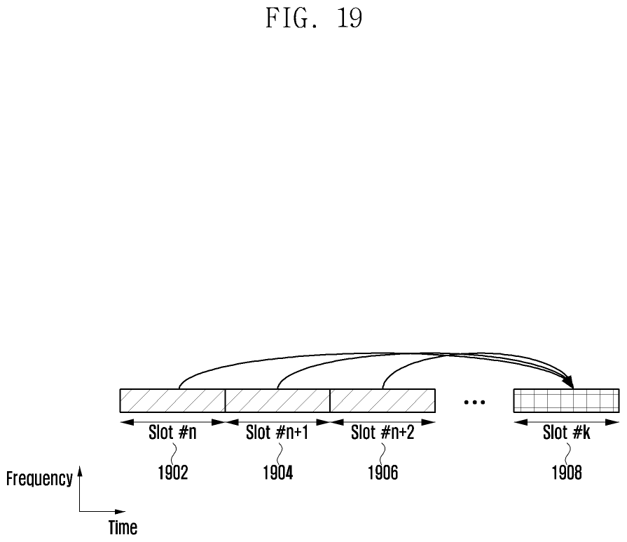

Taking the above-described pseudo-code 1 as an example in FIG. 19, in order to perform HARQ-ACK PUCCH transmission in slot #k 1908, all of slot candidates capable of PDSCH-to-HARQ-ACK timing which may indicate slot #k 1908 are considered. In FIG. 19, it is assumed that only PDSCHs scheduled in slot #n 1902, slot #n+1 1904, and slot #n+2 1906 enable HARQ-ACK transmission in slot #k 1908 through possible PDSCH-to-HARQ-ACK timing combinations. In addition, the maximum number of schedulable PDSCHs for each slot is derived in consideration of time domain resource configuration information of schedulable PDSCHs in the slots 1902, 1904, and 1906, respectively, and information indicating whether a symbol within each slot is a DL or an UL. For example, if a maximum of two PDSCHs can be scheduled in the slot 1902, three in the slot 1904, and two in the slot 1906, the maximum number of PDSCHs included in a HARQ-ACK codebook transmitted from the slot 1908 is 7 in total. This is referred to as the cardinality of the HARQ-ACK codebook.

In a specific slot, step 3-2 is described through the following [Table 46] (default PDSCH TDRA A for normal CP).

TABLE 46

| Row | dmrs-TypeA- | PDSCH | | | | | |
|---|---|---|---|---|---|---|---|
| index | Position | mapping type | K₀ | S | L | Ending | Order |
| 1 | 2 | Type A | 0 | 2 | 12 | 13 | 1x |
| | 3 | Type A | 0 | 3 | 11 | 13 | 1x |
| 2 | 2 | Type A | 0 | 2 | 10 | 11 | 1x |
| | 3 | Type A | 0 | 3 | 9 | 11 | 1x |
| 3 | 2 | Type A | 0 | 2 | 9 | 10 | 1x |
| | 3 | Type A | 0 | 3 | 8 | 10 | 1x |
| 4 | 2 | Type A | 0 | 2 | 7 | 8 | 1x |
| | 3 | Type A | 0 | 3 | 6 | 8 | 1x |
| 5 | 2 | Type A | 0 | 2 | 5 | 6 | 1x |
| | 3 | Type A | 0 | 3 | 4 | 6 | 1x |
| 6 | 2 | Type B | 0 | 9 | 4 | 12 | 2x |
| | 3 | Type B | 0 | 10 | 4 | 13 | 3 |
| 7 | 2 | Type B | 0 | 4 | 4 | 7 | 1x |
| | 3 | Type B | 0 | 6 | 4 | 9 | 2 |
| 8 | 2, 3 | Type B | 0 | 5 | 7 | 11 | 1x |
| 9 | 2, 3 | Type B | 0 | 5 | 2 | 6 | 1x |
| 10 | 2, 3 | Type B | 0 | 9 | 2 | 10 | 2x |
| 11 | 2, 3 | Type B | 0 | 12 | 2 | 13 | 3x |
| 12 | 2, 3 | Type A | 0 | 1 | 13 | 13 | 1x |
| 13 | 2, 3 | Type A | 0 | 1 | 6 | 6 | 1x |
| 14 | 2, 3 | Type A | 0 | 2 | 4 | 5 | 1 |
| 15 | 2, 3 | Type B | 0 | 4 | 7 | 10 | 1x |
| 16 | 2, 3 | Type B | 0 | 8 | 4 | 11 | 2x |

Table 46 is a time resource allocation table in which a UE operates as a default before receiving time resource allocation through a separate RRC signal. For reference, in addition to separately indicating a row index value via RRC, a PDSCH time resource allocation value is determined by dmrs-TypeA-Position which is a UE-common RRC signal. In Table 46, an ending column and an order column are values added separately for the convenience of description, and may not actually exist. The ending column refers to an end symbol of the scheduled PDSCH, and the order column refers to a code position value positioned within a specific codebook in a semi-static HARQ-ACK codebook. The corresponding table is applied to time resource allocation applied in DCI format 1_0 in a common search area of the PDCCH.

The UE performs the following steps in order to determine the HARQ-ACK codebook by calculating the maximum number of non-overlapping PDSCHs within a specific slot.
Step 1: Search for a PDSCH allocation value which first ends in a slot among all rows in a PDSCH time resource allocation table. In Table 46, it may be noted that row index 14 ends first. This is indicated as 1 in the order column. Other row indexes which overlap with the corresponding row index 14 in at least one symbol are indicated as 1× in the order column.
Step 2: Search for a PDSCH allocation value which first ends among the remaining row indexes which are not indicated in the order column. In Table 46, the PDSCH allocation value corresponds to a row having a row index of 7 and a dmrs-TypeA-Position value of 3. Other row indexes which overlap with the corresponding order index in at least one symbol are indicated as 2× in the order column.
Step 3: Increase and express an order value by repeating step 2. For example, in [Table 46], search for a PDSCH allocation value which first ends among the row indexes which are not indicated in the order column. In Table 46, the PDSCH allocation value corresponds to a row having a row index of 6 and a dmrs-TypeA-Position value of 3. Other row indexes which overlap with the corresponding order index in at least one symbol are indicated as 3× in the order column.
Step 4: End the process when all row indexes are marked with an order. The size of the corresponding order is the maximum number of PDSCHs which can be scheduled in the corresponding slot without time overlapping. Scheduling without time overlapping means that different PDSCHs are scheduled by TDM.

In the order column of Table 46, a maximum value of order refers to a HARQ-ACK codebook size of the corresponding slot, and an order value refers to a HARQ-ACK codebook point at which a HARQ-ACK feedback bit for the corresponding scheduled PDSCH is located. For example, row index 16 in Table 46 means the second code position in a semi-static HARQ-ACK codebook having a size of 3. If a set of occasions for candidate PDSCH receptions in the serving cell c is MA, c, the UE transmitting a HARQ-ACK feedback may calculate MA, c through the [pseudo-code 1] or [pseudo-code 2] steps. MA, c may be used to determine the number of HARQ-ACK bits that the UE is required to transmit. Specifically, a HARQ-ACK codebook may be configured by using the cardinality of a MA, c set.

In another example, considerations for determining the semi-static HARQ-ACK codebook (or HARQ-ACK codebook type 1) may be as follows.
a) on a set of slot timing values K1 associated with the active UL BWP
   i) If the UE is configured to monitor PDCCH for DCI format 1_0 and is not configured to monitor PDCCH for DCI format 1_1 on serving cell c, K1 is provided by the slot timing values {1, 2, 3, 4, 5, 6, 7, 8} for DCI format 1_0
   ii) If the UE is configured to monitor PDCCH for DCI format 1_1 for serving cell c, K₁ is provided by dl-DataTolIL-ACK for DCI format 1_1
b) on a set of row indexes R of a table that is provided either by a first set of row indexes of a table that is provided by PDSCH-TimeDomainResourceAllocationList in PDSCH-ConfigCommon or by Default PDSCH TDRA A [6, TS 38.214], or by the union of the first set of row indexes and a second set of row indexes, if provided by PDSCH-TimeDomainResourceAllocationList in PDSCH-Config, associated with the active DL BWP and defining respective sets of slot offsets K₀, start and length indicators SLIV, and PDSCH mapping types for PDSCH reception as described in [6, TS 38.214]
c) on the ratio 2^{μ}^{_{DL}}^{*-μ}^{_{UL}} between the DL SCS configuration μ_{DL} and the UL SCS configuration μ_{UL} provided by subcarrierSpacing in BWP-DL and BWP-UL for the active DL BWP and the active UL BWP, respectively
d) if provided, on TDD-UL-DL-ConfigurationCommon and TDD-UL-DL-ConfigDedicated as described in Subclause 11.1.

In another example, a pseudo-code for determining the HARQ-ACK codebook may be as follows.

```
  [Start of pseudo-code 2]
  For the set of slot timing values K₁, the UE determines a set of M_{A,c} occasions for
candidate PDSCH receptions or SPS PDSCH releases according to the following pseudo-code.
A location in the Type-1 HARQ-ACK codebook for HARQ-ACK information corresponding
to a SPS PDSCH release is same as for a corresponding SPS PDSCH reception.
  Set j = O - index of occasion for candidate PDSCH reception or SPS PDSCH release
  Set B = Ø
  Set M_{A,c} = Ø
  Set c(K₁) to the cardinality of set K₁
  Set k =0 - index of slot timing values K_{1,k}, in descending order of the slot timing values,
in set K₁ for serving cell c
  While k<c(K₁)
        if mod(n_{U}−K_{1,k}+ 1, max(2 ^{μ}^{_{UL}}^{-μ}^{_{DL}}, 1)) = 0
    Set n _{D} = O - index of a DL slot within an UL slot
    while n _{D} < max(2 ^{μ}^{_{DL}}^{-μ}^{_{UL}}, 1)
      Set R to the set of rows
      Set c(R) to the cardinality of R
      Set r=0 - index of row in set R
      if slot n _{U} starts at a same time as or after a slot for an active DL
BWP change on serving cell c or an active UL BWP change on the PCell and slot
└ (n_{U}−K_{1,k})*2 ^{μ}^{_{DL}}^{-μ}^{_{UL}} ┘ +n _{D} is before the slot for the active DL BWP change on serving cell
c or the active UL BWP change on the PCell
        continue;
      else
        while r < c(R)
          if the UE is provided TDD-UL-DL-
ConfigurationCommon or TDD-UL-DL-ConfigDedicated and, for each slot from slot
└ (n _{U}−K_{1,k})*2 ^{μ}^{_{DL}}^{-μ}^{_{UL}} ┘ +n _{D}−N^{repeat}_{PDSCH}+1 to slot └ (n _{U}−K_{1,k})*2 ^{μ}^{_{DL}}^{-μ}^{_{UL}} ┘ +n _{D}, at least one symbol of
the PDSCH time resource derived by row r is configured as UL where K_{1,k} is the k-th slot
timing value in set K₁,
            R = R/r;
          end if
          r=r+1;
        end while
        if the UE does not indicate a capability to receive more than one
unicast PDSCH per slot and R ≠ Ø,
          M_{A,c} = M_{A,c} ∪ⱼ;
          j=j+1;
          The UE does not expect to receive SPS PDSCH release
and unicast PDSCH in a same slot;
        else
          Set c(R) to the cardinality of R
          Set m to the smallest last OFDM symbol index, as
determined by the SLIV, among all rows of R
          while R = Ø
            Set r=0
          while r < c(R)
            if S ≤ m for start OFDM symbol index S for
row r
              b _{r,k,n}_{_{D}} = J ; - index of occasion for
candidate PDSCH reception or SPS PDSCH release associated with row r
              R = R/r;
              B = B ∪ b _{r,k,n}_{_{D}};
              end if
            r=r+1;
            end while
            M_{A,c} = M_{A,c} ∪j
            j=j+1;
            Set m to the smallest last OFDM symbol index
among all rows of R;
            end while
          end if
        end if
        n _{D} = n _{D}+1;
      end while
    end if
    k=k+1;
  end while
  [End of pseudo-code 2]
```

In pseudo-code 2, a position of a HARQ-ACK codebook including HARQ-ACK information for DCI indicating DL SPS release is based on a position at which a DL SPS PDSCH is received. For example, when a start symbol of transmission of the DL SPS PDSCH is the fourth OFDM symbol based on the slot and the length thereof is 5 symbols, it is assumed that HARQ-ACK information including DL SPS release indicating the release of the corresponding SPS starts from the fourth OFDM symbol of the slot in which the DL SPS release is transmitted and a PDSCH having a length of 5 symbols is mapped and HARQ-ACK information corresponding thereto is determined through a PDSCH-to-HACK timing indicator and a PUSCH resource indicator included in control information indicating DL SPS release. In another example, when a start symbol of transmission of the DL SPS PDSCH is a fourth OFDM symbol based on the slot and the length thereof is 5 symbols, it is assumed that HARQ-ACK information including DL SPS release indicating the release of the corresponding SPS starts from the fourth OFDM symbol of the slot indicated by TDRA of DCI that is the DL SPS release and a PDSCH having a length of 5 symbols is mapped and HARQ-ACK information corresponding thereto is determined through a PDSCH-to-ACK timing indicator and a PUSCH resource indicator included in control information indicating DL SPS release.

### [HARQ-ACK: Type 2 (Dynamic) Codebook]

Based on a PDSCH-to-HARQ_feedback timing value for PUCCH transmission of HARQ-ACK information in slot n for PDSCH reception or SPS PDSCH release and K0 which is transmission slot position information of a PDSCH scheduled in DCI format 1_0 or 1_1, a UE transmits HARQ-ACK information transmitted in one PUCCH in the corresponding slot n. Specifically, in order to transmit the above-described HARQ-ACK information, the UE determines a HARQ-ACK codebook of a PUCCH transmitted in a slot determined by the PDSCH-to-HARQ_feedback timing and K0, based on a downlink assignment index (DAI) included in DCI indicating a PDSCH or SPS PDSCH release.

The DAI includes a counter DAI and a total DAI. The counter DAI is information informing of the position of HARQ-ACK information corresponding to the PDSCH scheduled in DCI format 1_0 or DCI format 1_1 within the HARQ-ACK codebook. Specifically, a value of the counter DAI within DCI format 1_0 or 1_1 indicates an accumulative value of PDSCH reception or SPS PDSCH release scheduled by DCI format 1_0 or 1_1 in a specific cell c. The accumulated value is configured based on a PDCCH MO in which the scheduled DCI exists and the serving cell.

The total DAI is a value informing the size of the HARQ-ACK codebook. Specifically, a value of the total DAI means the total number of PDSCHs or SPS PDSCH releases scheduled at and before a time point at which the DCI is scheduled. In addition, the total DAI is a parameter used when HARQ-ACK information in the serving cell c includes HARQ-ACK information for a PDSCH scheduled in another cell including the serving cell c in a CA situation. In other words, there is no total DAI parameter in a system operating with one cell.

FIG. illustrates a process of generating a Type-2 (dynamic) HARQ-ACK codebook by a terminal according to an embodiment.

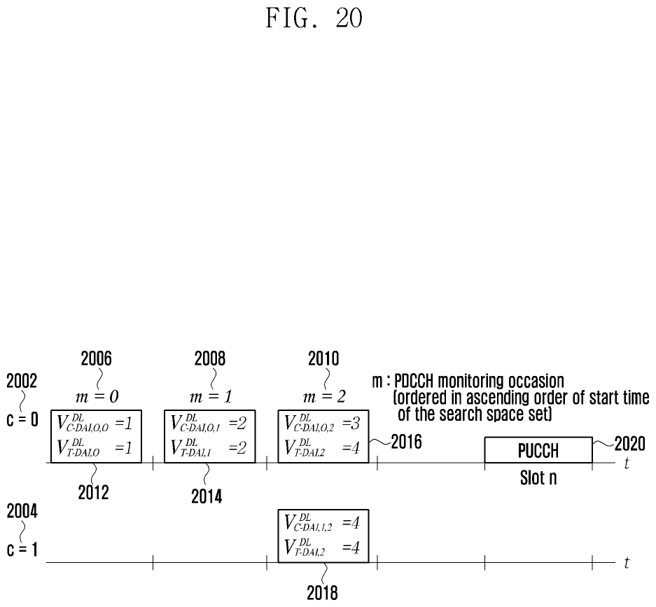

Referring to FIG. 20, in a situation where two carriers are configured for a UE, when the UE transmits a HARQ-ACK codebook selected based on a DAI, through a PUCCH 2020 in an n-th slot of carrier 0 2002, values of a counter DAI (C-DAI) and a total DAI (T-DAI) indicated by DCI retrieved in each PDCCH MO configured for each of the carriers are changed. First, in DCI retrieved in m=0 (2006), each of the C-DAI and the T-DAI indicates a value 2012 of 1. In DCI retrieved in m=1 (2008), each of the C-DAI and the T-DAI indicates a value 2014 of 2. In DCI retrieved in carrier 0 (c=0) 2002 of m=2 (2010), the C-DAI indicates a value 2016 of 3. In DCI retrieved in carrier 1 (c=1) 2004 of m=2 (2010), the C-DAI indicates a value 2018 of 4. In this case, when carriers 0 and 1 are scheduled in the same MO, all the T-DAIs are indicated as 4.

In FIGS. 19 and 20, HARQ-ACK codebook determination is operated in a situation in which only one PUCCH including HARQ-ACK information is transmitted in one slot. This is referred to as mode 1.

As an example of a method in which one PUCCH transmission resource is determined in one slot, when PDSCHs scheduled in different pieces of DCI are multiplexed into one HARQ-ACK codebook in the same slot, and the codebook is transmitted, a PUCCH resource selected for HARQ-ACK transmission is determined as a PUCCH resource indicated by a PUCCH resource field indicated in DCI for lastly scheduling a PDSCH. That is, a PUCCH resource indicated by a PUCCH resource field indicated in DCI scheduled before the DCI is neglected.

The following description defines HARQ-ACK codebook determination methods and devices in a situation in which two or more PUCCHs including HARQ-ACK information may be transmitted in one slot. This is referred to as mode 2.

A UE may be able to operate only in mode 1 (transmission of only one HARQ-ACK PUCCH in one slot) or operate only in mode 2 (transmission of one or more HARQ-ACK PUCCHs in one slot). Alternatively, in a case of a UE supporting both mode 1 and mode 2, it may be possible that a base station configures the UE to operate in only one mode by higher-layer signaling, or mode 1 and mode 2 are implicitly configured by a DCI format, an RNTI, a specific field value of DCI, and scrambling. For example, a PDSCH scheduled by DCI format A and pieces of HARQ-ACK information associated with the PDSCH are based on mode 1, and a PDSCH scheduled by DCI format B and pieces of HARQ-ACK information associated with the PDSCH are based on mode 2. Whether the above-described HARQ-ACK codebook is semi-static or dynamic is determined by an RRC signal.

### [Satellite Communication Structure]

In the following description, the characteristics of satellite communication is described. Satellites for communication may be classified into low Earth orbit (LEO) satellites, medium Earth orbit (MEO) satellites, and geostationary orbit (GEO) satellites according to their orbits. In general, a GEO satellite refers to a satellite at an altitude of about 36000 km, an MEO satellite refers to a satellite at an altitude of 5000 to 15000 km, and an LEO satellite refers to a satellite at an altitude of 500 to 1000 km. The disclosure is not limited to the above example. According to an embodiment of the disclosure, an orbital period around the Earth varies depending on each altitude, and an orbital period of the GEO satellite around the Earth is about 24 hours, an orbital period of the MEO satellite is about 6 hours, and an orbital period of the LEO satellite is about 90 minutes to 120 minutes. The low-orbit (˜2,000 km) satellite may have an advantage over the geostationary-orbit (36,000 km) satellite in propagation delay time (may be understood as the time it takes for a signal transmitted from a transmitter to reach a receiver) and loss due to its relatively low altitude.

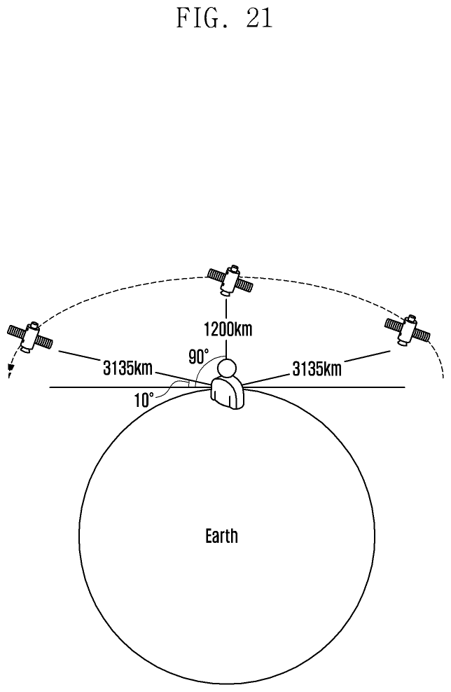

FIG. 21 illustrates an orbital period of a communication satellite around the Earth according to the altitude or height of the satellite according to an embodiment.

Referring to FIG. 21, assuming that a UE communicates with a satellite located at an altitude of 1,200 km, a distance between the UE and the satellite may vary depending on an elevation angle between the satellite and the UE. For example, when the elevation angle between the satellite and the UE is 90 degrees, the distance between the UE and the satellite is 1200 km, but when the elevation angle between the satellite and the UE is 10 degrees, the distance between the UE and the satellite is about 3135 km. Therefore, in satellite communication, even if the UE is fixed, the distance between the satellite and the UE may vary due to the periodic orbiting of a satellite such as a low-orbit satellite. In addition, in satellite communication, since the distance between the UE and the satellite is much greater than a distance between the UE and a base station in terrestrial networks, it may be necessary to transmit control information and data information in the manner of performing data transmission with a low code rate or repeated transmissions.

### [OCC-Based PUCCH Transmission]

Hereinafter, a PUCCH transmission method using an OCC of a UE is described. A PUCCH format (e.g., LTE PUCCH format 5) may be exemplified as one of signals or formats transmitted through a PUCCH, which is an UL control channel, and may be mainly used to deliver positive acknowledgment/negative acknowledgment (ACK/NACK) feedback for DL data transmission. For example, in PUCCH format 5, signals transmitted from different UEs may be distinguished (e.g., using an OFDMA scheme) by combining a frequency division multiple access (FDMA) scheme and a time division multiple access (TDMA) scheme, and the signals may be transmitted using a cyclic shift technique. To implement such a function, for example, in LTE PUCCH format 5, an OCC technique using orthogonality may be applied. OCC is used to distinguish signals transmitted from different UEs, and each UE may select an OCC sequence, based on a predefined OCC index, and transmit ACK/NACK bits by covering the bits with the corresponding sequence. According to an embodiment, PUCCH format 5 adopting OCC may enable efficient control channel transmission in a multiple access environment, thereby improving the overall performance of a communication system. The expression of the OCC index or OCC sequence is not limited to the above expression and may be represented using other terms that perform the same or similar functions.

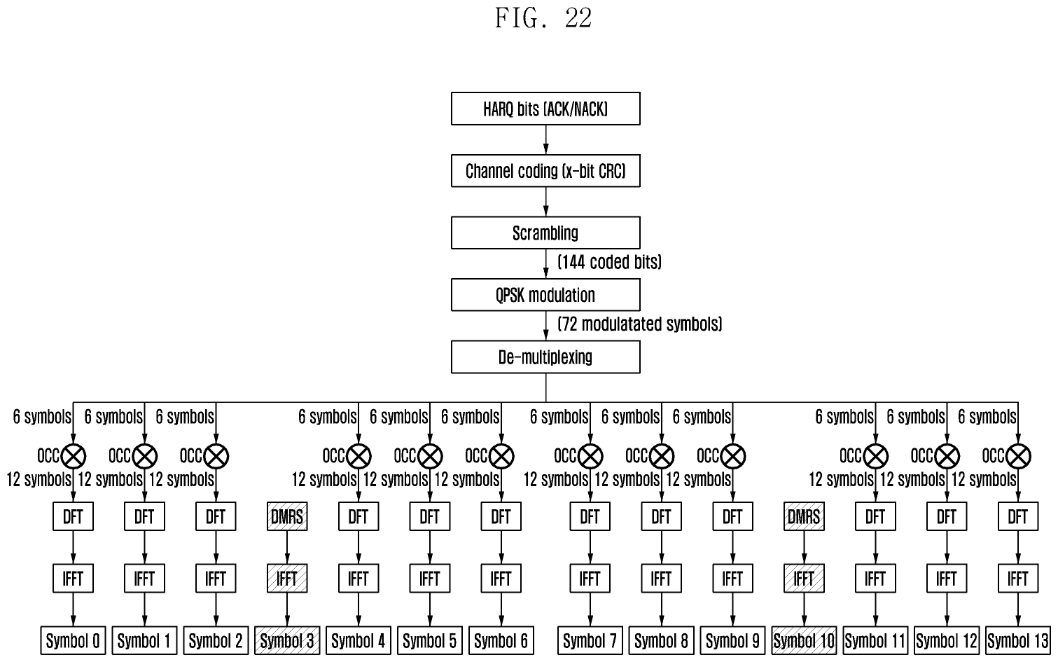

FIG. 22 is a block diagram illustrating a method for generating LTE PUCCH format 5 according to an embodiment.

The block diagram is not limited to PUCCH format 5 and may be exemplified as a method for generating a PUCCH format that performs a similar function. After generating HARQ ACK/NACK bits, a UE may generate coded bits through channel coding and scrambling processes. Then, through quadrature phase shift keying (QPSK) modulation and de-multiplexing processes, for example, 72 modulated symbols may be allocated across a total of 12 OFDM symbols. Subsequently, 6 modulated symbols allocated to each OFDM symbol may be mapped to 12 frequency tones through OCC-based spreading.

According to an embodiment, the expression “applying OCC” may be used as the expression “applying OCC spreading”, or may be used as the expression “applying OCC technique” or the expression “applying OCC scheme”, and these expressions may be used interchangeably in the disclosure. In addition, each of these expressions may be replaced with other similar expressions performing the same functions in embodiments of the disclosure.

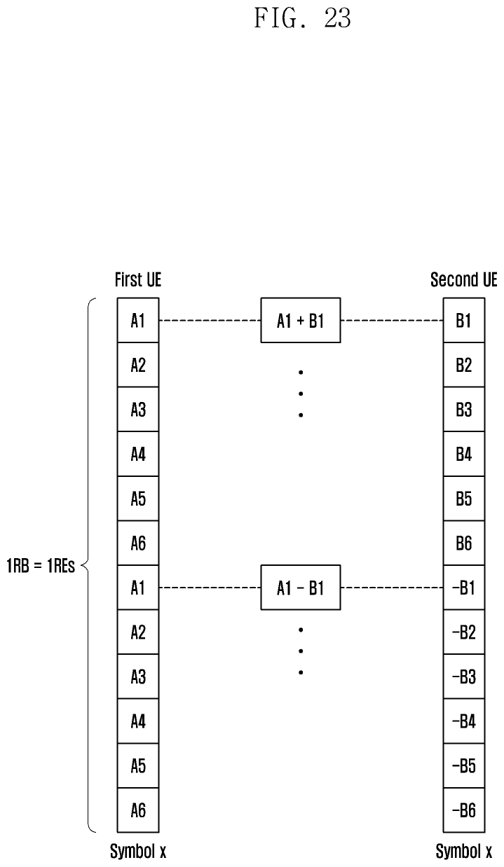

According to an embodiment, a spreading scheme may operate by mapping QPSK-modulated symbols to a larger number of virtual frequency tones. This enables signals from multiple users to avoid interfering with each other. For example, in a specific LTE PUCCH format, 12 QPSK-modulated symbols may be mapped to one SC-FDM symbol within one RB, but in LTE PUCCH format 5, which may be exemplified as shown in FIG. 22, 6 QPSK-modulated symbols may be mapped to one SC-FDM symbol within one RB. In addition, a code division multiplexing (CDM) index applicable in the spreading scheme is a value assigned to each user and may have a value of 0 or 1. This value may determine how each user's signal is to be spread. For example, a user with a CDM index of 0 may map their signal twice to 12 virtual frequency tones by duplication, while a user with a CDM index of 1 may also repeat their signal twice, but multiply half of the repeated signal by −1, and map the resulting signal to 12 virtual frequency tones. This allows each user's signal to be spread over a wider bandwidth, so that it may be possible to avoid interference with each other even in a multi-user environment. How interference can be avoided despite using the same time and frequency resources is further explained with reference to FIG. 23.

FIG. 23 illustrates a method in which different UEs perform mapping to virtual frequency tones by applying different OCC values according to an embodiment.

Referring to FIG. 23, a first UE may repeatedly map information A1, A2, A3, A4, A5, and A6 to one RB. A second UE may also repeatedly map information B1, B2, B3, B4, B5, and B6 to one RB, where half of the values are multiplied by 1 and mapped, and the other half are multiplied by −1 and mapped. After performing discrete Fourier transform (DFT) and inverse fast Fourier transform (IFFT), the first UE and the second UE may transmit their information. Upon receiving the information, the base station may perform a de-spreading process and, for example, may be able to decode A1 and B1 through values of “A1+B1” and “A1−B1”, respectively. In the same manner, the base station may be able to decode or identify the remaining information, that is, the information A2, A3, A4, A5, and A6 of the first UE and the information B2, B3, B4, B5, and B6 of the second UE, by using the method illustrated above.

Although FIGS. 22 and 23 illustrate the OCC spreading scheme in terms of the frequency axis as an example, it may be possible to apply the OCC spreading scheme in terms of the time axis. In addition, FIGS. 22 and 23 consider a method for applying OCC sequences of (1, 1) and (1, −1) to two different UEs based on an OCC length of 2, but it may be possible to consider a sequence having an OCC length greater than 2, and in this case, two or more different UEs may be able to transmit PUCCHs by using the same time and frequency resources.

### [OCC-Based PUSCH Transmission]

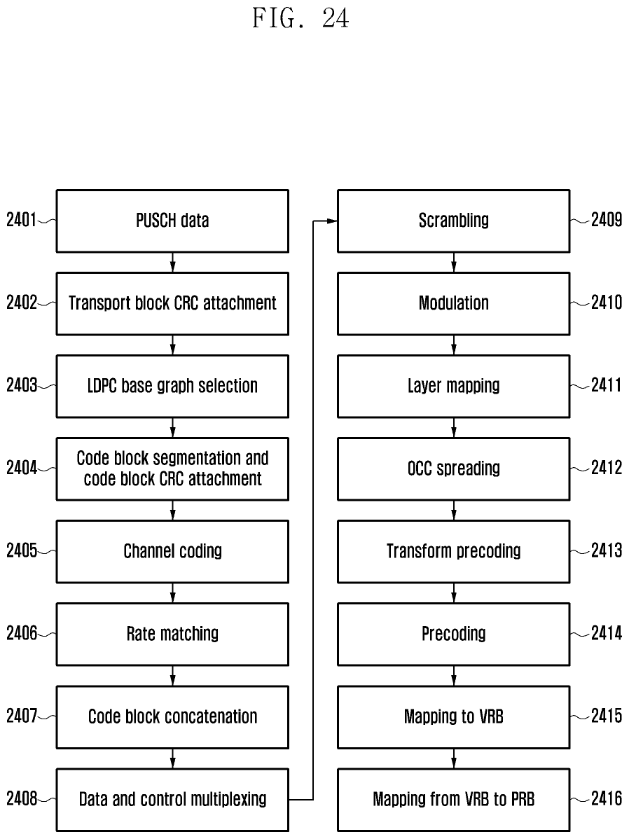

FIG. 24 is a flowchart illustrating a UE processing procedure for PUSCH transmission according to an embodiment of the disclosure.

Referring to FIG. 24, when a UE has data to transmit to a base station, the UE may perform processing for PUSCH transmission through a series of the following procedures. (Step 2401) The following procedures are merely examples, and some of the following procedures may be omitted or the UE may apply the procedures in a different order.

Data block CRC attachment (TB CRC attachment): An error check code is attached to data. (Step 2402)

LDPC base graph selection: An appropriate LDPC graph is selected for channel coding. (Step 2403)

Code block segmentation and CRC attachment: The data may be divided into smaller blocks, and a CRC may be attached to each block. (Step 2404)

Channel coding: A block is encoded to prevent transmission errors. (Step 2405)

Rate matching: The encoded data is mapped to available transmission resources. (Step 2406)

Code block concatenation: The encoded blocks are re-concatenated. (Step 2407)

Data and control multiplexing: When there is a control resource overlapping with a data resource, the corresponding control information is multiplexed with data information. (Step 2408)

Scrambling: The data is scrambled to prevent a predictable pattern that may degrade signal quality. (Step 2409)

Modulation: The scrambled data is modulated onto a carrier. (Step 2410) Layer mapping: The data is mapped across transmission layers. (Step 2411)

OCC spreading: OCC is applied to the data mapped to the layers. This is applicable to the example related to FIG. 23 or to other schemes. (Step 2412)

Transform precoding: Through DFT, a frequency-domain signal is reconstructed into a time-domain signal. This step is particularly used in scenarios with a single transmission layer, and may be used to improve signal orthogonality and reduce interference. (Step 2413)

Precoding: A spatial processing step that adjusts the transformed signal before transmission to optimize performance. This may include applying a matrix to the signal to enhance the directionality of the signal and improve reception at a receiver, and may take into account various antenna configurations and channel conditions. (Step 2414)

Mapping to a VRB: The data is mapped to a VRB in the frequency domain. (Step 2415)

Mapping from a VRB to a PRB: The VRB is then mapped to a PRB for actual transmission. (Step 2416)

Among the above procedures, the OCC spreading scheme may be applied in various ways.

According to an embodiment, when the UE repeatedly transmits a PUSCH in each slot, it may be possible to apply an OCC sequence for each slot.

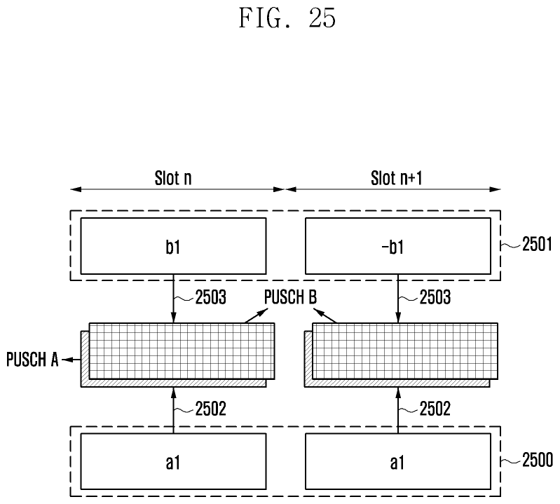

FIG. 25 illustrates a method for applying an OCC scheme when a UE repeatedly transmits a PUSCH for each slot according to an embodiment.

Referring to FIG. 25, in a situation where an OCC length is 2, two different UEs may respectively perform repeated transmission of a PUSCH through the same time and frequency resources. That is, this may correspond to a case where a first UE transmits PUSCH A and a second UE transmits PUSCH B. The first UE may generate the same data a1 (2500) and perform repeated transmissions of the data in slot n and slot n+1 (2502). The second UE may map data b1 to slot n and map −b1, which is obtained by multiplying b1 by −1, to slot n+1 (2501). The second UE may transmit b1 through PUSCH B in slot n and transmit-b1 through PUSCH B in slot n+1 (2503), and the first UE may transmit a1 through PUSCH A in each of slot n and slot n+1 (2502).

Although FIG. 25 illustrates that PUSCH A and PUSCH B, which are transmitted in slot n and slot n+1, are transmitted by the first UE and the second UE through the same time and frequency resources, it may also be possible that only some of the time and frequency resources overlap and the remaining time and frequency resources are used differently.

In addition, in FIG. 25, reference numerals 2500 and 2501 denote conceptual diagrams illustrating that the first UE and the second UE transmit data through a PUSCH, rather than indicating that the respective data is generated in slot n and slot n+1, and in practice, the data may be generated before slot n where PUSCH transmission begins.

In FIG. 25, a base station receives information a1+b1 through PUSCH A and PUSCH B transmitted by the first UE and the second UE in slot n, and receives information a1−b1 through PUSCH A and PUSCH B transmitted by the first UE and the second UE in slot n+1, and thus the base station may be able to receive or identify a1 and b1, respectively, through an OCC de-spreading scheme based on the received a1+b1 and a1-b1. Here, a1 and b1 may represent a set of symbols in which a series of data is channel-coded and modulated. Alternatively, a1 and b1 may represent a set of data before DFT, and are not limited to any specific data form or format.

In order to apply an OCC scheme as illustrated in FIG. 25, the base station may indicate, in advance, to the UEs through a higher-layer signal (higher layer signaling (e.g., an RRC message)) or an L1 signal (e.g., DCI), an OCC sequence value to be applied for each slot, during repeated PUSCH transmissions. For example, in the case of the second UE, when a DCI field, which may be exemplified as an OCC index, exists in an L1 signal and the corresponding value indicates a bit value corresponding to an OCC sequence of (1, −1), the second UE may be able to apply “1” in slot n and apply “−1” in slot n+1. Specifically, for example, a DCI field, which may be exemplified as an OCC index, may exist as 1 bit, and if a bit of the field is 0, an OCC sequence may indicate (1, 1), and if the bit is 1, the OCC sequence may indicate (1,−1) or (−1, 1). In addition, the type of the OCC sequence or the size of the DCI field may be determined by higher-layer signaling configuration. According to an embodiment, the length of the OCC sequence may be a value greater than the length of 2 described in the example above.

Each UE may transmit, to the base station, information related to the UE's capability to apply an OCC spreading method associated with an embodiment of the disclosure. In FIG. 25, the first UE is described as applying an OCC sequence of (1, 1), but regardless of this, the first UE may be able to perform conventional repeated PUSCH transmissions without applying an OCC sequence. Therefore, in FIG. 25, it may be possible that the first UE transmits or does not transmit the UE's capability to apply the OCC spreading method. On the other hand, the second UE may be able to apply the OCC spreading method only when the UE has transmitted the UE's capability to apply the OCC spreading method.

Although FIG. 25 exemplifies a case in which the first UE and the second UE apply two repeated transmissions, the number of repeated transmission slots may be 4, 8, or more, and there is no limitation on the number of slots or the number of repeated transmissions. For example, assuming that the OCC sequence of (1, −1) applied by the second UE is repeated four times, it may be possible to apply b1 in slot n, −b1 in slot n+1, b1 in slot n+2, and −b1 in slot n+3, or alternatively, b1 in slot n, b1 in slot n+1, −b1 in slot n+2, and −b1 in slot n+3.

Alternatively, it may be possible that an OCC sequence of 1 (or −1) is always applied in even-numbered slots, and an OCC sequence of −1 (or 1) is always applied in odd-numbered slots. Alternatively, an OCC sequence may be applied based on a modular operation. Since the OCC sequence of (1, −1) has a length of 2, it may be possible to apply 1 (or −1) as an OCC sequence value applied to a PUSCH within an n-th slot if the value of mod (n/2) is 1, and to apply −1 (or 1) if the value of mod (n/2) is 0.

In addition, although FIG. 25 illustrates that the first UE and the second UE start the same number of repeated transmissions from the same slot, it may be applicable even in a case where the UEs start repeated transmissions from different slots or perform different numbers of repeated transmissions.

In order for the UE to determine whether to perform OCC-based PUSCH transmission, the base station may provide relevant information to the UE through a higher-layer signal, an L1 signal, or a combination thereof. The UE may determine whether an OCC sequence is applied to a PUSCH transmitted by the UE through reception of the corresponding information. In addition, specific OCC sequence information may be provided to the UE through a higher-layer signal or an L1 signal, and the UE may be able to determine an OCC sequence size or an OCC sequence type through the provided information. Alternatively, the base station may implicitly indicate to the UE whether OCC-based PUSCH transmission is performed, through other information, and likewise, may implicitly indicate OCC sequence information or an OCC sequence size or type.

When the UE performs repeated PUSCH transmissions within one slot, it may be possible to apply an OCC sequence for each PUSCH transmission unit that is repeatedly transmitted.

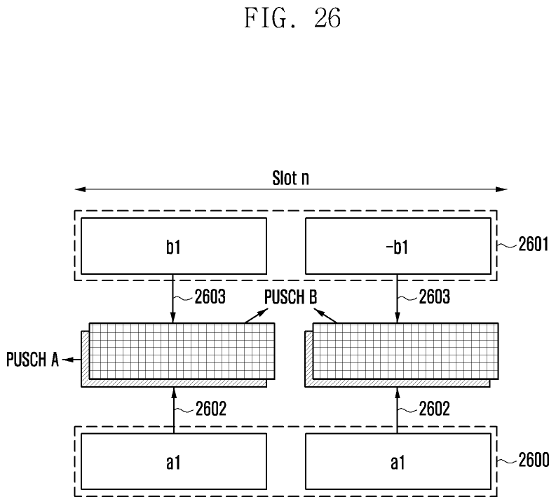

FIG. 26 illustrates a method for applying an OCC scheme when a UE repeatedly transmits a PUSCH within one slot according to an embodiment.

Referring to FIG. 26, in a situation where an OCC length is 2, two different UEs may respectively perform repeated transmission of a PUSCH through the same time and frequency resources. That is, this may correspond to a case where a first UE transmits PUSCH A and a second UE transmits PUSCH B. The first UE may generate the same data a1 (2600) and perform repeated transmissions of the data in one slot n (2602). The second UE may map data b1 to the first PUSCH B in slot n and map −b1, which is obtained by multiplying b1 by −1, to the second PUSCH B in slot n (2601). The second UE may transmit b1 through the first PUSCH B in slot n and transmit −b1 through the second PUSCH B in slot n (2603), and the first UE may transmit a1 through each PUSCH A in slot n (2602).

Although FIG. 26 illustrates that PUSCH A and PUSCH B, which are transmitted in slot n, are transmitted by the first UE and the second UE through the same time and frequency resources, it may also be possible that only some of the time and frequency resources overlap and the remaining time and frequency resources are used differently.

In addition, in FIG. 26, reference numerals 2600 and 2601 denote conceptual diagrams illustrating that the first UE and the second UE transmit data through a PUSCH, rather than indicating that the respective data is generated in slot n, and in practice, the data may be generated before slot n where PUSCH transmission begins.

In FIG. 26, a base station receives information a1+b1 through the first PUSCH A and PUSCH B transmitted by the first UE and the second UE in slot n, and receives information a1−b1 through the second PUSCH A and PUSCH B transmitted by the first UE and the second UE in slot n, and thus the base station may be able to receive or identify a1 and b1, respectively, through an OCC de-spreading scheme based on the received a1+b1 and a1−b1. Here, a1 and b1 may represent a set of symbols in which a series of data is channel-coded and modulated. Alternatively, a1 and b1 may represent a set of data before DFT, and are not limited to any specific data form or format.

In order to apply an OCC scheme as illustrated in FIG. 26, the base station may indicate, in advance, to the UEs through a higher-layer signal or an L1 signal, an OCC sequence value to be applied for each PUSCH transmission interval, during repeated PUSCH transmissions. For example, in the case of the second UE, when a DCI field, which may be exemplified as an OCC index, exists in an L1 signal and the corresponding value indicates a bit value corresponding to an OCC sequence of (1, −1), the second UE may be able to apply “1” to the first PUSCH and apply “−1” to the second PUSCH. Specifically, for example, a DCI field, which may be exemplified as an OCC index, may exist as 1 bit, and if a bit of the field is 0, an OCC sequence may indicate (1, 1), and if the bit is 1, the OCC sequence may indicate (1,−1) or (−1, 1). In addition, the type of the OCC sequence or the size of the DCI field may be determined by higher-layer signaling configuration. According to an embodiment, the length of the OCC sequence may be a value greater than the length of 2 described in the example above.

Each UE may transmit, to the base station, information related to the UE's capability to apply an OCC spreading method associated with an embodiment of the disclosure. In FIG. 26, the first UE is described as applying an OCC sequence of (1, 1), but regardless of this, the first UE may be able to perform conventional repeated PUSCH transmissions without applying an OCC sequence. Therefore, in FIG. 26, it may be possible that the first UE transmits or does not transmit the UE's capability to apply the OCC spreading method. On the other hand, the second UE may be able to apply the OCC spreading method only when the UE has transmitted the UE's capability to apply the OCC spreading method.

Although FIG. 26 exemplifies a case in which the first UE and the second UE apply two repeated transmissions, the number of repeated transmission slots may be 4, 8, or more, and there is no limitation on the number of slots or the number of repeated transmissions.

In addition, it may be possible that the repeated PUSCH transmissions occur across multiple slots rather than within one slot. In this case, assuming that the OCC sequence of (1, −1) applied by the second UE is repeated four times, it may be possible to apply b1 to the first PUSCH, −b1 to the second PUSCH, b1 to the third PUSCH, and −b1 to the fourth PUSCH, or alternatively, b1 to the first PUSCH, b1 to the second PUSCH, −b1 to the third PUSCH, and −b1 to the fourth PUSCH.

Alternatively, it may be possible that an OCC sequence of 1 (or −1) is always applied to even-numbered PUSCH transmissions, and an OCC sequence of −1 (or 1) is always applied to odd-numbered PUSCH transmissions.

Alternatively, an OCC sequence may be applied based on a modular operation. Since the OCC sequence of (1, −1) has a length of 2, it may be possible to apply 1 (or −1) as an OCC sequence value applied to an n-th PUSCH if the value of mod (n/2) is 1, and to apply −1 (or 1) if the value of mod (n/2) is 0.

In addition, although FIG. 26 illustrates that the first UE and the second UE start the same number of repeated transmissions from the same slot, it may be applicable even in a case where the UEs start repeated transmissions from different slots or perform different numbers of repeated transmissions.

According to an embodiment, it may be possible to apply an OCC sequence between pieces of information belonging to different time resources within one PUSCH.

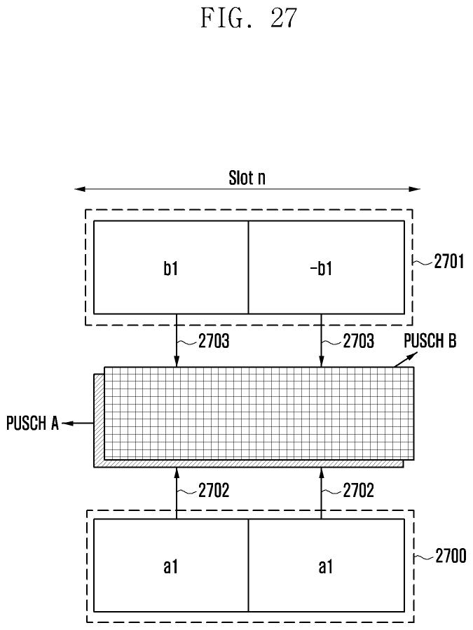

FIG. 27 illustrates a method for applying an OCC scheme in terms of time resources when a UE transmits a PUSCH according to an embodiment.

Referring to FIG. 27, when a first UE and a second UE apply an OCC scheme with a length of 2 in terms of time resources, it may be possible to determine an actual TB size (TBS) value by dividing the size of a PUSCH resource allocated to the corresponding UE by 2 during TBS calculation. In addition, FIG. 27 may exemplify a case where the first UE and the second UE perform repeated transmissions within the same slot.

Alternatively, it may also be possible to consider the actual size of a PUSCH transmission resource region when calculating a TBS. The size of the PUSCH transmission resource region may be determined by a frequency resource size (the number of RBs) and a time resource size (the number of symbols). Thereafter, the UEs may perform data transmission preparation according to the procedure described in FIG. 24.

Also, in an OCC spreading step, as illustrated in FIG. 27, the first UE may sequentially arrange two identical pieces of data a1 in terms of time resources and apply an OCC sequence of (1, 1) to the first a1 and the second a1, respectively (2700). The first UE may transmit the data in a PUSCH A resource region allocated by a base station (2702). The second UE may also sequentially arrange two identical pieces of data b1 in terms of time resources and apply an OCC sequence of (1, −1) to the first b1 and the second b1, respectively (2701). The second UE may transmit the data in a PUSCH B resource region allocated by the base station (2703).

Although FIG. 27 illustrates an example in which data to which OCC is applied is divided into two parts in terms of time resources, it may be possible to divide the data into three, four, or more parts for application. When the same data is mapped into four parts, the first UE may generate (a1, a1, a1, a1), and the second UE may generate (b1, −b1, b1, −b1) or (b1, b1, −b1, −b1).

In addition, although the OCC spreading and de-spreading scheme has been described in terms of the frequency axis in FIG. 23, it is fully possible to convert and apply the scheme in terms of the time axis, and the scheme may be the same or partially similar.

Although FIG. 27 illustrates that PUSCH A and PUSCH B, which are transmitted in slot n, are transmitted by the first UE and the second UE through the same time and frequency resources, it may also be possible that only some of the time and/or frequency resources overlap and the remaining time and frequency resources are used differently.

In addition, in FIG. 27, reference numerals 2700 and 2701 denote conceptual diagrams illustrating that the first UE and the second UE transmit data through a PUSCH, rather than indicating that the respective data is generated in slot n, and in practice, the data may be generated before slot n where PUSCH transmission begins.

In FIG. 27, the base station receives information a1+b1 and a1−b1 through PUSCH A and PUSCH B transmitted by the first UE and the second UE in slot n, and thus the base station may be able to receive or identify a1 and b1, respectively, through an OCC de-spreading scheme based on the received a1+b1 and a1−b1. Here, a1 and b1 may represent a set of symbols in which a series of data is channel-coded and modulated. Alternatively, a1 and b1 may represent a set of data before DFT, and are not limited to any specific data form or format.

In order to apply an OCC scheme as illustrated in FIG. 27, the base station may indicate, in advance, to the UEs through a higher-layer signal or an L1 signal, an OCC sequence value to be applied, during repeated PUSCH transmissions. For example, in the case of the second UE, when a DCI field, which may be exemplified as an OCC index, exists in an L1 signal and the corresponding value indicates a bit value corresponding to an OCC sequence of (1, −1), the second UE may be able to apply “1” to the first portion of a PUSCH and apply “−1” to the second portion. Specifically, a DCI field, which may be exemplified as an OCC index, may exist as 1 bit, and if a bit of the field is 0, an OCC sequence may indicate (1, 1), and if the bit is 1, the OCC sequence may indicate (1,−1) or (−1, 1). In addition, the type of the OCC sequence or the size of the DCI field may be determined by higher-layer signaling configuration. According to an embodiment, the length of the OCC sequence may be a value greater than the length of 2 described in the example above.

Each UE may transmit, to the base station, information related to the UE's capability to apply an OCC spreading method associated with an embodiment of the disclosure. In FIG. 27, it may be possible that the first UE and the second UE transmit or do not transmit the UE's capability to apply the OCC spreading method.

Although FIG. 27 illustrates an example where one PUSCH is transmitted, the disclosure is not limited thereto, and it may be possible that the repeated PUSCH transmissions occur across multiple slots. In addition, although FIG. 27 illustrates that the first UE and the second UE start PUSCH transmission from the same slot, it may be applicable even in a case where the UEs start PUSCH transmission from different slots or perform different numbers of repeated transmissions.

According to an embodiment, it may be possible to apply an OCC sequence between pieces of information belonging to different frequency resources within one PUSCH.

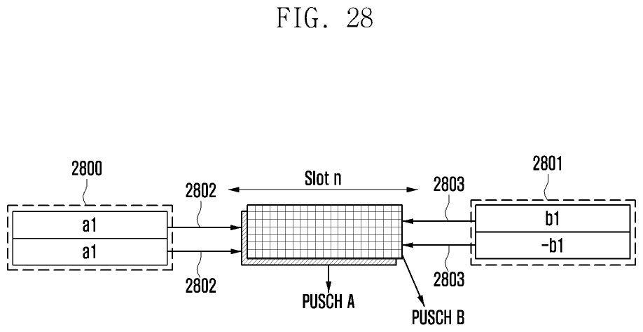

FIG. 28 illustrates a method for applying an OCC scheme in terms of frequency resources when a UE transmits a PUSCH according to an embodiment.

Referring to FIG. 28, when a first UE and a second UE apply an OCC scheme with a length of 2 in terms of frequency resources, it may be possible to determine an actual TBS value by dividing the size of a PUSCH resource allocated to the corresponding UE by 2 during TBS calculation.

Alternatively, it may also be possible to consider the actual size of a PUSCH transmission resource region when calculating a TBS. The size of the PUSCH transmission resource region may be determined by a frequency resource size (the number of RBs) and a time resource size (the number of symbols). Thereafter, the UEs may perform data transmission preparation according to the procedure described in FIG. 24.

Also, in an OCC spreading step, as illustrated in FIG. 28, the first UE may sequentially arrange two identical pieces of data a1 in terms of frequency resources and apply an OCC sequence of (1, 1) to the first a1 and the second a1, respectively (2800). The first UE may transmit the data in a PUSCH A resource region allocated by a base station (2802). The second UE may also sequentially arrange two identical pieces of data b1 in terms of frequency resources and apply an OCC sequence of (1, −1) to the first b1 and the second b1, respectively (2801). The second UE may transmit the data in a PUSCH B resource region allocated by the base station (2803).

Although FIG. 28 illustrates an example in which data to which OCC is applied is divided into two parts in terms of frequency resources, it may be possible to divide the data into three, four, or more parts for application. When the same data is mapped into four parts, the first UE may generate (a1, a1, a1, a1), and the second UE may generate (b1, −b1, b1, −b1) or (b1, b1, −b1, −b1).

In addition, the OCC spreading and de-spreading scheme may be the same as or partially similar to that described in FIG. 23.

Although FIG. 28 illustrates that PUSCH A and PUSCH B, which are transmitted in slot n, are transmitted by the first UE and the second UE through the same time and frequency resources, it may also be possible that only some of the time and/or frequency resources overlap and the remaining time and frequency resources are used differently.

In addition, in FIG. 28, reference numerals 2800 and 2801 denote conceptual diagrams illustrating that the first UE and the second UE transmit data through a PUSCH, rather than indicating that the respective data is generated in slot n, and in practice, the data may be generated before slot n where PUSCH transmission begins.

In FIG. 28, the base station receives information a1+b1 and a1−b1 through PUSCH A and PUSCH B transmitted by the first UE and the second UE in slot n, and thus the base station may be able to receive or identify a1 and b1, respectively, through an OCC de-spreading scheme based on the received a1+b1 and a1−b1. Here, a1 and b1 may represent a set of symbols in which a series of data is channel-coded and modulated. Alternatively, a1 and b1 may represent a set of data before DFT, and are not limited to any specific data form or format.

In order to apply an OCC scheme as illustrated in FIG. 28, the base station may indicate, in advance, to the UEs through a higher-layer signal or an L1 signal, an OCC sequence value to be applied, during repeated PUSCH transmissions. For example, in the case of the second UE, when a DCI field, which may be exemplified as an OCC index, exists in an L1 signal and the corresponding value indicates a bit value corresponding to an OCC sequence of (1, −1), the second UE may be able to apply “1” to the first portion of a PUSCH and apply “−1” to the second portion. Specifically, a DCI field, which may be exemplified as an OCC index, may exist as 1 bit, and if a bit of the field is 0, an OCC sequence may indicate (1, 1), and if the bit is 1, the OCC sequence may indicate (1,−1) or (−1, 1).

In addition, the type of the OCC sequence or the size of the DCI field may be determined by higher-layer signaling configuration. According to an embodiment, the length of the OCC sequence may be a value greater than the length of 2 described in the example above.

Each UE may transmit, to the base station, information related to the UE's capability to apply an OCC spreading method associated with an embodiment of the disclosure. In FIG. 28, it may be possible that the first UE and the second UE transmit or do not transmit the UE's capability to apply the OCC spreading method.

Although FIG. 28 illustrates an example where one PUSCH is transmitted, the disclosure is not limited thereto, and it may be possible that the repeated PUSCH transmissions occur across multiple slots. In addition, although FIG. 28 illustrates that the first UE and the second UE start PUSCH transmission from the same slot, it may be applicable even in a case where the UEs start PUSCH transmission from different slots or perform different numbers of repeated transmissions.

The following description illustrates a scenario in which OCC-based PUSCH transmission is applied in satellite communication. The methods described below may be sufficiently applicable to terrestrial networks.

Satellite communication may be largely divided into three components: a UE, a ground station (base station), and a satellite, and a link between the UE and the satellite is referred to as a service link or a user link, and a link between the ground station and the satellite is referred to as a feeder link. In a service link, a DL is usually a satellite→UE link, and an UL is a UE→satellite link. Although this is similar in terrestrial networks, in satellite communication, an UL coverage may be insufficient since a transmission power of the UE may be significantly lower than a transmission power of the satellite, and, to this end, the UE may perform repeated transmissions for UL data transmission. If all UEs within satellite coverage perform repeated transmissions of the same data through the UL, the satellite network may face a shortage of available frequency and time resources. To solve this, it may be necessary to support a larger number of UEs by using a code resource in addition to frequency and time resources. Therefore, it may be possible to consider transmitting UL data by using an OCC scheme according to an embodiment of the disclosure.

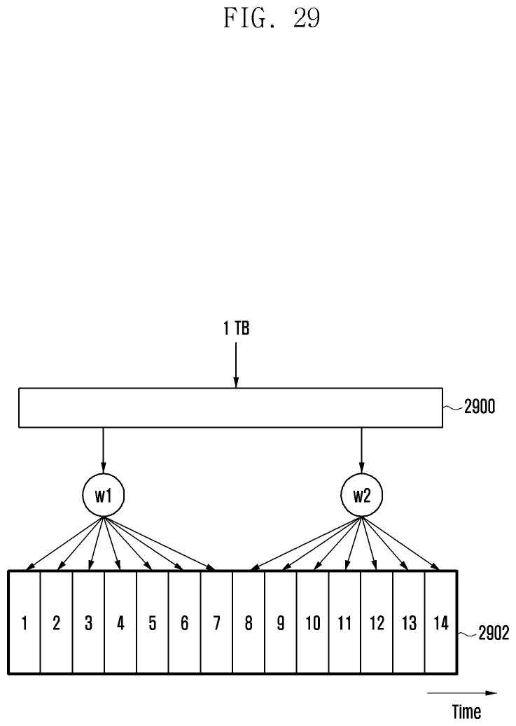

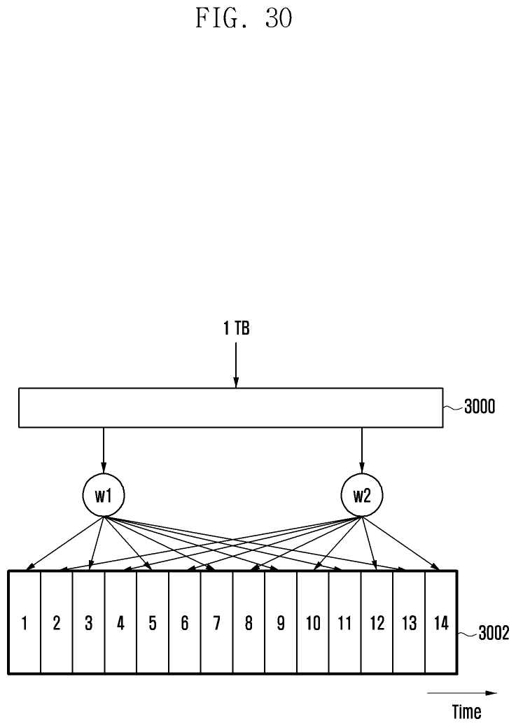

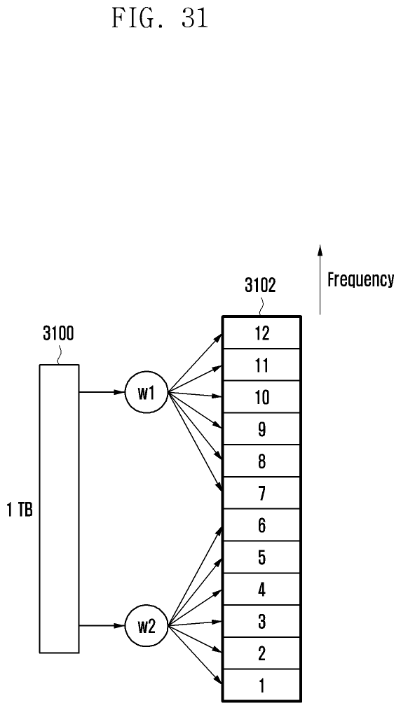

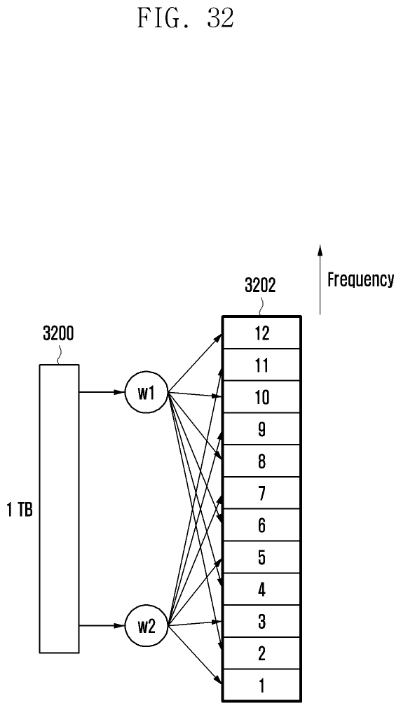

FIGS. 29 to 32 illustrate a process in which one TB is mapped to a radio resource by applying an OCC technique. FIGS. 29 and 30 illustrate an example in which an OCC technique is applied in terms of symbol levels and mapped to a radio resource, and FIGS. 31 and 32 illustrate an example in which an OCC technique is applied in terms of RE levels or RB levels and mapped to a radio resource.

FIGS. 29 and 30 illustrate a method for applying an OCC technique in terms of time resources when a UE transmits a PUSCH according to an embodiment, and FIGS. 31 and 32 illustrate a method for applying an OCC technique in terms of frequency resources when a UE transmits a PUSCH.

FIGS. 29 to 32 illustrate an example in which an OCC length is 2, and w1 and w2 may represent OCC codes (or OCC sequences) and have values of (1 1) or (1−1).

Referring to FIGS. 29 to 32, reference numerals 2900, 3000, 3100, and 3200 may represent modulated information or transform-precoded information after one TB undergoes a series of transmission processing processes as illustrated in FIG. 24. The specific form of the information of each of reference numerals 2900, 3000, 3100, and 3200 may vary depending on all or a part of the processing processes described in FIG. 24. As illustrated in FIGS. 29 to 32, this information may be classified into two copies, each of which may be multiplied by w1 and w2, and then mapped in terms of time resources or frequency resources. Reference numerals 2902, 3002, 3102, and 3202 may represent one PUSCH resource.

According to an embodiment, examples of the OCC code may include a Walsh sequence, a binary sequence, or a DFT sequence.

According to an embodiment, time resources and frequency resources may be factors for determining the TBS size described above, and thus a TBS may be determined in consideration of whether OCC spreading is performed in terms of time resources or in terms of frequency resources.

### [TBoMS Transmission]

The following description illustrates TBoMS. Various methods may exist to reduce a code rate of data (or TB) transmitted by a UE in order to extend UL coverage of the UE. For example, a lower MCS value may be selected for data to be transmitted by the UE, or the data may be repeatedly transmitted. Since the UE generally has an UL transmission power limit, a method of reducing a code rate of transmission data through repeated transmissions may be considered. When data is transmitted repeatedly, different RV values may be selected so that both systematic bits and parity bits generated through channel coding are transmitted, thereby improving channel coding performance. However, since a starting point of a circular buffer selected by an RV value is fixed, there may be a case where some pieces of bit information are not transmitted even when repeated transmissions are performed.

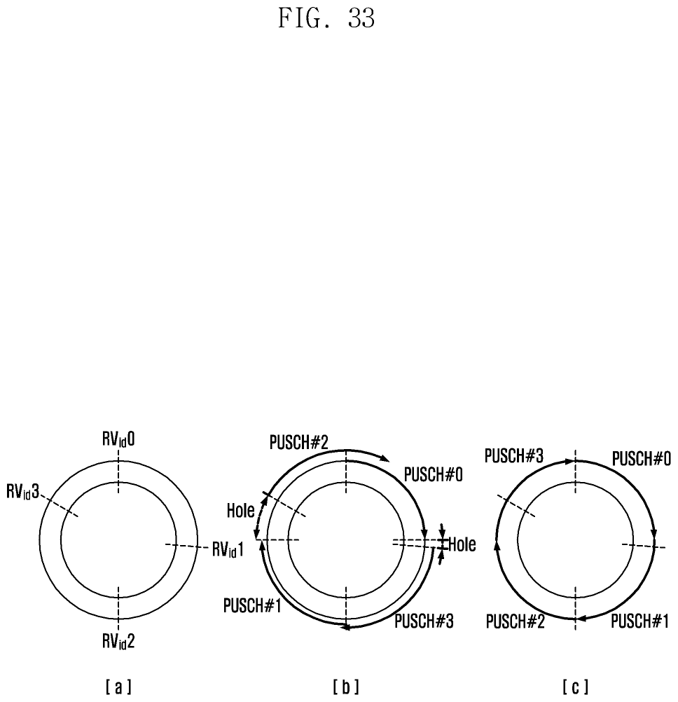

FIG. 33 illustrates a bit selection procedure according to an RV value according to an embodiment.

Referring to FIG. 33, case (a) illustrates a starting position in a circular buffer according to different RV values. Case (b) illustrates a bit stream selected for each RV starting position in a circular buffer when the same data is repeatedly transmitted four times.

As illustrated in case (b), even when the same data is repeatedly transmitted four times, a bit stream (a hole in case (b)) that is not transmitted may exist within the circular buffer. Therefore, according to an embodiment, to solve this problem, it may be possible to consider TBoMS in which one data is divided and transmitted through four PUSCHs as illustrated in case (c), without relying on an RV. Accordingly, the UE may be able to transmit all bit streams within the circular buffer. Therefore, by improving channel decoding performance, a coverage enhancement effect can be achieved.

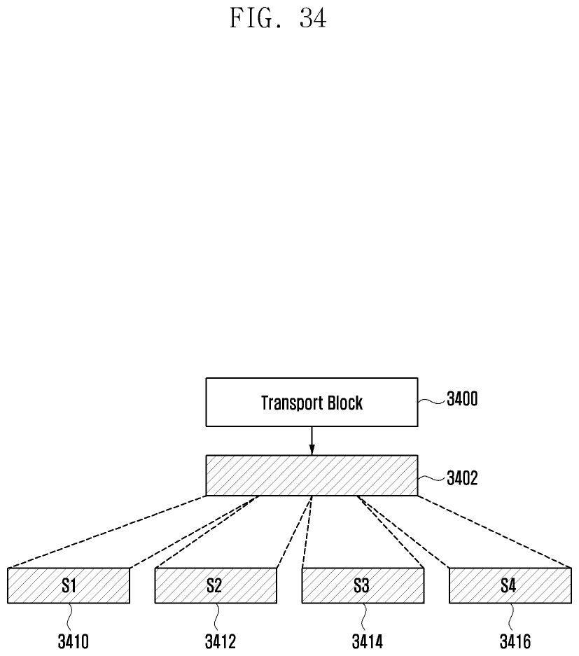

FIG. 34 illustrates a process in which a TBoMS scheme is mapped to a transmission resource according to an embodiment.

Referring to FIG. 34, a UE may generate a TB 3400 to transmit data received from a higher layer to a physical layer, and may perform all or a part of procedures such as channel coding and rate matching, e.g., as described above in FIG. 24. The channel-coded bit streams 3402 generated through a series of procedures may be mapped across multiple slots. Although FIG. 34 illustrates a case where one TB is mapped to a total of 4 slots 3410, 3412, 3414, and 3416, but is not limited to a specific number of slots. The respective slots may be consecutive or partially non-consecutive slots. In this case, the UE may additionally consider the number of slots to which TBoMS is applied in order to calculate a TB size. For example, the TB size is determined by the number of REs to which a TB is allocated, a code rate, a modulation order, and the number of layers. When a TBoMS scheme is applied, the number of slots to which TBoMS is applied may also be additionally considered when determining the number of REs to which the TB is allocated.

According to an embodiment, it may be possible to perform repeated transmissions of the corresponding TB in a situation where the TBoMS scheme is applied. When the number of slots to which the TBoMS scheme is applied is N and the number of repeated transmissions of the TB is k, the UE may perform transmission by using a total of N·k slots.

According to an embodiment, a resource mapping scheme may be in the form of mapping encoded TB information across N slots to which the TBoMS scheme is applied, and then repeating the mapping k times.

In a situation where TBoMS is not applied, inter-slot level OCC applies different OCC spreading for each UE in the same time and frequency resources as illustrated in FIG. 25, and a base station may receive or identify data transmitted by different UEs through OCC de-spreading. In addition, this may be exemplified as a method in which a PUSCH is transmitted for each slot. For example, when an OCC sequence length is 2, at least 2 slots may be required to perform inter-slot level OCC, and when the OCC sequence length is 4, at least 4 slots may be required to perform inter-slot level OCC. If repeated transmission is applied separately from an OCC method, a UE may be able to apply the same or different RV values for each repeated transmission. If an RV version is applied differently according to the order of repeated transmissions, the UE is required to apply OCC spreading to only bit information determined by the same RV value when applying OCC spreading. For example, when OCC spreading is applied to a PUSCH indicated by RV1 and a PUSCH indicated by RV2, both PUSCHs may correspond to channel-coded information based on the same TB, but, since the order of arranging bit streams in a circular buffer for rate matching may differ, when OCC spreading is applied and the PUSCHs are transmitted overlapping with other UEs to the base station, it may be impossible for the base station to derive the rate-matched information through OCC de-spreading.

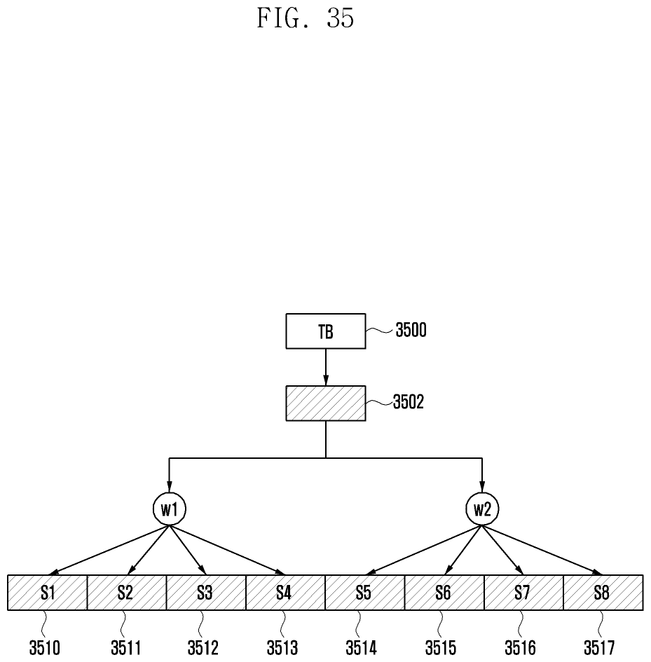

FIG. 35 illustrates a slot-level OCC application method according to an embodiment.

Referring to FIG. 35, when RV values are applied in the order of “0→2→3→1→0→ . . . ” according to the order of repeated transmissions, it may be possible to apply OCC spreading. For a TB 3500, OCC w1 may be applied to information generated through performing all or a part of procedures such as channel coding and rate matching, as described above with reference to FIG. 24, for the first four consecutive slots, and OCC w2 may be applied for the following four consecutive slots. The UE may perform repeated transmissions across a total of 8 slots, where RV0 is applied to PUSCHs transmitted in slot 1 3510 and slot 5 3514, RV2 is applied to PUSCHs in slot 2 3511 and slot 6 3515, RV3 is applied to PUSCHs in slot 3 3512 and slot 7 3516, and RV1 is applied to PUSCHs in slot 4 3513 and slot 8 3517. Therefore, a base station may be able to apply OCC de-spreading to the PUSCH received in slot 1 3510 and the PUSCH received in slot 5 3514 and use them for decoding.

Similarly, the base station may be able to apply OCC de-spreading to the PUSCH received in slot 2 3511 and the PUSCH received in slot 6 3515 and use them for decoding, may be able to apply OCC de-spreading to the PUSCH received in slot 3 3512 and the PUSCH received in slot 7 3516 and use them for decoding, and may be able to apply OCC de-spreading to the PUSCH received in slot 4 3513 and the PUSCH received in slot 8 3517 and use them for decoding.

In the manner illustrated in FIG. 35, when repeated transmissions are performed in a situation where OCC is applied, the number of repeated transmissions may be determined based on the number of OCC sequences (m) and the total number of RVs (k). For example, when the total number of available RVs is 4 and the number of OCC sequences is 2, the UE may be required to perform at least 8 repeated transmissions. To this end, when the UE receives scheduling of PUSCH transmission through DCI and determines that OCC is applied, based on a separate higher-layer signal or L1 signal or a combination thereof, the UE may be able to determine the number of repeated transmissions in consideration of the number of OCCs and whether an RV version is applied.

Alternatively, it may be possible to determine whether an RV version is applied, based on repeated transmission-related information separate from OCC. For example, when the number of repeated transmissions is 3 in a situation where an OCC sequence length of 2 is applied, the UE may be able to determine that the same RV value is applied rather than cycling through RV values.

Alternatively, it may be possible to perform cycling using only a limited number of RV values, for example, in the order of “0→2→3→0→2→3→ . . . ”. In addition, PUSCHs included in each slot illustrated in FIG. 35 may all have the same time (i.e., a start symbol and a symbol length) and frequency resources within the respective slots, or at least one of the resources may be the same. For example, when the number of available RVs is 4 and the number of OCC sequences is 4, the UE is required to perform at least 16 repeated transmissions. In addition, there may be limitations in applying “0→2→3→0→2→ . . . ”, which is a scheme that excludes an RV value of 1. Since the difference between slots to which OCC de-spreading is applied may correspond to at least 3 slots, it may be difficult to maintain orthogonality due to channel variations, which may lead to performance degradation. Therefore, it may be necessary to improve orthogonality by minimizing an interval between slots to which different OCC values are applied.

According to an embodiment, repeated transmissions and inter-slot level OCC may be applied in a situation where TBoMS is applied.

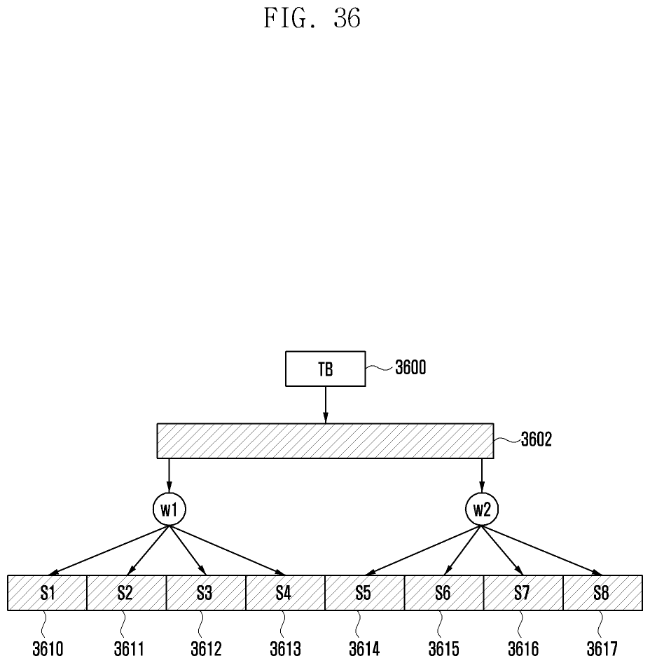

FIG. 36 illustrates a method for applying OCC by a UE in a situation where TBoMS and repeated transmissions are applied, according to an embodiment.

Referring to FIG. 36, a difference from FIG. 35 may be that, when a UE maps a TB to a PUSCH, one TB is mapped to PUSCHs included in 4 different slots according to FIG. 34. In addition, FIG. 36 may assume that the number of slots for which TBoMS is configured is 4, and the number of repeated transmissions is 2. That is, one TB is included in each of the PUSCHs in the 4 slots and transmitted, and since the transmission is repeated twice, a total of 8 slots may be required. In this case, when the transmission is repeated twice, RV values applied to the PUSCHs may be different if OCC is not applied, but, if OCC is applied, the same RV value needs to be applied. This is because the number of repeated transmissions with the same RV value may need to match the number of OCC sequences. Therefore, the UE may map information generated after demodulation and decoding of a TB 3600 (e.g., rate-matched value 3602) to 4 slots to which TBoMS is applied. In this case, it may be possible to apply OCC value w1 when mapping to the first 4 slots 3610, 3611, 3612, and 3613, and then apply OCC value w2 when mapping to the following 4 slots 3614, 3615, 3616, and 3617. Therefore, the UE may map and transmit UL data across the slots 3610, 3611, 3612, and 3613, and similarly map the UL data again across the slots 3614, 3615, 3616, and 3617. To this end, the UE may determine the total number of repeated transmission slots by considering the number of slots to which TBoMS is applied, the number of repeated transmissions, and the number of times OCC is applied (i.e., an OCC length or a sequence length).

Alternatively, the number of repeated transmissions may be determined by considering the number of slots to which TBoMS is applied and the number of times OCC is applied. For example, as illustrated in FIG. 36, it is assumed that a total of 8 repeated transmissions are performed by considering that the number of slots to which TBoMS is applied is 4 and the number of times OCC is applied is 2.

In addition, when TBoMS and OCC are applied together, it may be possible to always use an RV value as a fixed value regardless of subsequent repeated transmissions. For example, when TBoMS and OCC are applied together, it may be possible to always consider an RV value as 0. Therefore, the base station may be able to apply OCC de-spreading to PUSCHs received through the slot 3610 and the slot 3614.

Likewise, it may be possible to apply OCC de-spreading to PUSCHs received through the slot 3611 and the slot 3615, to apply OCC de-spreading to PUSCHs received through the slot 3612 and the slot 3616, and to apply OCC de-spreading to PUSCHs received through the slot 3613 and the slot 3617.

According to an embodiment, the greater the time difference between slots to which OCC de-spreading is applied, the more difficult it may be to ensure orthogonality, which may potentially lead to performance degradation. Therefore, it may be necessary to improve orthogonality by minimizing an interval between slots to which different OCC values are applied.

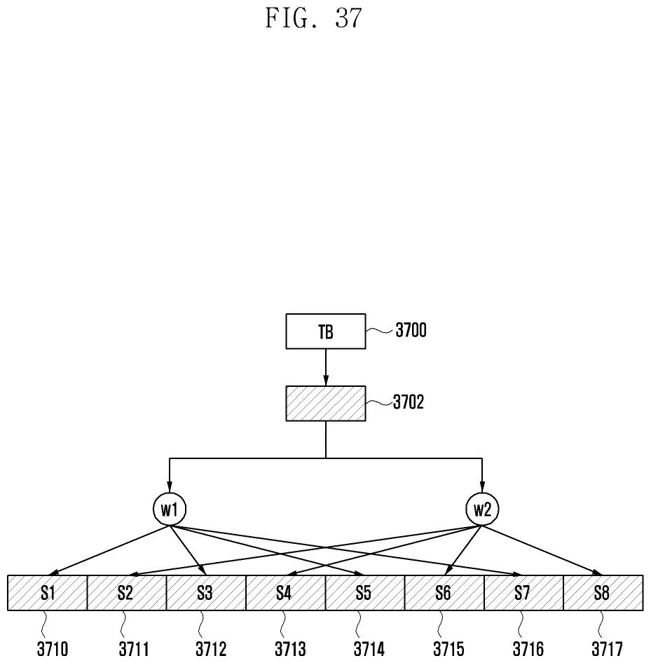

FIG. 37 illustrates a method for applying OCC during repeated PUSCH transmissions according to an embodiment.

Referring to FIG. 37, compared to FIG. 35, a difference may correspond to a slot position where OCC spreading information is applied and an RV version application scheme.

In FIG. 37, slots to which OCC spreading information is applied are illustrated in FIG. 37, where w1 is applied to slots 3710, 3712, 3714, and 3716, and w2 is applied to slots 3711, 3713, 3715, and 3717.

The application of w1 or w2 to a specific slot may mean that a specific OCC value w1 or w2 is applied to symbols immediately before mapping into the respective slots, and OCC spreading is applied using the corresponding OCC value. In addition, RV values may also be cyclically applied for each slot group to which OCC spreading is applied, rather than for each slot, depending on an OCC sequence length. For example, in FIG. 37, the slot groups to which OCC spreading is applied are {3710, 3711}, {3712, 3713}, {3714, 3715}, and {3716, 3717}, and the length of the applied OCC sequence in this case is 2. Therefore, the same RV value may be applied to slots within each slot group, and RV values may be cyclically applied for each slot group. For example, it may be possible to apply an RV value of 0 to slot group {3710, 3711}, an RV value of 2 to slot group {3712, 3713}, an RV value of 3 to slot group {3714, 3715}, and an RV value of 1 to slot group {3716, 3717}.

According to an embodiment, applying a specific RV value to a slot group may mean applying the corresponding RV value when transmitting a PUSCH scheduled in a slot included in the slot group. In this manner, a base station may perform OCC de-spreading between adjacent slot groups, thereby ensuring orthogonality and thus improving reception performance.

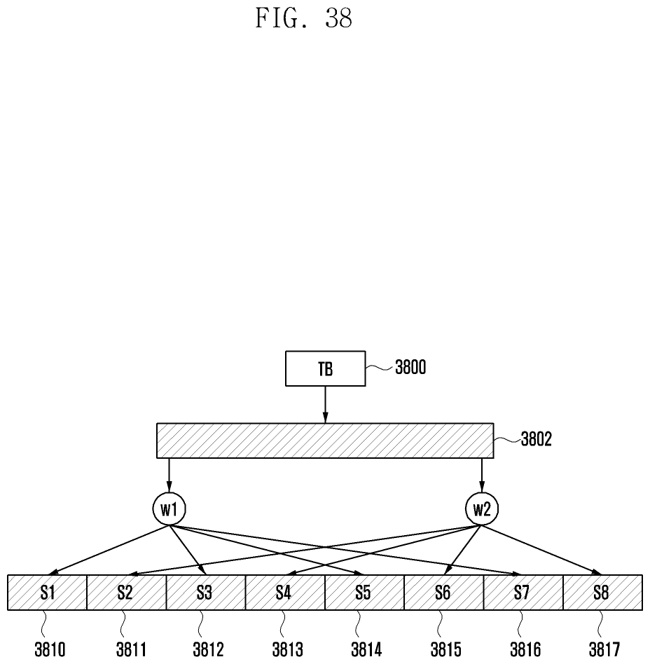

FIG. 38 illustrates a method for applying TBoMS and OCC during repeated PUSCH transmissions according to an embodiment.

Referring to FIG. 38, similarly to FIG. 36, the number of slots to which TBoMS is applied is 4, the number of TB repeated transmissions is 2, and an OCC sequence length is 2. In FIG. 36, the slots to which one TB is mapped according to TBoMS are consecutive, while FIG. 38 illustrates a case where mapping is non-consecutive. That is, the total of 4 slots to which TBoMS is applied for the first TB transmission are slots 3810, 3812, 3814, and 3816, and the total of 4 slots to which TBoMS is applied for the second TB transmission are slots 3811, 3813, 3815, and 3817.

An RV value of a PUSCH allocated for each TB transmission may be the same. For example, a UE may apply OCC value w1 to the first TB transmission and map it to the slots 3810, 3812, 3814, and 3816 by using a TBoMS scheme, and apply OCC value w2 to the second TB transmission and map it to the slots 3811, 3813, 3815, and 3817 by using the TBoMS scheme. Therefore, in this manner, the UE may perform OCC spreading by considering the number of slots to which TBoMS is applied and the number of repeated transmissions.

According to an embodiment, the number of repeated transmissions may be determined according to the number of slots to which TBoMS is applied and the OCC sequence length. In addition, slot group units to which OCC de-spreading is applied may correspond to {3810, 3811}, {3812, 3813}, {3814, 3815}, and {3816, 3817}, respectively. Therefore, since the time difference between slots in a slot group to which OCC de-spreading is applied may be small, it may be possible to effectively maintain orthogonality, and thus improve reception performance.

In a situation where TBoMS is applied as illustrated in FIG. 38, the UE may be able to determine a slot to which a corresponding TB is to be mapped by considering whether OCC is applied. For example, when OCC is not applied, the UE may determine N·K consecutive slots for TBoMS. Here, N denotes the number of slots to which TBoMS is applied, and may be determined by a higher-layer signal, an L1 signal, or a combination thereof. K denotes the number of times one TB is repeatedly transmitted, and may be determined by a higher-layer signal, an L1 signal, or a combination thereof. When N is 4 and K is 2, and one TB is composed of {A, B, C, D} for TBoMS, for a total of 8 slots, {A1, B1, C1, D1} and {A2, B2, C2, D2} may be determined as corresponding slots and some resources of a specific TB corresponding thereto. {A1, B1, C1, D1} and {A2, B2, C2, D2} may indicate that different OCC values are applied to {A, B, C, D}. Specifically, for example, applying the first value of an OCC sequence to {A, B, C, D} may correspond to {A1, B1, C1, D1}, and applying the second value of the OCC sequence may correspond to {A2, B2, C2, D2}.

When OCC is applied, the UE may determine N·K slots for TBoMS. In this case, when calculating the number of N slots to which a specific OCC value is applied, slots to which different OCC values are applied may not be calculated. In other words, the calculation may be performed only for slots to which the same OCC value is applied. When Nis 4 and K is 2, and one TB is composed of {A, B, C, D} for TBoMS, for a total of 8 slots, {A1, A2}, {B1, B2}, {C1, C2}, and {D1, D2} may be determined as corresponding slots and some resources of a specific TB corresponding thereto, and in this case, this exemplifies a case where the length of the OCC sequence is 2. In this case, within a slot group configured in the form of {X, X}, each slot may have a different OCC sequence value applied, or modulation symbols reflecting an OCC spreading code may be mapped to each slot through OCC spreading.

When OCC is applied, the UE may determine N·K slots for TBoMS. In this case, when calculating the number of N slots to which a specific OCC value is applied, the UE may be able to determine N slots according to n+q·(k−1) slots. Here, n denotes the first slot among N slots to which a specific OCC value is applied, q denotes an OCC sequence length, and k may correspond to one of values of {1, 2, . . . , N}. Therefore, when N is 4 and q is 2, the UE may be able to map the slots to which the specific OCC value is applied to slots n, n+2, n+4, and n+6.

When OCC is applied, the UE may determine N·K·q slots for TBoMS. In this case, q may correspond to an OCC sequence length. For example, when N is 4, K is 2, and q is 2, one TB is composed of {A, B, C, D} for TBoMS, and a total of 16 slots may be mapped as {{A1, A2}, {B1, B2}, {C1, C2}, {D1, D2}} and {{A1, A2}, {B1, B2}, {C1, C2}, {D1, D2}}. Here, each of {A1, A2}, {B1, B2}, {C1, C2}, and {D1, D2} exemplifies a form in which an OCC sequence of length 2 is mapped to the same modulation symbol with different OCC values. Then, {A1, A2}, {B1, B2}, {C1, C2}, and {D1, D2} may be repeated 4 times corresponding to the length of TBoMS. Finally, an interval to which TBoMS and OCC are applied may be repeatedly transmitted twice in the form of {{A1, A2}, {B1, B2}, {C1, C2}, {D1, D2}} and {{A1, A2}, {B1, B2}, {C1, C2}, {D1, D2}}.

Alternatively, it may be possible to determine the mapping in the manner of {{A1, B1, C1, D1}, {A2, B2, C2, D2}} and {{A1, B1, C1, D1}, {A2, B2, C2, D2}}.

Alternatively, it may be possible to determine the mapping in the manner of {{A1, B1, C1, D1}, {A1, B1, C1, D1}} and {{A2, B2, C2, D2}}, {A2, B2, C2, D2}}.

According to an embodiment, the UE may be able to perform transmission by using at least one of the above-mentioned manners. Alternatively, when multiple methods are available, it may be possible to apply one of the methods in advance through a higher-layer signal, an L1 signal, or a combination thereof and perform transmission. For example, a base station may transmit information related to an OCC application scheme according to an embodiment to the UE through a higher-layer signal (e.g., an RRC message) or an L1 signal (e.g., a DCI), or may configure a PUSCH transmission scheme to which an embodiment of the disclosure is applied through such methods. In addition, the OCC application scheme may be configured for the UE and the application may be activated or deactivated dynamically through an indication.

Whether OCC is applied may be determined through a higher-layer signal, an L1 signal, or a combination thereof. Whether TBoMS is applied may also be determined through a higher-layer signal, an L1 signal, or a combination thereof. The TB repeated transmissions may be determined through a higher-layer signal, an L1 signal, or a combination thereof. The higher-layer signal related to whether each transmission is performed may exist independently, or one or more pieces of information may be indicated simultaneously through the same field. In addition, the information related to whether each transmission is performed may be explicitly or implicitly transmitted by the base station to the UE. For example, when the application of OCC is activated, the number of repeated transmissions may implicitly be equal to or an integer multiple of the OCC sequence length. In addition, according to an embodiment, a value of N·K·q may be determined not to exceed a maximum of 32. The value of 32 is merely an example, and other natural number values may be applied.

A PUSCH resource allocated to each slot may be further limited to have the same start symbol and the same symbol length based on the corresponding slot. Alternatively, a PUSCH resource allocated to each slot may be further limited to have at least the same symbol length based on the corresponding slot.

Alternatively, it may be possible to allow frequency hopping for a PUSCH resource allocated to each slot, and it may be possible to limit at least the PUSCHs to which data with OCC spreading applied is allocated to have the same hop. For example, among {A1, A2}, {B1, B2}, {C1, C2}, and {D1, D2}, two PUSCHs corresponding to {A1, A2} may be required to have the same hop, while B1, B2, C1, C2, D1, and D2, which are different from A1, may have different hops. Here, a hop may refer to the middle value, the smallest value, or the largest value among frequency resources to which a PUSCH is transmitted.

3502, 3602, 3702, and 3802, as described above in FIGS. 35 to 38, may represent symbols decoded/demodulated for a TB, may be DFT symbols to which DFT is applied, may be modulation symbols, or may be symbols at a step prior to mapping to actual physical channel resources.

As described in FIG. 26, it may be possible to apply inter-symbol level OCC by transmitting multiple PUSCHs within one slot. Specifically, for example, when inter-symbol groups are considered as one PUSCH, applying an OCC spreading scheme between the corresponding PUSCH transmission resources may be performed. In this case, PUSCHs to which the same OCC spreading is applied may be required to have the same time and frequency resources. This is because, from the receiver's perspective, during OCC de-spreading, different OCC sequences are required to be applied to the same modulation symbol in order to perform de-spreading. For example, it may be possible to repeatedly transmit PUSCH 1 including 3 symbols and PUSCH 2 including 2 symbols for the same TB. In this case, when the frequency resource sizes of PUSCH 1 and PUSCH 2 are the same, and the same RV is applied to both, more modulation symbols will be mapped to PUSCH 1 compared to PUSCH 2. Therefore, when OCC code w1 is applied to PUSCH 1 and OCC code w2 is applied to PUSCH 2, a base station may not be able to use some of resources of PUSCH 1 for OCC de-spreading when applying the resources to OCC de-spreading, which may lower the resource efficiency of an UL to which OCC is applied. Therefore, according to an embodiment, it may be necessary to ensure that all PUSCH transmission resources applied to OCC spreading have the same time and frequency resources.

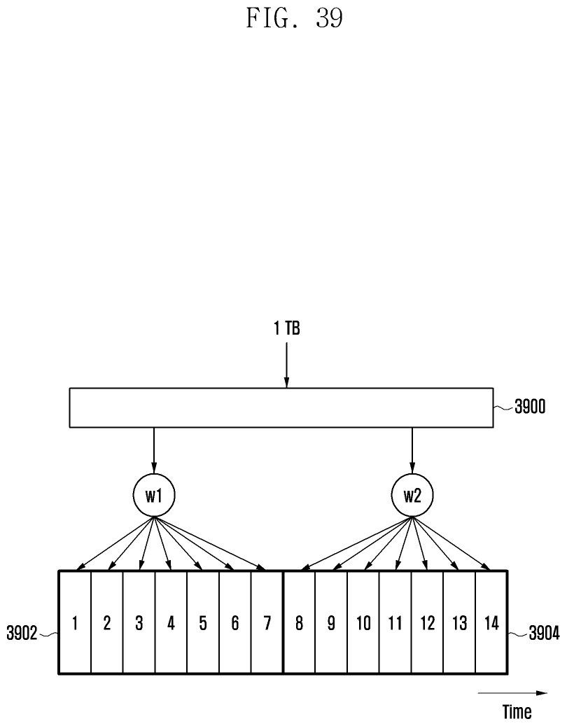

FIG. 39 illustrates an example in which OCC is applied to two different PUSCHs within one slot according to an embodiment.

Referring to FIG. 39, symbols 3900, which may mean decoded/demodulated symbols for a TB, may be DFT symbols to which DFT is applied, may be modulation symbols, or may be symbols at a step prior to mapping to actual physical channel resources, may be mapped to PUSCH 1 3902 and PUSCH 2 3904 through OCC spreading. In this case, each of PUSCH 1 and PUSCH 2 has the same symbol length and frequency resource size. In addition, OCC value w1 may be applied to PUSCH 1, and OCC value w2 may be applied to PUSCH 2. As described with reference to FIG. 26, when two different UEs use the same resource and apply different OCC sequences to transmit data to a base station, the base station may be able to demodulate/decode or identify data transmitted by each UE through OCC de-spreading.

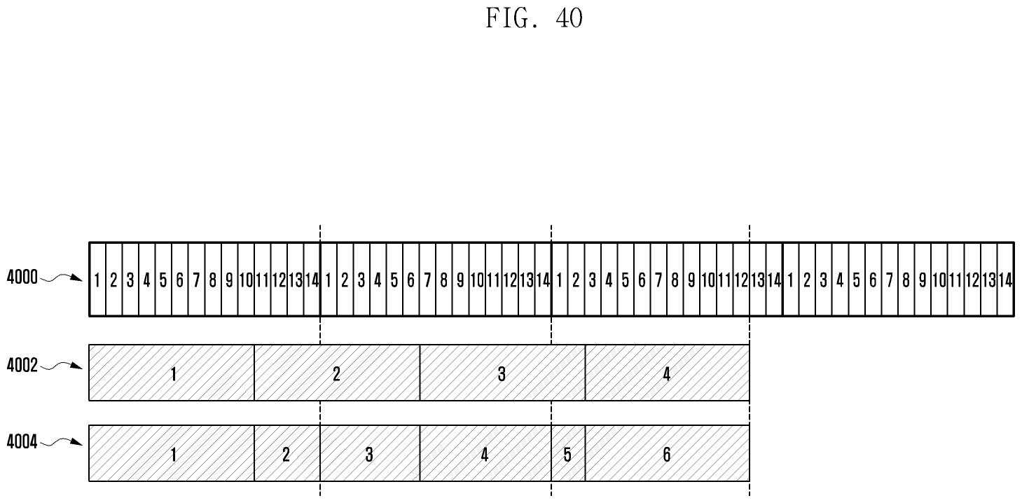

The following description illustrates various methods for identically providing a PUSCH transmission resource to which OCC spreading is applied. The UE may be able to apply at least one of the following methods. The following methods may be applicable only when the UE is configured by a higher-layer signal from the base station or indicated by an L1 signal so as to apply OCC spreading to the corresponding PUSCH in advance.
Method A-1: This is a method of limiting the number of PUSCH symbols that can be allocated within one slot in consideration of an OCC sequence length. For example, when the OCC sequence length is 2, the maximum number of PUSCH symbols that can be allocated within one slot may be limited to 7 symbols, as illustrated in FIG. 39. For example, when the OCC sequence length is 4, the maximum number of PUSCH symbols that can be allocated within one slot may be limited to 3 symbols with reference to FIG. 39. Generalizing this, if the number of symbols within one slot is denoted by S and the OCC sequence length is denoted by q, the maximum number of schedulable PUSCH symbols may be floor (S/q).
Method A-2: When PUSCH repeated transmission type B is used to apply OCC spreading, it may be possible to restrict at least the PUSCH resources indicated by nominal repetition from being mapped across a slot boundary or other invalid symbols. FIG. 40 illustrates PUSCH repeated transmission type B according to an embodiment of the disclosure. In a situation where one slot 4000 consists of 14 symbols, when a PUSCH having a length of 10 symbols is repeatedly transmitted 4 times starting from the first symbol of the first slot, a nominal repetition resource may be determined as illustrated in reference numeral 4002 without considering a slot boundary. Thereafter, when a specific nominal repetition resource overlaps with a slot boundary, a DL symbol, or other invalid symbols, the resource may be divided into one or more actual repetition resources according to reference numeral 4004, and when all symbols are UL symbols as illustrated in reference numeral 4004, the resource may be divided into up to 6 actual PUSCH repetition resources due to the slot boundary. In this case, it may be difficult to apply OCC spreading to actual PUSCH 1 and actual PUSCH 2 in reference numeral 4004. Therefore, a time resource length between actual PUSCHs to which OCC spreading is applied is required to be the same.
Method A-3: Method A-2 describes a method for preventing a nominal repetition itself from being divided by a slot boundary or other invalid symbols. Alternatively, a UE may be able to perform transmission by using nominal repetition rather than an actual repetition scheme. Referring to FIG. 40 as an example, the UE may be able to perform DMRS mapping and OCC spreading by using resources scheduled as illustrated in reference numeral 4002. Therefore, when OCC is applied, the UE may be able to perform UL data transmission in the manner illustrated in reference numeral 4002, and when OCC is not applied, the UE may be able to perform UL data transmission in the manner illustrated in reference numeral 4004.
Method A-4: It may be possible to provide multiple pieces of starting and length indication value (SLIV) information. An SLIV is information indicating a start symbol and symbol length for which a PUSCH is allocated in a specific slot, and it may be possible to In this case, a PUSCH repeated transmission indicate multiple SLIVs within one slot. resource is determined for each indicated SLIV, and the symbol length of each PUSCH may be determined to be the same. For example, it may be possible to indicate, within a specific DCI field, SLIV 1 having a start symbol of 1 and a symbol length of 3, and SLIV 2 having a start symbol of 5 and a symbol length of 3. In this case, a UE may determine that a PUSCH configured with SLIV 1 and a PUSCH configured with SLIV 2 are each repeatedly transmitted. Alternatively, a PUSCH resource may be determined by one piece of SLIV information, and the PUSCH resource may be consecutively repeated as many times as the OCC sequence length.

Hereinafter, an embodiment involving intra-symbol level OCC (i.e., frequency-level OCC) will be described.

In general, in order to apply OCC spreading, the same information (or modulated symbols) may be repeated as many times as an OCC sequence length. When applying OCC spreading in the frequency domain, a UE may apply RB-level OCC spreading or RE-level OCC spreading as described with reference to FIG. 28. In the case of applying RE-level OCC, the OCC sequence length may need to be limited depending on the number of PUSCH RBs to which OCC spreading is applied. For example, when the number of scheduled PUSCH RBs is 1, the total number of REs included in 1 RB is 12. In this case, when the OCC sequence length is 2, information mapped to a total of 6 REs may be repeated twice, so that RE-level OCC may be applied.

Alternatively, when the OCC sequence length is 4, information mapped to a total of 3 REs may be repeated 4 times, so that RE-level OCC may be applied. That is, the product of the sequence length and the number of REs to which the information is mapped is required to be 12. Therefore, when the OCC sequence length is 8, it may not be possible to apply RE-level OCC spreading to a PUSCH scheduled with 1 RB. Therefore, when the OCC sequence length is 8, RE-level OCC may be applicable only in a situation where the number of scheduled RBs for a PUSCH is a multiple of 2. For example, since a 2-RB PUSCH consists of 24 REs, when the OCC sequence length of 8 is applied, information mapped to a total of 3 REs may be repeated 8 times, and each repetition may be spread using different pieces of OCC information.

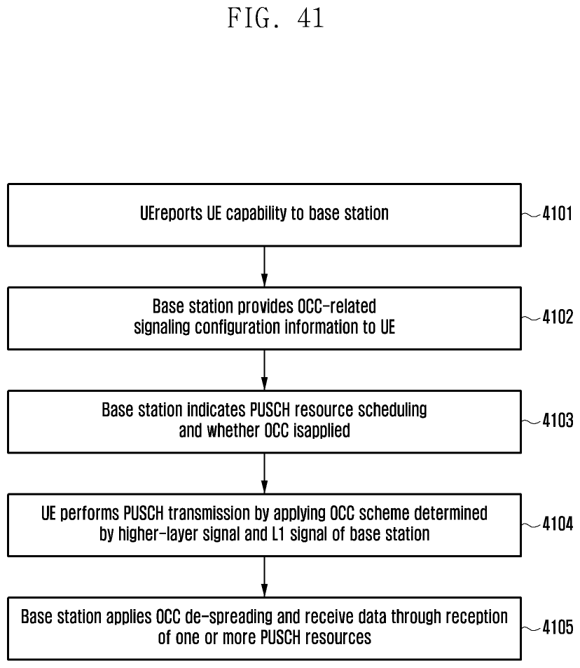

FIG. 41 illustrates a procedure for performing PUSCH transmission to which an OCC scheme is applied, according to an embodiment.

Referring to FIG. 41, in step 4101, during PUSCH transmission to a base station, a UE may first transmit, to the base station, information on the UE's capability indicating whether an OCC sequence is applicable.

In step 4102, the base station provides higher-layer signal information related to OCC to the UE.

In step 4103, during PUSCH scheduling, the base station may notify the UE whether OCC is applied through a higher-layer signal or an L1 signal. In this case, the L1 signal may indicate specific information among OCC sequence information through a separate DCI field.

Alternatively, indirect indication may be performed through an MCS field. For example, when an MCS value is indicated as 5, it may be possible to apply an OCC sequence with a length of 2 and a specific set of values. In another example, parameters related to OCC spreading applied to each MCS value may be linked through a higher-layer signal, and one of these values may be indicated to the UE. Through this, the UE may receive the MCS value and information on whether OCC spreading is applied, and, if applied, OCC sequence information. The UE may determine a TBS size of a PUSCH, determine the number of rate matching bits of UCI transmitted through the PUSCH, or determine a transmission power of the PUSCH by applying an OCC scheme by at least one or some combination of the methods described in the first to third embodiments.

In consideration of this, in step 4104, the UE may transmit the corresponding PUSCH.

In step 4105, the base station may perform a demodulation/decoding or identification process on data of each UE through an OCC de-spreading scheme through reception signals received from multiple UEs.

Some of the steps disclosed in FIG. 41 may be omitted or performed in a different order.

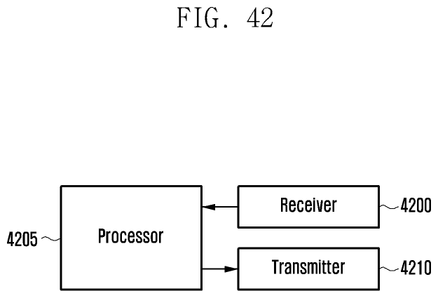

FIG. 42 illustrates a UE according to an embodiment.

Referring to FIG. 42, the UE includes a receiver 4200 and a transmitter 4210, which may be referred to collectively as a transceiver, and a processor 4205 (or controller). Although not illustrated, the UE may also include memory. The receiver 4200 and the transmitter 4210, the memory, and the processor 4205 may operate according to the above-described communication methods of the UE. Components of the UE are not limited to the above-described example. For example, the UE may include a larger or smaller number of components than the above-described components. Furthermore, the transceiver, the memory, and the processor 4205 may be implemented in the form of a single chip.

The transceiver may transmit/receive signals with base stations. The signals may include control information and data. To this end, the transceiver may include a radio frequency (RF) transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

In addition, the transceiver may receive signals through a radio channel, output the same to the processor 4205, and transmit signals output from the processor 4205 through the radio channel.

The memory may store programs and data necessary for operations of the UE. In addition, the memory may store control information or data included in signals transmitted/received by the UE. The memory may include storage media such as a read only memory (ROM), a random access memory (RAM), a hard disk, a compact disc-ROM (CD-ROM), a digital versatile disc (DVD), or a combination of storage media. In addition, the memory may include multiple memories.

Furthermore, the processor 4205 may control a series of processes such that the UE can operate according to the above-described embodiments. For example, the processor 4205 may control components of the UE to receive DCI configured in two layers so as to simultaneously receive multiple PDSCHs. The processor 4205 may include multiple processors, and the processor 4205 may perform operations of controlling the components of the UE by executing programs stored in the memory.

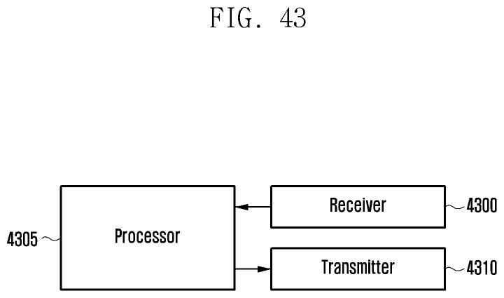

FIG. 43 illustrates a base station according to an embodiment.

Referring to FIG. 43, the base station includes a receiver 4300, a transmitter 4310, and a processor 4305 (or controller). The receiver 4300 and the transmitter 4310 may be collectively referred to as a transceiver. Although not illustrated the base station may also include memory.

The transmitter 4300, the receiver 4310, the memory, and the processor 4305 may operate according to the above-described communication methods of the base station. However, components of the base station are not limited to the above-described example. For example, the base station may include a larger or smaller number of components than the above-described components. Furthermore, the transceiver, the memory, and the processor 4305 may be implemented in the form of a single chip.

The transceiver may transmit/receive signals with UEs. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

In addition, the transceiver may receive signals through a radio channel, output the same to the processor 4305, and transmit signals output from the processor 4305 through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, a DVD, or a combination of storage media. In addition, the memory may include multiple memories.

The processor 4305 may control a series of processes such that the base station can operate according to the above-described embodiments of the disclosure. For example, the processor 4305 may control components of the base station to configure DCI configured in two layers including allocation information regarding multiple PDSCHs and to transmit the same. The processor 4305 may include multiple processors, and the processor 4305 may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a ROM, an electrically erasable programmable ROM (EEPROM), a magnetic disc storage device, a CD-ROM, DVDs, other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, other variants based on the technical idea of the embodiments may also be implemented in other communication systems such as FDD LTE, TDD LTE, 5G, or NR systems.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure.

The scope of the disclosure is defined by the appended claims, rather than the above detailed description, and the scope of the disclosure should be construed to include all changes or modifications derived from the meaning and scope of the claims and equivalents thereof.

What is claimed is:

1. A method performed by a terminal in a wireless communication system, the method comprising:
receiving, from a base station, configuration information on an orthogonal cover code (OCC);
identifying a transport block (TB) and multiple slots for TB processing;
based on the configuration information, applying a different OCC sequence to each repetition of the TB; and
transmitting, to the base station, a physical uplink shared channel (PUSCH).

2. The method of claim 1,
wherein a first slot among first multiple slots associated with a first OCC sequence is consecutive in time with a second slot among second multiple slots associated with a second OCC sequence, and
wherein the first slot and the second slot are associated with a same part of the TB.

3. The method of claim 1,
wherein the multiple slots for the TB associated with the repetition are discontinuous in time.

4. The method of claim 1, further comprising transmitting, to the base station, capability information on the OCC,
wherein the configuration information comprises at least one of information on a length of an OCC sequence or information on a number of the multiple slots for the TB processing, and
wherein the TB comprises at least one modulation symbol.

5. A method performed by a base station in a wireless communication system, the method comprising:
transmitting, to a terminal, configuration information on an orthogonal cover code (OCC);
receiving, from the terminal, a physical uplink shared channel (PUSCH); and
identifying a transport block (TB) and multiple slots for TB processing,
wherein a different OCC sequence is applied to each repetition of the TB.

6. The method of claim 5,
wherein a first slot among first multiple slots associated with a first OCC sequence is consecutive in time with a second slot among second multiple slots associated with a second OCC sequence, and
wherein the first slot and the second slot are associated with a same part of the TB.

7. The method of claim 5, wherein the multiple slots for the TB associated with the repetition are discontinuous in time.

8. The method of claim 5, further comprising receiving, from the terminal, capability information on the OCC,
wherein the configuration information comprises at least one of information on a length of an OCC sequence or information on a number of the multiple slots for the TB processing, and
wherein the TB comprises at least one modulation symbol.

9. A terminal in a wireless communication system, the terminal comprising:
at least one transceiver;
at least one processor communicatively coupled to the at least one transceiver; and
at least one memory, communicatively coupled to the at least one processor, storing instructions executable by the at least one processor individually or in any combination to cause the terminal to:
receive, from a base station, configuration information on an orthogonal cover code (OCC),
identify a transport block (TB) and multiple slots for TB processing,
based on the configuration information, apply a different OCC sequence to each repetition of the TB and
transmit, to the base station, a physical uplink shared channel (PUSCH).

10. The terminal of claim 9,
wherein a first slot among first multiple slots associated with a first OCC sequence is consecutive in time with a second slot among second multiple slots associated with a second OCC sequence, and
wherein the first slot and the second slot are associated with a same part of the TB.

11. The terminal of claim 9,
wherein the multiple slots for the TB associated with the repetition are discontinuous in time.

12. The terminal of claim 9, wherein the instructions further cause the terminal to:
transmit, to the base station, capability information on the OCC,
wherein the configuration information comprises at least one of information on a length of an OCC sequence or information on a number of the multiple slots for the TB processing, and
wherein the TB comprises at least one modulation symbol.

13. A base station in a wireless communication system, the base station comprising:
at least one transceiver;
at least one processor communicatively coupled to the at least one transceiver; and
at least one memory, communicatively coupled to the at least one processor, storing instructions executable by the at least one processor individually or in any combination to cause the base station to:
transmit, to a terminal, configuration information on an orthogonal cover code (OCC),
receive, from the terminal, a physical uplink shared channel (PUSCH), and
identify a transport block (TB) and multiple slots for TB processing,
wherein a different OCC sequence is applied to each repetition of the TB.

14. The base station of claim 13,
wherein a first slot among first multiple slots associated with a first OCC sequence is consecutive in time with a second slot among second multiple slots associated with a second OCC sequence, and
wherein the first slot and the second slot are associated with a same part of the TB.

15. The base station of claim 13,
wherein the multiple slots for the TB associated with the repetition are discontinuous in time.

16. The base station of claim 13, wherein the instructions further cause the base station to receive, from the terminal, capability information on the OCC,
wherein the configuration information comprises at least one of information on a length of an OCC sequence or information on a number of the multiple slots for the TB processing, and
wherein the TB comprises at least one modulation symbol.
